(19) United States
(12) Patent Application Publication
(10) Pub. No.: US 2026/0128910 A1
(43) Pub. Date: May 7, 2026

(54) DISTRIBUTED DIGITAL CERTIFICATE IMPLEMENTATION METHODS, COMPUTER DEVICES, AND STORAGE MEDIA

(71) Applicant: Ant Blockchain Technology (Shanghai) Co., Ltd., Shanghai (CN)

(72) Inventors: Guofeng TANG, Hangzhou (CN); Li LIN, Hangzhou (CN); Xin WANG, Hangzhou (CN); Yao WANG, Hangzhou (CN); Ying YAN, Hangzhou (CN)

(73) Assignee: Ant Blockchain Technology (Shanghai) Co., Ltd., Shanghai (CN)

(21) Appl. No.: 19/437,892

(22) Filed: Dec. 31, 2025

Related U.S. Application Data
(63) Continuation of application No. PCT/CN2023/135001, filed on Nov. 29, 2023.

(30) Foreign Application Priority Data
Aug. 31, 2023 (CN) 202311121706.9

(51) Int. Cl. H04L 9/32; H04L 9/00; H04L 9/08; H04L 9/30

(52) U.S. Cl. CPC H04L 9/3268; H04L 9/008; H04L 9/0819; H04L 9/3073

(57) ABSTRACT

A distributed digital certificate implementation is described. Each of n participants generates a respective threshold private key share based on a distributed key generation protocol. Each of at least t+1 of the n participants generates a random value based on an offline-phase protocol. Each of the at least t+1 participants receives a certificate application, and generates a certificate share by signing application information in the certificate application based on an online-phase protocol, the threshold private key share, and the random value generated based on the offline-phase protocol. Any party aggregates at least t+1 signature shares into a total certificate after obtaining the at least t+1 certificate shares.

### CROSS-REFERENCE TO RELATED APPLICATIONS

This application is a continuation of PCT Application No. PCT/CN2023/135001, filed on Nov. 29, 2023, which claims priority to Chinese Patent Application No. 202311121706.9, filed on Aug. 31, 2023, and each application is hereby incorporated by reference in its entirety.

### TECHNICAL FIELD

Implementations of this specification pertain to the field of cryptography technologies, and in particular, relate to distributed digital certificate implementation methods, computer devices, and a storage media.

### BACKGROUND

In the early days of the Internet, secure information transmission has become an important problem. To resolve this problem, various encryption algorithms, for example, symmetric encryption algorithms such as a DES, are invented. However, in these encryption algorithms, both parties need to share a key in advance, which is very difficult in an Internet environment. Therefore, a public key encryption technology is invented, which allows both parties to perform secure communication without directly exchanging a key. However, the public key encryption technology introduces a new problem: How to verify authenticity of a public key. To resolve this problem, a digital certificate is invented.

A principle of the digital certificate is based on a public key infrastructure (PKI). In the PKI, a third party is widely trusted, and is referred to as a certificate authority (CA). A task of the CA is to authenticate an identity of an entity and issue a digital certificate to the entity. When an entity (for example, a website) needs a digital certificate, the entity generates a pair of public key and private key, and then sends the public key and some identity information to the CA. The CA verifies authenticity of these information, generates a digital certificate including the public key and the identity information of the entity, and signs the certificate by using a private key of the CA.

When another entity (for example, a user) needs to verify an identity of the first entity, the another entity can request the digital certificate of the first entity. The user can verify a signature of the certificate by using the public key of the CA, and then encrypt information by using the public key in the certificate, or verify a digital signature of the first entity.

It can be seen that a main function of the digital certificate is to verify authenticity of the public key, to ensure secure information transmission. The digital certificate can be used in various network security scenarios, which are as follows:

Secure communication: By using the digital certificate, two entities can perform secure communication without directly exchanging a key. For example, to access an HTTPS website, a browser requests a digital certificate of the website, and then encrypts information by using a public key in the certificate.

Identity verification: The digital certificate includes identity information of an entity, which can be used to verify an identity of the entity. For example, to download software, a digital signature of the software can be checked, to ensure that the software is released by a trusted company.

Data integrity: By using the digital certificate, an entity can generate a digital signature, which can be used to verify data integrity. For example, when an email is received, a digital signature of the email can be checked, to ensure that the email is not tampered with.

Therefore, the digital certificate is often compared to an identity card of the user on a network. A public key certificate generally includes identity information of a certificate-holding subject, public key information of the subject, CA information, additional information, and a digital signature added to the above-mentioned information by using a CA private key.

The certificate authority plays a vital role in the digital certificate field. The certificate authority is a widely trusted third-party institution, and is responsible for verifying identities of entities (for example, individuals, companies, and websites) and issuing digital certificates to the entities. The following are some of main functions of the certification authority:

Identity verification: One of main responsibilities of the CA is to verify an identity of an entity applying for a digital certificate. This typically involves a series of identity verification processes such as verification of company registration information and personal identification information. The CA issues the digital certificates to the entities only after identity verification succeeds.

Certificate issuance: The CA issues the digital certificates to the entities once identities of the entities are verified. The certificate includes a public key of the entity and some identity information such as a name of the entity and a validity period of the certificate. All the information is signed by using the private key of the CA, to ensure authenticity and integrity of the certificate.

Certificate revocation: In some cases, an issued certificate may need to be revoked. For example, if a private key of the certificate is leaked, or an owner of the certificate no longer needs the certificate, the certificate needs to be revoked. The CA is responsible for managing a certificate revocation list (CRL), and all revoked certificates are recorded in the list.

Trust anchor: The CA is a trust anchor of the public key infrastructure (PKI). This means that the CA is trusted, and therefore, certificates signed by the CA are also trusted. Most operating systems and browsers have built-in public keys of widely trusted CAs, so that users can verify certificates signed by these CAs.

In a conventional digital certificate solution, a certificate authority is usually a centralized authority.

With rapid development of the Internet, the digital certificate has become an important tool that ensures network security. However, there are some problems in a conventional digital certificate system, which is mainly reflected by excessive dependence on a centralized certificate authority. As a core of trust, security and reliability of the CA directly affect security of the entire system. However, in recent years, some serious security events have revealed vulnerability of centralized CA systems.

To resolve such problems, people begin to explore new certificate system models, among which the most promising is a distributed digital certificate system. Emergence of the distributed digital certificate system is mainly based on a blockchain and other distributed ledger technologies. These technologies provide a decentralized way to store and verify data, so that certificates can be issued and verified without a centralized CA.

Emergence of the distributed digital certificate system can resolve some problems of the conventional CA system. First, because there is no centralized CA, system security no longer depends on a single trustpoint, which can improve system robustness. Second, all operations are recorded on a blockchain. This improves system transparency, and the users can verify certificate issuance and revocation operations.

Public key cryptography in cryptography used in the digital certificate, briefly referred to as public key cryptography or referred to as asymmetric cryptography, is cryptography in which a pair of public key and private key (public key-private key is denoted as pk-sk, where pk denotes a public key, and sk denotes a secret key) is used, and corresponds to cryptography in which there is only one private key. The public key cryptography includes an encryption algorithm and a digital signature algorithm. A public key-private key cipher pair is a cornerstone of modern cryptography security, and many applications such as a hypertext transfer protocol secure (https) application layer encryption transport protocol and a blockchain are based on pk-sk.

A private key usually represents an identity of a party that owns the private key, can only be held by an owner of the private key, and cannot be disclosed. A corresponding public key can be disclosed. A signature added by using the private key can represent an approval of the owner of the private key for information in a digital world, and signed information can represent a behavior of the owner of the private key in a message of a protocol. Usually, one owner independently has one private key. In this case, the owner can use their private key to sign a piece of information, and send the signed information to another party. After receiving the signature, a receiver can verify the signature by using a corresponding public key. If verification succeeds, the receiver can confirm that the information is signed by the owner, and the signed information is not tampered with.

For the conventional centralized CA, a CA signs a public key of a first entity (for example, a website) by using a private key of the CA. When a second entity (for example, a user) accesses the website, to avoid disclosure of personal information, an identity of the first entity needs to be first verified, and a digital certificate of the first entity can be requested. After receiving the digital certificate of the first entity, the user can verify a signature of the certificate by using the public key of the CA. If verification succeeds, authenticity of the website certificate issued by the CA can be confirmed based on authority of the CA, and therefore, the website can be trusted. Further, when sending information to the website, the user can further encrypt the to-be-transmitted information by using the public key in the certificate. Because only the website has the corresponding private key, only the website can decrypt the transmitted information. As such, privacy of information transmitted in a network is ensured.

In a distributed CA, there is no centralized CA, and instead, there are usually a plurality authoritative institutions. The plurality authoritative institutions can serve as nodes in a plurality of networks, and these nodes can generate respectively public-private key pairs through distributed key negotiation, and have a total public key. A signature added by each node to the same information by using a private key of the node is referred to as a signature share. When a plurality of signature shares are aggregated, a total signature can be obtained, and the total signature can be verified by the total public key. As such, it is possible that a certificate is issued only when all (or most) of the plurality authoritative institutions agree.

The above-mentioned content is equivalent to jointly controlling an account. Sometimes, accounts need flexible access control policies, for example, when a plurality of parties jointly control an account on the blockchain. In a case of some needs, n participants need to jointly control an account. In this case, for a behavior of controlling the account, for example, a transfer, the account can be controlled to execute the transfer behavior only when all of the n participants approve.

In addition, a threshold function can be implemented. For example, at least three of five nodes need to approve. To be specific, only when at least three nodes give a signature share, a total signature can be obtained through aggregation, and the total signature can be verified by the total public key. When a plurality of parties jointly control an account, not all of n participants need to agree, and instead, the account can be controlled when t+1 of the n participants (t<n, and t is also referred to as a threshold) agree, which can be implemented by using a threshold signature.

In such threshold cryptography, private key information is shared with a plurality of independent participants, and a plurality of participants need to agree for each time of private key calculation, thereby improving algorithm security. In addition, availability of a private key is not affected when a small quantity of participants are faulty and unavailable. Secure (t, n) threshold cryptography needs to satisfy the following: (1) A final signature, an exchanged key, or a plaintext can be calculated in a case of any more than t participants, and no information about the above-mentioned results is available in a case of t or fewer than t participants. (2) In an algorithm execution process, no information about a private key and a private key share of a participant is disclosed.

### SUMMARY

An object of this application is to provide distributed digital certificate implementation methods, computer devices, and storage media, including: A distributed digital certificate implementation method is provided, including:

Each of n participants generates a respective threshold private key share based on a distributed key generation protocol.

Each of at least t+1 of the n participants generates a random value based on an offline-phase protocol.

Each of the at least t+1 participants receives a certificate application, and generates a certificate share by signing application information in the certificate application based on an online-phase protocol, the threshold private key share, and the random value generated based on the offline-phase protocol.

A key share updating method in a distributed threshold signature solution is provided. A first participant set [symbol] existing before a change includes n participants, a second participant set [symbol] obtained after the change includes n′ participants, a threshold changes from t to t′ through the change, and the method includes:

Each of at least t+1 participants in a third set [symbol] obtained by intersecting the first participant set [symbol] existing before the change and the second participant set [symbol] obtained after the change generates a new t′-degree random polynomial by using an original private key share component as a secret value. S is a subset of participant indices, and satisfies |S|=t+1.

Each of the at least t+1 participants in the third set [symbol] generates n′ new secret shares based on the new t′-degree random polynomial generated by the participant, retains one secret share, and encrypts and sends the remaining secret share to another participant in the second set [symbol] .

Each participant in the second participant set [symbol] generates a new private key share based on a local new secret share.

A distributed threshold signature implementation method is provided, including:

Each of n participants generates a respective threshold private key share based on a distributed key generation protocol.

Each of at least t+1 of the n participants generates a random value based on an offline-phase protocol.

Each of the at least t+1 participants generates a signature share by signing a message based on an online-phase protocol, a threshold private key share, and the random value generated based on the offline-phase protocol.

A computer device is provided, including: a processor; and a storage. The storage stores a program, and when the processor executes the program, the following operations are performed: generating a respective threshold private key share based on a distributed key generation protocol; generating a random value based on an offline-phase protocol; and generating a signature share by signing a message based on an online-phase protocol, the threshold private key share, and the random value generated based on the offline-phase protocol.

A storage medium is provided, configured to store a program. When the program is executed, the following operations are performed: generating a respective threshold private key share based on a distributed key generation protocol; generating a random value based on an offline-phase protocol; and generating a signature share by signing a message based on an online-phase protocol, the threshold private key share, and the random value generated based on the offline-phase protocol.

According to the above-mentioned solutions provided in this application, dependence on a centralization institution can be avoided, to become more flexible and robust. Private key shard leakage and loss can be tolerated to a certain extent. This effectively avoids a security risk brought by improper private key management, and is more suitable for a decentralization scenario such as a blockchain.

### BRIEF DESCRIPTION OF DRAWINGS

To describe the technical solutions in the implementations of the specification more clearly, the following briefly describes the accompanying drawings needed for describing the implementations. Clearly, the accompanying drawings in the following description show merely some implementations described in this specification, and a person of ordinary skill in the art can still derive other drawings from these accompanying drawings without creative efforts.

FIG. 1 is a schematic diagram illustrating distributed threshold key generation, according to one or more implementations;

FIG. 2 is a schematic diagram illustrating a distributed threshold signature, according to one or more implementations;

FIG. 3 illustrates a distributed key updating procedure, according to one or more implementations;

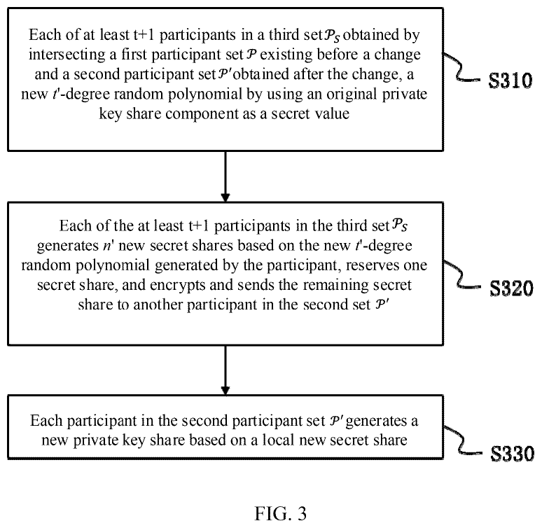

FIG. 4 illustrates a procedure of a distributed digital certificate implementation method, according to one or more implementations; and

FIG. 5 illustrates a procedure of a distributed digital certificate implementation method, according to one or more implementations.

### DESCRIPTION OF EMBODIMENTS

To make a person skilled in the art better understand the technical solutions in this specification, the following clearly and comprehensively describes the technical solutions in the implementations of this specification with reference to the accompanying drawings in the implementations of this specification. Clearly, the described implementations are merely some but not all of the implementations of this specification. All other implementations obtained by a person of ordinary skill in the art based on the implementations of this specification without creative efforts shall fall within the protection scope of this specification.

A distributed key generation (DKG) protocol is a distributed protocol in which a group of keys are generated through collaboration between a plurality of participants participating in the protocol. A verifiable secret sharing (VSS) protocol is an important theoretical basis of the DKG protocol.

VSS means that during sharing of secret data between a plurality of participants, the secret data can be split into a plurality of shards without disclosing the secret data, and each of the plurality of participants keeps one shard. Then, when the secret data need to be restored, all the shards need to be collected to successfully restore the complete secret data.

The VSS protocol was first proposed by Shamir in 1979, and is a polynomial-based secret sharing protocol. The VSS protocol is developed from Shamir's secret sharing (SSS). Therefore, Shamir's secret sharing is first described.

Shamir's secret sharing includes two phases: secret sharing (or secret distribution) and secret reconstruction. A polynomial needs to be first constructed by a dealer:

$$f ( x ) = {a}_{0} + {a}_{1} x + {a}_{2} {x}^{2} + … + {a}_{n} {x}^{n} \qquad Polynomial \text{(*} )$$

Here, a₀ is to-be-shared secret data.

This polynomial of degree n is uniquely determined by a group of coefficients (a₀, a₁, a₂, . . . , aₙ), and this group of coefficients includes n+1 values. As such, if it is known that a curve corresponding to the polynomial of degree n passes through n+1 different points on a plane, that is, coordinates (x₁, y₁), (x₂, y₂), . . . , (xₙ, yₙ), (xₙ₊₁, yₙ₊₁) of the n+1 different points are obtained, a system of (n+1)-variable linear equations of n+1 equations can be obtained. Therefore, values of the n+1 coefficients a₀, a₁, a₂, . . . , an can be determined by using this system of equations, then the polynomial (*) is determined, and finally a value of the secret data a₀ can be obtained. The coordinates (x₁, y₁), (x₂, y₂), . . . , (xₙ, yₙ), (xₙ₊₁, yₙ₊₁) of the n+1 different points are n+1 secret shards.

A process of finding a curve passing through several existing points based on the points is referred to as polynomial interpolation. There are a plurality of methods for implementing polynomial interpolation. The following describes a common Lagrange interpolation method. Given a polynomial * of degree n, if it is known that a curve corresponding to the polynomial passes through coordinates of n+1 points (x₁, y₁), (x₂, y₂), . . . , (xₙ, yₙ), (xₙ₊₁, yₙ₊₁) on a plane, a polynomial of the curve of degree n can be obtained by using the Lagrange interpolation method as follows:

$$f ( x ) = \frac{( x - {x}_{2} ) ( x - {x}_{3} ) … ( x - {x}_{n} ) ( x - {x}_{n + 1} )}{( {x}_{1} - {x}_{2} ) ( {x}_{1} - {x}_{3} ) … ( {x}_{1} - {x}_{n} ) ( {x}_{1} - {x}_{n + 1} )} {y}_{1} + \frac{( x - {x}_{1} ) ( x - {x}_{3} ) … ( x - {x}_{n} ) ( x - {x}_{n + 1} )}{( {x}_{2} - {x}_{1} ) ( {x}_{2} - {x}_{3} ) … ( {x}_{2} - {x}_{n} ) ( {x}_{2} - {x}_{n + 1} )} {y}_{2} + … + \frac{( x - {x}_{1} ) ( x - {x}_{2} ) … ( x - {x}_{n - 1} ) ( x - {x}_{n + 1} )}{( {x}_{n} - {x}_{1} ) ( {x}_{n} - {x}_{2} ) … ( {x}_{n} - {x}_{n - 1} ) ( {x}_{1} - {x}_{n + 1} )} {y}_{n} + \frac{( x - {x}_{1} ) ( x - {x}_{2} ) … ( x - {x}_{n} ) ( x - {x}_{n + 1} )}{( {x}_{n + 1} - {x}_{1} ) ( {x}_{n + 1} - {x}_{2} ) … ( {x}_{n} - {x}_{n - 1} ) ( {x}_{n + 1} - {x}_{n} )} {y}_{n + 1} \qquad Polynomial \text{(*} \text{*)}$$

The polynomial (**) and the polynomial (*) are essentially equivalent. If x=0 in the polynomial (*), f(0)=a₀, that is, the value of the secret data a₀ can be obtained. Therefore, if x=0 in the polynomial (**), the value of the secret data a₀ can also be obtained, that is, f(0)=a₀.

For the n+1 points (x₁, y₁), . . . , (xₙ>yₙ), (xₙ₊₁, yₙ₊₁), the above-mentioned polynomial (**) can also be represented as follows:

$$L ( x ) = {\sum }_{j = 1}^{n + 1} {l}_{j} ( x ) \cdot {y}_{j}$$

$${l}_{j} ( x ) = {\prod }_{1 \leq m \leq n + 1 , m \neq j} \frac{( x - {x}_{m} )}{( {x}_{j} - {x}_{m} )} .$$

Similarly, for a constant term or a secret value;

$$L ( 0 ) = {\sum }_{j = 1}^{n + 1} {l}_{j} ( 0 ) \cdot {y}_{j} .$$

In conclusion, n+1 points on the polynomial can be randomly selected, and the n+1 points are shared between n+1 participants, for example, each participant obtains coordinates of one point. If coordinates of any fewer than n+1 points are collected, the original secret data a₀ cannot be inferred. Only after all the n+1 points are obtained, the value of the secret data a₀ can be restored by reconstructing polynomial coefficients. In addition, even if coordinates of any fewer than n+1 points are collected, for example, coordinates of n points, because there are countless curves of degree n passing through these n points, the value of the secret data a₀ is not disclosed in terms of probability. The degree n here is also referred to as a degree of the polynomial.

On this basis, threshold Shamir's secret sharing can be implemented. For example, t-of-n secret sharing is to share a secret between n participants and specify that a threshold for a minimum quantity of secret shards needed for restoration is greater than t, that is, greater than or equal to t+1. For example, in a transaction in which four parties participate, if an agreed threshold is 3, that is, n=4 and t=2, a secret can be restored only when at least t+1=3 participants provide secret shards of the participants. Otherwise, the secret cannot be restored. Specifically, a polynomial of degree t=2 can be constructed:

$$f ( x ) = {a}_{0} + {a}_{1} x + {a}_{2} {x}^{2} \qquad Polynomial \text{(*} \text{**)}$$

It can be obtained that a curve corresponding to the polynomial of degree 2 passes through four different points on a plane, that is, coordinates (x₁, y₁), (x₂, y₂), (x₃, y₃), (x₄, y₄) of the four different points are obtained, and the coordinates of the four points are separately distributed to one participant in a secret sharing phase. The four participants are set to Party₁, Party₂, Party₃, Party₄. As such, assume that Party₁ has a shard (x₁, y₁), Party₂ has a shard (x₂, y₂), Party₃ has a shard (x₃, y₃), and Party₄ has a shard (x₄, y₄). The polynomial (**) can be determined by any three points on the corresponding curve. Therefore, in Partyᵢ (i∈{1, 2, 3, 4}), when any three participants provide secret shards of the participants, the polynomial (***) can be restored in a secret reconstruction phase, and a secret value a₀ can be obtained. When any fewer than three participants provide secret shards of the participants, the polynomial (***) cannot be restored, and the secret value a₀ cannot be obtained. The above-mentioned parameter t is also referred to as a threshold.

In the above-mentioned Shamir's secret sharing and threshold Shamir's secret sharing, a role for generating a polynomial and distributing secret shards is needed. This role can be referred to as a dealer. This dealer is an entity that knows the secret and needs to be a trusted third party of each participant. In addition, an entity for aggregating t+1 shards and obtaining the secret is further needed, for example, the dealer, a participant, or another entity.

In engineering practice, polynomials are usually defined in finite fields or prime fields rather than real number fields or natural number fields.

In a classic Shamir's secret sharing scheme, assume that participants are honest. However, actually, there may be dishonest behavior or malicious behavior. For example, the dealer deceives one or more participants by sending an incorrect secret shard to the participant.

In secret sharing, verifiable secret sharing (VSS) is proposed to verify a malicious problem, for example, the participant verifying whether the dealer deceives the participant (verifying whether the dealer sends an incorrect secret shard, as described above). Feldman VSS is a practical VSS scheme constructed based on Shamir's secret sharing, including the following:

The dealer has a secret and distributes n shards of the secret to n participants. The secret can be reconstructed by t participants. A polynomial of degree t can be constructed by using a scheme similar to the above-mentioned threshold Shamir's secret sharing scheme:

$$f ( x ) = {a}_{0} + {a}_{1} x + {a}_{2} {x}^{2} + … + {a}_{t} {x}^{t} \qquad Polynomial \text{(*} \text{***)}$$

The dealer randomly selects xᵢ that is not 0 for each participant Partyᵢ, calculates sᵢ=f(xᵢ), and encrypts and sends the sub-secret sᵢ to the participant Partyᵢ. In addition, the dealer calculates Aⱼ=g^{a}^{ⱼ}, where j=0, 1, 2, . . . , and t−1, and discloses Aⱼ, that is, discloses {A₀, A₁, A₂, . . . , Aₜ₋₁}. The parameter Aⱼ is referred to as a public verification parameter. A method for generating Aⱼ here is the same as a method for generating a public key based on a private key on an elliptic curve. Therefore, Aⱼ can also be referred to as a public key shard (or a public key share).

For a case in which a selected polynomial corresponds to an elliptic curve, it is secure to disclose Aⱼ, because based on a property of the elliptic curve, aⱼ cannot be derived based on Aⱼ.

The public verification parameter {A₀, A₁, A₂, . . . , Aₜ₋₁} is also referred to as a commitment. The commitment can be used to verify whether a value of the polynomial is correct because a coefficient of the polynomial is bound to the commitment. In discrete logarithm-based implementations, g is a generator of a cyclic group in the finite field, and g can be preconfigured for the dealer and Partyᵢ. The above-mentioned sub-secret can also be referred to as a secret share.

After receiving the sub-secret sᵢ, the participant can verify validity of sᵢ by using the public verification parameter. Whether sᵢ is valid can be verified by verifying whether the following equation is true:

$${g}^{{s}_{i}} = {A}_{0}^{{x}_{i}^{0}} \cdot {A}_{1}^{{x}_{i}^{1}} \cdot … \cdot {A}_{t}^{{x}_{i}^{t}} \qquad Polynomial \text{(*} \text{****)}$$

A right side of the polynomial (*****) can be deduced as follows:

$${A}_{0}^{{x}_{i}^{0}} \cdot {A}_{1}^{{x}_{i}^{1}} \cdot … \cdot {A}_{t - 1}^{{x}_{i}^{t - 1}} = {( {g}^{{a}_{0}} )}^{{x}_{i}^{0}} \cdot {( {g}^{{a}_{1}} )}^{{x}_{i}^{1}} \cdot … \cdot {( {g}^{{a}_{t}} )}^{{x}_{i}^{t}} = ( {g}^{{a}_{0} \cdot {x}_{i}^{0}} ) \cdot ( {g}^{{a}_{1} \cdot {x}_{i}^{1}} ) \cdot … \cdot ( {g}^{{a}_{t} \cdot {x}_{i}^{t}} ) = {g}^{{a}_{0} \cdot {x}_{i}^{0} + {a}_{1} \cdot {x}_{i}^{1} + … + {a}_{t} \cdot {x}_{i}^{t}} = {g}^{{a}_{0} + {a}_{1} \cdot {x}_{i}^{1} + … + {a}_{t} \cdot {x}_{i}^{t}} = {g}^{f ( {x}_{i} )} = {g}^{{s}_{i}}$$

The right side of the polynomial (*****) can also be written as

$${g}^{{s}_{i}} = {\prod }_{k = 0}^{t} {A}_{k}^{{x}_{i}^{k}} .$$

It can be seen that for Partyᵢ, the dealer selects xᵢ that is not 0, for example, xᵢ is i. In this case, Partyᵢ can calculate the right side of the polynomial (*****) by using i and the public verification parameter {A₀, A₁, A₂, . . . , Aₜ}, and calculate a left side of the polynomial (*****) by using generator g and the sub-secret sᵢ. Therefore, it can be determined, by determining whether the left and right sides of the polynomial (*****) are equal, whether (xᵢ, g^{s}^{ᵢ}) is a point on a curve corresponding to {A₀, A₁, A₂, . . . , Aₜ}. This verification is a verification in a secret distribution phase. For simplicity, xᵢ=i usually can be used.

In engineering, implementations are usually based on discrete logarithms, and a modulo operation such as mod p is used for the above-mentioned equations, where p is a large prime number, and p is also preconfigured for the dealer and Partyᵢ. mod p is omitted in the following similar places.

In the secret reconstruction phase, for example, at least t+1 participants send secret shards of the participants to the dealer, and the dealer can verify each secret shard by using a public verification parameter corresponding to the polynomial. If the verification fails, it can be proved that a participant that sends the secret shard acts maliciously. A secret shard on which verification succeeds can be used as a basis for reconstructing the secret.

In the secret reconstruction phase, after secret shards of the at least t+1 participants are collected, a polynomial f(x) can be reconstructed by using the Lagrange interpolation method, to obtain a value of f(0), that is, obtain a secret value.

In addition, validity of the secret a₀ can be verified by using the public verification parameter {A₀, A₁, A₂, . . . , Aₜ}, that is, whether (0, a₀) is a point on the curve can be verified, because there is the following relationship:

$${A}_{0}^{{0}^{0}} \cdot {A}_{1}^{{0}^{1}} \cdot … \cdot {A}_{t}^{{0}^{t}} = {( {g}^{{a}_{0}} )}^{{0}^{0}} \cdot {( {g}^{{a}_{1}} )}^{{0}^{1}} \cdot … \cdot {( {g}^{{a}_{t}} )}^{{0}^{t}} = ( {g}^{{a}_{0} \cdot {0}^{0}} ) \cdot ( {g}^{{a}_{1} \cdot {0}^{1}} ) \cdot … \cdot ( {g}^{{a}_{t} \cdot {0}^{t}} ) = {g}^{{a}_{0} \cdot {0}^{0} + {a}_{1} \cdot {0}^{1} + … + {a}_{t} \cdot {0}^{t}} = {g}^{{a}_{0} \cdot 1 + {a}_{1} \cdot 0 + … + {a}_{t} \cdot 0} = {g}^{{a}_{0}} = {A}_{0} = {g}^{f ( 0 )}$$

That is, the validity of the secret a₀ can be simplify verified by using the public verification parameter A₀.

In the above-mentioned deduction, 0⁰=1 is defined, and 0^{k}=0, k≠0.

In the above-mentioned scheme, a dealer is needed, and the dealer is centralized, and is an entity that knows the secret. As described above, the dealer needs to be a trusted third party, or the dealer needs to be trusted by participants. In a distributed scenario, both distributed secret distribution and distributed secret reconstruction need to be implemented. Therefore, the centralized dealer needs to be removed. As such, trust removal is implemented. To resolve this problem, Rabin et al. proposed an improved protocol named Joint-Feldman in 1999. A basic idea of this protocol is to execute the Feldman VSS protocol n times in parallel. Each participant locally generates a random polynomial and then shares a randomly selected secret value between all the participants. A commitment of a secret rather than a secret is shared. Therefore, the secret cannot be restored provided that there is no collusion and cheating by a plurality of persons whose quantity exceeds the threshold t. Such a distributed VSS protocol in which the trusted third party is removed is also referred to as a distributed VSS (DVSS) protocol.

Specifically, four participants are used as an example. If the threshold is t=2, the degree of the polynomial is t=2, and a decentralized threshold secret sharing or Joint-Feldman implementation scheme includes the following:

Each Pᵢ (Party; is briefly written as Pᵢ, where i∈{1, 2, 3, 4}) sets a to-be-shared secret sᵢ₀ and randomly selects other parameters to generate a polynomial of degree t−1.

A participant P₁ generates a polynomial of degree 2:
f₁(z)=a₁₀+a₁₁Z+a₁₂z², where a₁₀ is a secret s₁ set by P₁.

A participant P₂ generates a polynomial of degree 2:
f₂(z)=a₂₀+a₂₁z+a₂₂z², where a₂₀ is a secret s₂ set by P₂.

A participant P₃ generates a polynomial of degree 2:
f₃(z)=a₃₀+a₃₁z+a₃₂z², where a₃₀ is a secret s₃ set by P₃.

A participant P₄ generates a polynomial of degree 2:
f₄(z)=a₄₀+a₄₁z+a₄₂z², where a₄₀ is a secret s₄ set by P₄.

Then, each participant Pᵢ generates and distributes n values on a curve corresponding to the polynomial of degree t of each participant. Here, still assume that n=4, t=2, and n=1, 2, 3, 4.

The participant P₁ generates s₁₁=f₁(1), s₁₂=f₁(2), s₁₃=f₁(3), s₁₄=f₁(4), retains s₁₁, encrypts and sends s₁₂ to P₂, encrypts and sends s₁₃ to P₃, and encrypts and sends s₁₄ to P₄.

The participant P₂ generates s₂₁=f₂(1), s₂₂=f₂(2), s₂₃=f₂(3), s₂₄=f₂(4), retains s₂₂, encrypts and sends s₂₁ to P₁, encrypts and sends s₂₃ to P₃, and encrypts and sends s₂₄ to P₄.

The participant P₃ generates s₃₁=f₃(1), s₃₂=f₃(2), s₃₃=f₃(3), s₃₄=f₃(4), retains s₃₃, encrypts and sends s₃₁ to P₁, encrypts and sends s₃₂ to P₂, and encrypts and sends s₃₄ to P₄.

The participant P₄ generates s₄₁=f₄(1), s₄₂=f₄(2), s₄₃=f₄(3), s₄₄=f₄(4), retains s₄₄, encrypts and sends s₄₁ to P₁, encrypts and sends s₄₂ to P₂, and encrypts and sends s₄₃ to P₃.

In addition, each participant Pᵢ further generates a public verification parameter Aᵢₖ=g^{a}^{ᵢₖ} corresponding to the polynomial of degree t−1 of each participant, where k=0, 1, . . . , t, and publishes the public verification parameter to each participant. Details are as follows:

The participant P₁ generates A₁ₖ=g^{a}^{₁ₖ}, where k=0, 1, . . . , t, including A₁₀=g^{a}^{₁₀}, A₁₁=g^{a}^{₁₁}, and A₁₂=g^{a}^{₁₂}, and broadcasts {A₁₀, A₁₁, A₁₂} to P₂, P₃, and P₄.

The participant P₂ generates A₂ₖ=g^{a}^{₁ₖ}, where k=0, 1, . . . , t, including A₂₀=g^{a}^{₂₀}, A₂₁=g^{a}^{₂₁}, and A₂₂=g^{a}^{₂₂}, and broadcasts {A₂₀, A₂₁, A₂₂} to P₁, P₃, and P₄.

The participant P₃ generates A₃ₖ=g^{a}^{₃ₖ}, where k=0, 1, . . . , t, including A₃₀=g^{a}^{₃₀}, A₃₁=g^{a}^{₃₁}, and A₃₂=g^{a}^{₃₂}, and broadcasts {A₃₀, A₃₁, A₃₂} to P₁, P₂, and P₄.

The participant P₄ generates A₄ₖ=g^{a}^{₄ₖ}, where k=0, 1, . . . , t, including A₄₀=g^{a}^{₄₀}, A₄₁=g^{a}^{₄₁}, and A₄₂=g^{a}^{₄₂}, and broadcasts {A₄₀, A₄₁, A₄₂} to P₁, P₂, and P₃.

As such, after receiving s₂₁, P₁ can perform verification by using {A₂₀, A₂₁, A₂₂}; after receiving s₃₁, P₁ can perform verification by using {A₃₀, A₃₁, A₃₂}; and after receiving s₄₁, P₁ can perform verification by using {A₄₀, A₄₁, A₄₂}. A verification method is similar to the above-mentioned descriptions. Details are omitted for simplicity.

Similarly, after receiving s₁₂, P₂ can perform verification by using {A₁₀, A₁₁, A₁₂}; after receiving s₃₂, P₂ can perform verification by using {A₃₀, A₃₁, A₃₂}; and after receiving s₄₂, P₂ can perform verification by using {A₄₀, A₄₁, A₄₂}.

Similarly, after receiving s₁₃, P₃ can perform verification by using {A₁₀, A₁₁, A₁₂}; after receiving s₂₃, P₃ can perform verification by using {A₂₀, A₂₁, A₂₂}; and after receiving s₄₃, P₃ can perform verification by using {A₄₀, A₄₁, A₄₂}.

Similarly, after receiving s₁₄, P₄ can perform verification by using {A₁₀, A₁₁, A₁₂}; after receiving s₂₄, P₄ can perform verification by using {A₂₀, A₂₁, A₂₂}; and after receiving s₃₄, P₄ can perform verification by using {A₃₀, A₃₁, A₃₂}.

Assume that a participant set that is obtained after each participant performs verification and on which verification succeeds is set to Qual, and Qual={P₁, P₂, P₃, P₄} is set. In this case, P₁ locally holds secret shares s₁₁, s₂₁, s₃₁, and s₄₁ generated by different participants and public verification parameters {A₁₀, A₁₁, A₁₂}, {A₂₀, A₂₁, A₂₂}, {A₃₀, A₃₁, A₃₂}, and {A₄₀, A₄₁, A₄₂}; P₂ locally holds secret shares s₁₂, s₂₂, s₃₂, and s₄₂ generated by different participants and public verification parameters {A₁₀, A₁₁, A₁₂}, {A₂₀, A₂₁, A₂₂}, {A₃₀, A₃₁, A₃₂}, and {A₄₀, A₄₁, A₄₂}; P₃ locally holds secret shares s₁₃, s₂₃, s₃₃, and s₄₃ generated by different participants and public verification parameters {A₁₀, A₁₁, A₁₂}, {A₂₀, A₂₁, A₂₂}, {A₃₀, A₃₁, A₃₂}, {A₄₀, A₄₁, A₄₂}; and P₄ locally holds secret shares s₁₄, s₂₄, s₃₄, and s₄₄ generated by different participants and public verification parameters {A₁₀, A₁₁, A₁₂}, {A₂₀, A₂₁, A₂₂}, {A₃₀, A₃₁, A₃₂}, and {A₄₀, A₄₁, A₄₂}.

Then, the participant P₁ can calculate that the secret share s₁ is s₁=s₁₁+s₂₁+s₃₁+s₄₁; the participant P₂ can calculate that the secret share s₂ is s₂=s₁₂+s₂₂+s₃₂+s₄₂; the participant P₃ can calculate that the secret share s₃ is s₃=s₁₃+s₂₃+s₃₃+s₄₃; the participant P₄ can calculate that the secret share s₄ is s₄=s₁₄+s₂₄+s₃₄+s₄₄; and each participant Pᵢ can broadcast the secret share sᵢ calculated by the participant to another participant. After collecting at least t+1 secret shares, that is, t secret shares, in {s₁, s₂, s₃, s₄}, each participant Pᵢ can reconstruct the secret s₀. Here, for t=2, after collecting at least t+1=2+1=3 secret shares, each participant Pᵢ can reconstruct the secret s₀.

This is because summation can be performed on the curves of all the participants to obtain a total curve:

$$f ( z ) = {f}_{1} ( z ) + {f}_{2} ( z ) + {f}_{3} ( z ) + {f}_{4} ( z ) \qquad Polynomial ( I )$$

$$f ( z ) = ( {a}_{10} + {a}_{11} z + {a}_{12} {z}^{2} ) + ( {a}_{20} + {a}_{21} z + {a}_{22} {z}^{2} ) + ( {a}_{30} + {a}_{31} z + {a}_{32} {z}^{2} ) + ( {a}_{40} + {a}_{41} z + {a}_{42} {z}^{2} )$$

$$f ( z ) = ( {a}_{10} + {a}_{20} + {a}_{30} + {a}_{40} ) + ( {a}_{11} + {a}_{21} + {a}_{31} + {a}_{41} ) z + ( {a}_{12} + {a}_{22} + {a}_{32} + {a}_{42} ) {z}^{2}$$

In this case,

$${s}_{1} = {s}_{11} + {s}_{21} + {s}_{31} + {s}_{41} = {f}_{1} ( 1 ) + {f}_{2} ( 1 ) + {f}_{3} ( 1 ) + {f}_{4} ( 1 )$$

$${s}_{2} = {s}_{12} + {s}_{22} + {s}_{32} + {s}_{42} = {f}_{1} ( 2 ) + {f}_{2} ( 2 ) + {f}_{3} ( 2 ) + {f}_{4} ( 2 )$$

$${s}_{3} = {s}_{13} + {s}_{23} + {s}_{33} + {s}_{43} = {f}_{1} ( 3 ) + {f}_{2} ( 3 ) + {f}_{3} ( 3 ) + {f}_{4} ( 3 )$$

$${s}_{4} = {s}_{14} + {s}_{24} + {s}_{34} + {s}_{44} = {f}_{1} ( 4 ) + {f}_{2} ( 4 ) + {f}_{3} ( 4 ) + {f}_{4} ( 4 )$$

For the total curve f(z), there are the following relationships:

$${s}_{1} = {f}_{1} ( 1 ) + {f}_{2} ( 1 ) + {f}_{3} ( 1 ) + {f}_{4} ( 1 ) = f ( 1 )$$

$${s}_{2} = {f}_{1} ( 2 ) + {f}_{2} ( 2 ) + {f}_{3} ( 2 ) + {f}_{4} ( 2 ) = f ( 2 )$$

$${s}_{3} = {f}_{1} ( 3 ) + {f}_{2} ( 3 ) + {f}_{3} ( 3 ) + {f}_{4} ( 3 ) = f ( 3 )$$

$${s}_{4} = {f}_{1} ( 4 ) + {f}_{2} ( 4 ) + {f}_{3} ( 4 ) + {f}_{4} ( 4 ) = f ( 4 )$$

The secret is s₀=a₁₀+a₂₀+a₃₀+a₄₀.

As such, after each participant Pᵢ collects at least three of the secret shares s₁, s₂, s₃, and s₄, it is equivalent to that at least three points on a curve corresponding to the polynomial (I) are obtained, that is, at least three of four coordinates (x₁₌₁,y₁=s₁), (x₂₌₂,y₂=s₂), (x₃₌₃,y₃=s₃), (x₄₌₄, y₄=s₄) are obtained. Therefore, the total curve f(z) can be restored. Further, it can be calculated that f(0)=a₁₀+a₂₀+a₃₀+a₄₀=s₀, and therefore the secret s₀ can be obtained.

In addition, validity of the secret sᵢ can be verified by using the verification parameters {A₁₀, A₁₁, A₁₂}, {A₂₀, A₂₁, A₂₂}, {A₃₀, A₃₁, A₃₂}, and {A₄₀, A₄₁, A₄₂}, that is, it can be verified whether (0, sᵢ) is a point on the total curve. Specifically, the validity is determined by verifying whether the following equation is true:

$${g}^{{s}_{i}} = {\prod }_{j = 1}^{n} {\prod }_{k = 0}^{t} {A}_{j k}^{{x}_{i}^{k}} \qquad Polynomial ( II )$$

This is because there is the following relationship:

$${\prod }_{j = 1}^{n} {\prod }_{k = 0}^{t} {A}_{jk}^{{x}_{i}^{k}} = ( {A}_{10}^{{x}_{i}^{0}} \cdot {A}_{11}^{{x}_{i}^{1}} \cdot … \cdot {A}_{1 t}^{{x}_{i}^{t}} ) \cdot ( {A}_{20}^{{x}_{i}^{0}} \cdot {A}_{21}^{{x}_{i}^{1}} \cdot … \cdot {A}_{2 t}^{{x}_{i}^{t}} ) \cdot … \cdot ( {A}_{n 0}^{{x}_{i}^{0}} \cdot {A}_{n 1}^{{x}_{i}^{1}} \cdot … \cdot {A}_{n t}^{{x}_{i}^{t}} ) = ( {( {g}^{{a}_{10}} )}^{{x}_{i}^{0}} \cdot {( {g}^{{a}_{11}} )}^{{x}_{i}^{1}} \cdot … \cdot {( {g}^{{a}_{1 t}} )}^{{x}_{i}^{t}} ) \cdot ( {( {g}^{{a}_{20}} )}^{{x}_{i}^{0}} \cdot {( {g}^{{a}_{21}} )}^{{x}_{i}^{1}} \cdot … \cdot {( {g}^{{a}_{2 t}} )}^{{x}_{i}^{t}} ) \cdot … \cdot ( {( {g}^{{a}_{n 0}} )}^{{x}_{i}^{0}} \cdot {( {g}^{{a}_{n 1}} )}^{{x}_{i}^{1}} \cdot … \cdot {( {g}^{{a}_{n t}} )}^{{x}_{i}^{t}} ) = {g}^{( {a}_{10} \cdot {x}_{i}^{0} + {a}_{11} \cdot {x}_{i}^{1} + … + {a}_{1 t} \cdot {x}_{i}^{t} ) + ( {a}_{20} \cdot {x}_{i}^{0} + {a}_{21} \cdot {x}_{i}^{1} + … + {a}_{2 t} \cdot {x}_{i}^{t} ) + … + ( {a}_{n 0} \cdot {x}_{i}^{0} + {a}_{n 1} \cdot {x}_{i}^{1} + … + {a}_{n t} \cdot {x}_{i}^{t} )} = {g}^{( {a}_{10} \cdot {x}_{i}^{0} + {a}_{20} \cdot {x}_{i}^{0} + … + {a}_{n 0} \cdot {x}_{i}^{0} ) + ( {a}_{11} \cdot {x}_{i}^{1} + {a}_{21} \cdot {x}_{i}^{1} + … {a}_{n 1} \cdot {x}_{i}^{1} ) + … + ( {a}_{1 ( t - 1 )} \cdot {x}_{i}^{t - 1} + {a}_{2 t} \cdot {x}_{i}^{t} + … {a}_{n t} \cdot {x}_{i}^{t} )} = {g}^{( {a}_{10} + {a}_{20} + … + {a}_{n 0} ) + ( {a}_{11} + {a}_{21} + … {a}_{n 1} ) \cdot {x}_{i}^{1} + … + ( {a}_{1 t} + {a}_{2 t} + … {a}_{n t} ) \cdot {x}_{i}^{t}} = {g}^{f ( {x}_{i} )} = {g}^{{f}_{1} ( {s}_{i} ) + {f}_{2} ( {s}_{i} ) + … + {f}_{n} ( {s}_{i} )} = {g}^{{s}_{1 i} + {s}_{2 i} + … + {s}_{n i}} = {g}^{{s}_{i}}$$

Usually, assume that a right side of an equal sign of the polynomial (II) is a public key share, and is denoted as pubᵢ, i=1, 2, . . . , n, to verify a corresponding private key share.

$${pub}_{i} = {\prod }_{j = 1}^{n} {\prod }_{k = 0}^{t} {A}_{j k}^{{x}_{i}^{k}}$$

As described above, usually, xᵢ=i for each i=1, 2, . . . , n can be used. As such, i can be used as a number of each participant.

For verification of the secret s₀, that is, xᵢ=0, the above-mentioned equation can be further deduced as follows:

$${\prod }_{j = 1}^{n} {\prod }_{k = 0}^{t} {A}_{jk}^{{x}_{0}^{k}} = ( {A}_{10}^{{x}_{0}^{0}} \cdot {A}_{11}^{{x}_{0}^{1}} \cdot … \cdot {A}_{1 t}^{{x}_{0}^{t}} ) \cdot ( {A}_{20}^{{x}_{0}^{0}} \cdot {A}_{21}^{{x}_{0}^{1}} \cdot … \cdot {A}_{2 t}^{{x}_{0}^{t}} ) \cdot … \cdot ( {A}_{n 0}^{{x}_{0}^{0}} \cdot {A}_{n 1}^{{x}_{0}^{1}} \cdot … \cdot {A}_{n t}^{{x}_{0}^{t}} ) = ( {A}_{10}^{{0}^{0}} \cdot {A}_{11}^{{0}^{1}} \cdot … \cdot {A}_{1 t}^{{0}^{t}} ) \cdot ( {A}_{20}^{{0}^{0}} \cdot {A}_{21}^{{0}^{1}} \cdot … \cdot {A}_{2 t}^{{0}^{t}} ) \cdot … \cdot ( {A}_{n 0}^{{0}^{0}} \cdot {A}_{n 1}^{{0}^{1}} \cdot … \cdot {A}_{n t}^{{0}^{t}} ) = ( {A}_{10}^{{0}^{0}} \cdot {A}_{20}^{{0}^{0}} \cdot … \cdot {A}_{n 0}^{{0}^{0}} ) \cdot ( {A}_{11}^{{0}^{1}} \cdot {A}_{21}^{{0}^{1}} \cdot … \cdot {A}_{n 1}^{{0}^{1}} ) \cdot … \cdot ( {A}_{1 t}^{{0}^{t}} \cdot {A}_{2 t}^{{0}^{t}} \cdot … \cdot {A}_{n t}^{{0}^{t}} ) = {( {A}_{10} \cdot {A}_{20} \cdot … \cdot {A}_{n 0} )}^{{0}^{0}} \cdot {( {A}_{11} \cdot {A}_{21} \cdot … \cdot {A}_{n 1} )}^{{0}^{1}} \cdot {( {A}_{1 t} \cdot {A}_{2 t} \cdot … \cdot {A}_{n t} )}^{{0}^{t}}$$

0¹=1 is defined, and 0^{k}=0, k≠0. Therefore, the above-mentioned equation can be further deduced as follows:

$$= {( {A}_{10} \cdot {A}_{20} \cdot … \cdot {A}_{n 0} )}^{{0}^{0}} = {A}_{10} \cdot {A}_{20} \cdot … \cdot {A}_{n 0} = {g}^{( {a}_{10} + {a}_{20} + … + {a}_{n 0} )} = {g}^{f ( 0 )} = {g}^{{s}_{0}}$$

### Polynomial (III)

It can be seen that validity of s₀ can be verified based on the polynomial (III).

In addition, based on the deduction in the above-mentioned polynomial (III), verification of the validity of s₀ can be further reduced as follows:

$${g}^{{s}_{0}} = {\prod }_{i = 1}^{n} {A}_{i 0} \qquad Polynomial ( IV )$$

Usually, assume that a right side of an equal sign of the polynomial (IV) is a total public key, and is denoted as pub.

The above-mentioned Joint-Feldman protocol can implement distributed secret sharing, that is, complete main content of DKG. The above-mentioned protocols from Shamir to threshold Shamir, the Feldman VSS protocol, and the Joint-Feldman DVSS protocol are a series of secret sharing implementation schemes. Actually, in addition to the series of schemes starting with Shamir's secret sharing, there are schemes based on additive secret sharing, SPDZ (an important protocol in secure multi-party computation, first proposed in 2012), the Chinese remainder theorem, etc., which can ultimately implement DKG. These schemes are omitted here and are not described.

Through implementation of the above-mentioned DKG protocol, a problem of overall unavailability caused by a fault in a single node when a single entity generates a key and a problem of a need to trust the single node that generates the key can be overcome. However, because each participant Pᵢ broadcasts a generated secret share sᵢⱼ, i, j∈(1, 2, . . . , n), n is the quantity of participants, and each participant Pᵢ can broadcast a secret share sᵢ calculated by the participant to another participant, each participant Pᵢ can reconstruct a secret s₀ after collecting at least t+1 secret shares, that is, t secret shares, in {s₁, s₂, s₃, s₄}. Consequently, at least t+1 participants obtain the finally reconstructed secret s₀, that is, the secret s₀ is exposed, and a total curve becomes unavailable. If a new secret s₀ needs to be generated next time, a process of executing the DKG protocol needs to be repeated.

Properties of the DKG protocol in terms of threshold and secret commitments, combined with a matching threshold signature algorithm, can be used to construct a distributed threshold signature protocol. As a distributed system, a blockchain uses a large quantity of signature algorithms. As such, nodes in the blockchain generate secret shares in a distributed way through DKG, and after at least t+1 blockchain nodes sign to-be-signed information by using secret shares as private key shares and broadcast the information, any blockchain node that collects at least t+1 signature shares can restore a total signature, and can restore a total public key by the above-mentioned method, and the restored total signature can be verified by using the total public key, to implement a threshold signature. In addition, an advantage of this is that a secret share held by each blockchain node does not need to be broadcast to another node, and therefore the secret share of each blockchain node is not exposed and a private key is not exposed. Therefore, a secret share generated at a time through DKG can be repeatedly used a plurality of times, and there is no need to execute the DKG protocol for each threshold signature.

A basic ECDSA signature algorithm includes:

A signer Alice selects an elliptic curve E_{q}(a, b) and a base point G, and shares the information with a verifier Bob, where q is a modulus.

Alice selects a private key x in a finite field [symbol] , and generates a public key X=x·G based on the private key.

Alice selects a random number k in the finite field [symbol] , calculates R=k⁻¹·G, calculates r=f(R), and r≠0. f(R) can be a horizontal coordinate of R.

Alice obtains a digest value h by performing hash calculation on a to-be-signed message m, that is, h=hash(m), and calculates:

$$σ = k ( h + x \cdot r ) mod q \qquad Equation ( a )$$

Alice generates a signature sig=(r, σ), and sends the message m, the signature sig, and the public key X to a signature verifier Bob.

Bob verifies the received message m and the received signature sig by using the public key X and based on the following equation:

$$r = f ( {σ}^{- 1} \cdot h \cdot G + {σ}^{- 1} \cdot r \cdot X ) \qquad Equation ( b )$$

If the equation b is true, it indicates that the signature is valid; otherwise the signature is invalid. A reason is as follows: It can be seen from Equation (a) that k⁻¹=σ⁻¹(h+x·r) mod q, and R=k⁻¹·G and k⁻¹ can be substitute into r=f(R), to obtain:

$$r = f ( R ) = f ( {k}^{- 1} \cdot G ) = f ( {σ}^{- 1} ( h + x \cdot r ) \cdot G ) = f ( {σ}^{- 1} \cdot h \cdot G + {σ}^{- 1} \cdot x \cdot r \cdot G ) = f ( {σ}^{- 1} \cdot h \cdot G + {σ}^{- 1} \cdot r \cdot X )$$

That is, based on a right side of Equation (b), Bob can perform calculation based on σ and r in the received signature, the message m, and the public key X, and verify whether a calculation result is equal to r in the signature.

The basic ECDSA signature algorithm can be extended to a threshold signature algorithm. For example, after the above-mentioned DKG process, each of n signers P₁, P₂, . . . , Pₙ has a secret share of the signer, and has a total public key. A threshold is t, and t<n. Each of at least t+1 signers of n participants uses a secret share of the signer as a private key share, and signs and broadcasts the same to-be-signed information. Then, any verifier that collects at least t+1 signature shares can restore a total signature, and can verify the total signature by using the total public key, to implement a threshold signature. A specific implementation is the article “UC Non-Interactive, Proactive, Threshold ECDSA with Identifiable Aborts” published by Fireblocks in CCS20. This article constructs a distributed ECDSA signature solution in a case of a malicious model. A disadvantage of this solution is that a large quantity of zero-knowledge proofs are needed to resist a malicious adversary, and therefore, large communication costs and calculation costs are needed. In addition, the threshold in this solution is fixed to t=n−1, and no solution of any threshold is provided.

One or more implementations of this application provide a distributed threshold signature method based on an ECDSA. In some of the implementations, each signer can generate a threshold private key in a dealer-based or dealer-less method such as threshold Shamir, a Feldman protocol, or a Joint-Feldman protocol, or based on another DKG solution. An implementation result of such a DKG solution is that a participant Pᵢ(i∈n) has a private key share ωᵢ, and any at least t+1 private key shares corresponds to a total private key ω. A result of the DKG can be further that a total public key X is generated. The total public key X and the total private key w have a relationship: ω·G=X.

In addition, after obtaining respective private key shares based on the DKG, n participants can generate signature shares by signing the same message by using respective private key shares. Any at least t+1 signature shares can be aggregated into a total signature, and the total signature can be verified by the total public key.

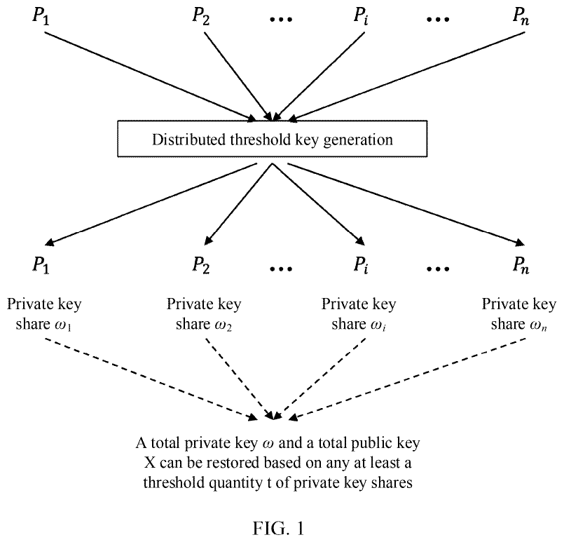

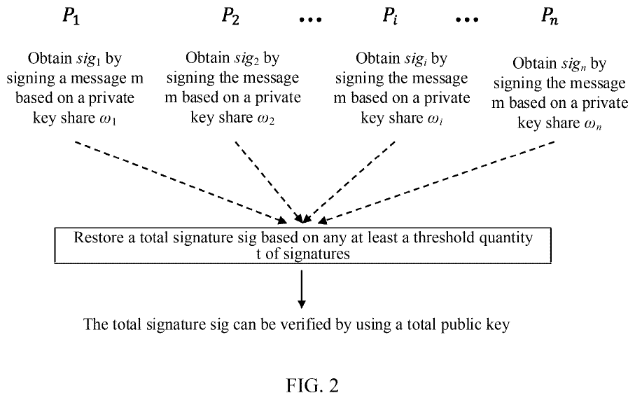

The above-mentioned relationship can be represented by distributed threshold key generation in FIG. 1 and a distributed threshold signature in FIG. 2.

This implementation of this application can include two parts: the distributed threshold key generation and the distributed threshold signature. The two parts both specify, in a form of a protocol, a process of how each participant transmits data and performs data processing, to cooperate to implement a specific purpose. The distributed threshold signature includes an offline phase and an online phase.

The following first describes a process of a distributed threshold key generation protocol. In this process, assume that there are a total of n participants: P₁, P₂, . . . , and Pₙ. Each participant Pᵢ (i={1, 2, . . . , n}) can generate a respective private key share based on the distributed key generation protocol.

Specifically, each participant Pᵢ can generate a t-degree polynomial fᵢ(z)=aᵢ₀+aᵢ₁z+aᵢ₂z²+ . . . +aᵢₜz^{t}, where aᵢ₀ is a secret sᵢ₀ that is set by Pᵢ. A threshold here is t, and therefore, a degree of the polynomial is also t.

If a threshold is 2, and a total quantity of participants is 4, that is, t=2, and n=4, there are a total of four participants P₁, P₂, P₃, and P₄.

P₁ generates a 2-degree (t=2) polynomial f₁(z)=a₁₀+a₁₁z+a₁₂z², where a₁₀ is a secret s₁₀ that is set by P₁.

P₂ generates a 2-degree (t=2) polynomial f₂(z)=a₂₀+a₂₁z+a₂₂z², where a₂₀ is a secret s₂₀ that is set by P₂.

P₃ generates a 2-degree (t=2) polynomial f₃(z)=a₃₀+a₃₁z+a₃₂z², where a₃₀ is a secret s₃₀ that is set by P₃.

P₄ generates a 2-degree (t=2) polynomial f₄(z)=a₄₀+a₄₁z+a₄₂z², where a₄₀ is a secret s₄₀ that is set by P₄.

Further, each participant Pᵢ can generate n secret shares, retain one of the secret shares, and encrypt and send the remaining secret shares to another participant. For example, the participant Pᵢ generates coordinates of n points on a curve corresponding to a polynomial of the participant as n secret shares, retains coordinates of one of the points, and encrypts and sends coordinates of the remaining points to another participant.

Specifically, examples are as follows: P₁ generates s₁₁=f₁(1), s₁₂=f₁(2), s₁₃=f₁(3), s₁₄=f₁(4), retains s₁₁, encrypts and sends s₁₂ to P₂, encrypts and sends s₁₃ to P₃, and encrypts and sends s₁₄ to P₄; P₂ generates s₂₁=f₂(1), s₂₂=f₂(2), s₂₃=f₂(3), s₂₄=f₂(4), retains s₂₂, encrypts and sends s₂₁ to P₁, encrypts and sends s₂₃ to P₃, and encrypts and sends s₂₄ to P₄; P₃ generates s₃₁=f₃(1), s₃₂=f₃(2), s₃₃=f₃(3), s₃₄=f₃(4), retains s₃₃, encrypts and sends s₃₁ to P₁, encrypts and sends s₃₂ to P₂, and encrypts and sends s₃₄ to P₄; and P₄ generates s₄₁=f₄(1), s₄₂=f₄(2), s₄₃=f₄(3), s₄₄=f₄(4), retains s₄₄, encrypts and sends s₄₁ to P₁, encrypts and sends s₄₂ to P₂, and encrypts and sends s₄₃ to P₃.

In this case, P₁ locally has secret shares s₁₁, s₂₁, s₃₁, and s₄₁ generated by different participants; P₂ locally has secret shares s₁₂, s₂₂, s₃₂, and s₄₂ generated by different participants; P₃ locally has secret shares s₁₃, s₂₃, s₃₃, and s₄₃ generated by different participants; and P₄ locally has secret shares s₁₄, s₂₄, s₃₄, and s₄₄ generated by different participants.

Then, each participant Pᵢ can obtain a private key share by summarizing a secret share sᵢᵢ retained by each participant and a secret share sⱼᵢ obtained from another participant Pᵢ. For example, a summarization method is summarization. For example, the private key share of the participant Pᵢ is

$${s}_{i} = {\sum }_{j = 1}^{n} {s}_{j i} .$$

Specifically, examples are as follows: the participant P₁ can calculate that a private key share s₁ is s₁=s₁₁+s₂₁+s₃₁+s₄₁; the participant P₂ can calculate that a private key share s₂ is s₂=s₁₂+s₂₂+s₃₂+s₄₂; the participant P₃ can calculate that a private key share s₃ is s₃=s₁₃+s₂₃+s₃₃+s₄₃; and the participant P₄ can calculate that a private key share s₄ is s₄=s₁₄+s₂₄+s₃₄+s₄₄.

In addition, each participant Pᵢ can further generate a public verification parameter Aᵢₖ=aᵢₖG corresponding to the polynomial of degree t of each participant, where k=0, 1, . . . , t, and publish the public verification parameter to each participant. Details are as follows: the participant P₁ generates A₁ₖ=a₁ₖG, where k=0, 1, . . . , t=2, including A₁₀=a₁₀G=s₁₀G, A₁₁=a₁₁G, and A₁₂=a₁₂G, and broadcasts {A₁₀, A₁₁, A₁₂} to P₂, P₃, and P₄; the participant P₂ generates A₂ₖ=a₂ₖG, where k=0, 1, . . . , t=2, including A₂₀=a₂₀G=s₂₀G, A₂₁=a₂₁G, and A₂₂=a₂₂G, and broadcasts {A₂₀, A₂₁, A₂₂} to P₁, P₃, and P₄; the participant P₃ generates A₃ₖ=a₃ₖG, where k=0, 1, . . . , t=2, including A₃₀=a₃₀G=s₃₀G, A₃₁=a₃₁G, and A₃₂=a₃₂G, and broadcasts {A₃₀, A₃₁, A₃₂} to P₁, P₂, and P₄; and the participant P₄ generates A₄ₖ=a₄ₖG, where k=0, 1, . . . , t=2, including A₄₀=a₄₀G=s₄₀G, A₄₁=a₄₁G, and A₄₂=a₄₂G, and broadcasts {A₄₀, A₄₁, A₄₂} to P₁, P₂, and P₃.

Each participant Pᵢ can further verify, based on public verification parameters {Aⱼ₀, Aⱼ₁, . . . , Aⱼₜ} sent by Pⱼ, the secret share sⱼᵢ sent by Pⱼ, for example, based on the following formula:

$${s}_{j i} G = {A}_{j 0} + i {A}_{j 1} + … + {i}^{t} {A}_{j t}$$

Details are as follows: the participant P₁ verifies s₂₁ based on s₂₁G=A₂₀+A₂₁+A₂₂, verifies s₃₁ based on s₃₁G=A₃₀+A₃₁+A₃₂, and verifies s₄₁ based on s₄₁G=A₄₀+A₂₁+A₄₂; the participant P₂ verifies s₁₂ based on s₁₂G=A₁₀+2A₁₁+2²A₁₂, verifies s₃₂ based on s₃₂G=A₃₀+2A₃₁+2²A₃₂, and verifies s₄₂ based on s₄₂G=A₄₀+²A₂₁+2²A₄₂; the participant P₃ verifies s₁₃ based on s₁₃G=A₁₀+3A₁₁+3²A₁₂, verifies s₂₃ based on s₂₃G=A₃₀+3A₃₁+3²A₃₂, and verifies s₄₃ based on s₄₃G=A₄₀+3A₂₁+3²A₄₂; and the participant P₄ verifies s₁₄ based on s₁₄G=A₁₀+4A₁₁+4²A₁₂, verifies s₂₄ based on s₂₄G=A₂₀+4A₂₁+4²A₂₂, and verifies s₄₂ based on s₃₄G=A₄₀+⁴A₂₁+4²A₄₂.

Any party can terminate a protocol if verification fails.

In another aspect, each participant Pᵢ can calculate the total public key X. A calculation method is similar to the above-mentioned method. For example, the following formula is used here:

$$X = {\sum }_{i = 1}^{n} {A}_{i 0}$$

As described above, the total public key can be used to verify the subsequent aggregated total signature.

The above-mentioned distributed threshold key generation process is equivalent to a total polynomial:

$$f ( z ) = {f}_{1} ( z ) + {f}_{2} ( z ) + {f}_{3} ( z ) + {f}_{4} ( z ) = {a}_{10} + {a}_{11} z + {a}_{12} {z}^{2} + {a}_{20} + {a}_{21} z + {a}_{22} {z}^{2} + {a}_{30} + {a}_{31} z + {a}_{32} {z}^{2} + {a}_{40} + {a}_{41} z + {a}_{42} {z}^{2} = ( {a}_{10} + {a}_{20} + {a}_{30} + {a}_{40} ) + ( {a}_{11} + {a}_{21} + {a}_{31} + {a}_{41} ) z + ( {a}_{12} + {a}_{22} + {a}_{32} + {a}_{42} ) {z}^{2}$$

As described above, the polynomial corresponds to a total curve and has the following relationship:

$${s}_{1} = {f}_{1} ( 1 ) + {f}_{2} ( 1 ) + {f}_{3} ( 1 ) + {f}_{4} ( 1 ) = f ( 1 )$$

$${s}_{2} = {f}_{1} ( 2 ) + {f}_{2} ( 2 ) + {f}_{3} ( 2 ) + {f}_{4} ( 2 ) = f ( 2 )$$

$${s}_{3} = {f}_{1} ( 3 ) + {f}_{2} ( 3 ) + {f}_{3} ( 3 ) + {f}_{4} ( 3 ) = f ( 3 )$$

$${s}_{4} = {f}_{1} ( 4 ) + {f}_{2} ( 4 ) + {f}_{3} ( 4 ) + {f}_{4} ( 4 ) = f ( 4 )$$

In the above-mentioned DKG solution, each participant Pᵢ can broadcast the secret share sᵢ calculated by the participant to another participant. After collecting at least t+1 secret shares in {s₁, s₂, s₃, s₄}, each participant Pᵢ can reconstruct the secret s₀. For example, if the threshold is 2, after collecting at least three secret shares, each participant Pᵢ can reconstruct the secret s₀.

In this implementation, a purpose is to implement the distributed threshold signature, and therefore, the secret share sᵢ is not sent to another participant, but is used as a private key share. As such, after obtaining the at least t+1 secret shares, any participant or another participant does not restore the total secret, that is, does not obtain the total private key. As such, it is ensured that a plurality of participants can repeatedly perform a distributed threshold signature subsequently based on the private key shares obtained after one distributed threshold key generation protocol.

The following describes a distributed threshold signature process in the implementations. The process can include two parts: an offline phase and an online phase. In the above-mentioned distributed key generation process, n participants need to jointly participate in a protocol process. In the following distributed threshold signature process, only at least a threshold quantity of participants need to participate in a protocol process. Here, the threshold t=2 is still used as an example.

Offline phase: Aₜ least t+1 participants generate respective first random values kᵢ and second random values γᵢ. Each participant further obtains a coordinate component r and a respective private key share component mask value χᵢ based on a homomorphic encryption algorithm and an offline-phase protocol. Details can specifically include:

In the t+1 participants, each participant Pᵢ calculates a Lagrange coefficient

$${λ}_{i} = {\prod }_{j ∈ [ 1 , t + 1 ] , j \neq 1} \frac{j}{j - 1} ,$$

and calculates a private key share component xᵢ=λᵢsᵢ. Here, for example, if i is and 1, 2, or 3: a participant P₁ calculates a Lagrange coefficient

$${λ}_{1} = {\prod }_{j ∈ [ 1 , 3 ] , j \neq 1} \frac{j}{j - 1} = \frac{2}{2 - 1} \cdot \frac{3}{3 - 1} ,$$

and calculates a private key share component x₁=λ₁s₁; a participant P₂ calculates a Lagrange coefficient

$${λ}_{2} = {\prod }_{j ∈ [ 1 , 3 ] , j \neq 2} \frac{j}{j - 2} = \frac{1}{1 - 2} \cdot \frac{3}{3 - 2} ,$$

and calculates a private key share component x₂=λ₂s₂; and a participant P₃ calculates a Lagrange coefficient

$${λ}_{3} = {Π}_{j ∈ [ 1 , 3 ] , j \neq 3} \frac{j}{j - 3} = \frac{1}{1 - 3} \cdot \frac{2}{2 - 3} ,$$

and calculates a private key share component x₃=λ₃s₃.

S11: Each of the at least t+1 participants generates a first random value, a second random value, a corresponding first random value homomorphic ciphertext, and a corresponding second random value public key hash. Specifically, for example, the participant Pᵢ, i∈[1, t+1] generates the first random value kᵢ and the second random value γᵢ, and kᵢ, γᵢ∈ [symbol] . On this basis, the participant Pᵢ can calculate the first random value homomorphic ciphertext, for example, a Paillier ciphertext Kᵢ=Eᵢ(kᵢ), and calculate the second random value public key hash, for example, gᵢ=H₁(γᵢG), where H₁( ) is a hash algorithm, which is similar to the above-mentioned descriptions. When t+1 is 3, the participants are P₁, P₂, and P₃: P₁ generates a first random value k₁ and a second random value γ₁, calculates a Paillier ciphertext K₁=E₁(k₁) of the first random value, and calculates a second random value public key hash g₁=H₁(γ₁G); P₂ generates a first random value k₂ and a second random value y₂, calculates a Paillier ciphertext K₂=E₂(k₂) of the first random value, and calculates a second random value public key hash g₂=H₁(γ₂G); and P₃ generates a first random value k₃ and a second random value y₃, calculates a Paillier ciphertext K₃=E₃(k₃) of the first random value, and calculates a second random value public key hash g₃=H₁(γ₃G).

Further, each participant Pᵢ in the at least t+1 participants can send the generated first random value homomorphic ciphertext to another participant. Examples are as follows: P₁ broadcasts K₁ to P₂ and P₃; P₂ broadcasts K₂ to P₁ and P₂; and P₃ broadcasts K₃ to P₁ and P₂.

S12: For Kⱼ sent by Pⱼ, the participant Pᵢ that receives broadcast selects two masks β_{i,j}, \hat{B}_{i,j}∈ [symbol] . Here, [symbol] indicates that a value range of a subscript in the limited field is q to the power of 5. This is a proven value range with cryptographic security. The mask β_{i,j}, \hat{β}_{i,j} can be a large value selected in the range [symbol] . Further, Pᵢ can calculate intermediate ciphertexts D_{i,j} and \hat{D}_{i,j} based on a homomorphic algorithm, and send the intermediate ciphertexts to Pⱼ:

$${D}_{i , j} = {γ}_{1} ⊙ {K}_{j} ⊕ {E}_{j} ( - {β}_{i , j} ) = {E}_{j} ( {γ}_{i} \cdot {k}_{j} - {β}_{i , j} ) = {E}_{j} ( {α}_{i , j} )$$

$${\hat{D}}_{i , j} = {x}_{1} ⊙ {K}_{j} ⊕ {E}_{j} ( - {\hat{β}}_{i , j} ) = {E}_{j} ( {γ}_{i} \cdot {k}_{j} - {\hat{β}}_{i , j} ) = {E}_{j} ( {\hat{α}}_{i , j} )$$

In the two formulas, ⊙ and ⊕ respectively represent a homomorphic multiplication operation and a homomorphic addition operation.

Details are as follows:

After receiving K₂=E₂(k₂) the broadcast by P₂, P₁ selects two masks β_{1,2}, \hat{β}_{1,2}∈ [symbol] . Further, P₁ can calculate intermediate ciphertexts D_{1,2} and \hat{D}_{1,2} based on the homomorphic algorithm, and send the intermediate ciphertexts to P₂.

$${D}_{1 , 2} = {γ}_{1} ⊙ {K}_{2} ⊕ {E}_{2} ( - {β}_{1 , 2} ) = {E}_{2} ( {γ}_{1} \cdot {k}_{2} - {β}_{1 , 2} ) = {E}_{2} ( {α}_{1 , 2} )$$

$${\hat{D}}_{1 , 2} = {x}_{1} ⊙ {K}_{2} ⊕ {E}_{2} ( - {\hat{β}}_{1 , 2} ) = {E}_{2} ( {x}_{1} \cdot {k}_{2} - {\hat{β}}_{1 , 2} ) = {E}_{2} ( {\hat{α}}_{1 , 2} )$$

As such, P₂ receives D_{1,2}=E₂(α_{1,2}) and \hat{D}_{1,2}=E₂(\hat{α}_{1,2}). Although P₂ has a corresponding Paillier private key e₂, and k₂ is also generated by P₂, due to a mask function of the masks β_{i,j}, \hat{B}_{i,j} selected by P₁, P₂ cannot infer a private key share x₁ and a random value y₁ of P₁, thereby completing information transmission on this basis. The following is similar, and details are omitted.

After receiving K₃=E₃(k₃) the broadcast by P₃, P₁ can calculate intermediate ciphertexts D_{1,3} and \hat{D}_{1,3} based on the homomorphic algorithm, and send the intermediate ciphertexts to P₃.

$${D}_{1 , 3} = {γ}_{1} ⊙ {K}_{3} ⊕ {E}_{3} ( - {β}_{1 , 3} ) = {E}_{3} ( {γ}_{1} \cdot {k}_{3} - {β}_{1 , 3} ) = {E}_{3} ( {α}_{1 , 3} )$$

$${\hat{D}}_{1 , 3} = {x}_{1} ⊙ {K}_{3} ⊕ {E}_{3} ( - {\hat{β}}_{1 , 3} ) = {E}_{3} ( {x}_{1} \cdot {k}_{3} - {\hat{β}}_{1 , 3} ) = {E}_{3} ( {\hat{α}}_{1 , 3} )$$

Similarly, after receiving K₁=E₁(k₁) the broadcast by P₁, P₂ can calculate intermediate ciphertexts D_{2,1} and \hat{D}_{2,1} based on the homomorphic algorithm, and send the intermediate ciphertexts to P₁.

$${D}_{{2}_{,} 1} = {γ}_{2} ⊙ {K}_{1} ⊕ {E}_{1} ( - {β}_{{2}_{,} 1} ) = {E}_{1} ( {γ}_{2} \cdot {k}_{1} - {β}_{2 , 1} ) = {E}_{1} ( {α}_{2 , 1} )$$

$${\hat{D}}_{2 , 1} = {x}_{2} ⊙ {K}_{1} ⊕ {E}_{1} ( - {\hat{β}}_{{2}_{,} 1} ) = {E}_{1} ( {x}_{2} \cdot {k}_{1} - {\hat{β}}_{2 , 1} ) = {E}_{1} ( {\hat{α}}_{2 , 1} )$$

After receiving K₃=E₃(k₃) the broadcast by P₃, P₂ can calculate intermediate ciphertexts D_{2,3} and \hat{D}_{2,3} based on the homomorphic algorithm, and send the intermediate ciphertexts to P₃.

$${D}_{{2}_{,} 3} = {γ}_{2} ⊙ {K}_{3} ⊕ {E}_{3} ( - {β}_{{2}_{,} 3} ) = {E}_{3} ( {γ}_{2} \cdot {k}_{3} - {β}_{2 , 3} ) = {E}_{3} ( {α}_{2 , 3} )$$

$${\hat{D}}_{2 , 3} = {x}_{2} ⊙ {K}_{3} ⊕ {E}_{3} ( - {\hat{β}}_{{2}_{,} 3} ) = {E}_{3} ( {x}_{2} \cdot {k}_{3} - {\hat{β}}_{2 , 3} ) = {E}_{3} ( {\hat{α}}_{2 , 3} )$$

Similarly, after receiving K₁=E₁(k₁) the broadcast by P₁, P₃ can calculate intermediate ciphertexts D_{3,1} and \hat{D}_{3,1} based on the homomorphic algorithm, and send the intermediate ciphertexts to P₁.

$${D}_{3 , 1} = {γ}_{3} ⊙ {K}_{1} ⊕ {E}_{1} ( - {β}_{3 , 1} ) = {E}_{1} ( {γ}_{3} \cdot {k}_{1} - {β}_{3 , 1} ) = {E}_{1} ( {α}_{3 , 1} )$$

$${\hat{D}}_{3 , 1} = {x}_{3} ⊙ {K}_{1} ⊕ {E}_{1} ( - {\hat{β}}_{3 , 1} ) = {E}_{1} ( {x}_{3} \cdot {k}_{1} - {\hat{β}}_{3 , 1} ) = {E}_{1} ( {\hat{α}}_{3 , 1} )$$

After receiving K₂=E₂(k₂) the broadcast by P₂, P₃ can calculate intermediate ciphertexts D_{3,2} and \hat{D}_{3,2} based on the homomorphic algorithm, and send the intermediate ciphertexts to P₂.

$${D}_{3 , 2} = {γ}_{3} ⊙ {K}_{2} ⊕ {E}_{2} ( - {β}_{3 , 2} ) = {E}_{2} ( {γ}_{3} \cdot {k}_{2} - {β}_{3 , 2} ) = {E}_{2} ( {α}_{3 , 2} )$$

$${\hat{D}}_{3 , 2} = {x}_{3} ⊙ {K}_{2} ⊕ {E}_{2} ( - {\hat{β}}_{3 , 2} ) = {E}_{2} ( {x}_{3} \cdot {k}_{2} - {\hat{β}}_{3 , 2} ) = {E}_{2} ( {\hat{α}}_{3 , 2} )$$

S13: Further, each participant Pᵢ decrypts the received intermediate ciphertexts D_{j,i} and \hat{D}_{j,i} by using a corresponding homomorphic encryption private key, to obtain plaintexts α_{j,i}, \hat{α}_{j,i}, referred to as intermediate plaintexts here, where α_{j,i}=γⱼ·kᵢ−β_{j,i} and α_{j,i}=xⱼ·kᵢ−\hat{β}_{j,i}.

Further, an intermediate value δᵢ can be calculated based on the first random value kᵢ, the second random value γᵢ, and the intermediate plaintexts α_{j,i}, â_{j,i}, and the private key share component mask value χᵢ can be calculated based on the private key share component xᵢ, the first random value kᵢ, and the intermediate plaintexts α_{j,i}, â_{j,i}.

$${δ}_{i} = {γ}_{i} {k}_{i} + {\sum }_{j \neq 1} ( {α}_{j , i} + {β}_{j , i} )$$

$${χ}_{i} = {γ}_{i} {k}_{i} + {\sum }_{j \neq 1} ( {\hat{α}}_{j , i} + {\hat{β}}_{j , i} )$$

Here, there are two relational expressions:

$${Σ}_{i = 1}^{t + 1} {δ}_{i} = ( {k}_{1} + {k}_{2} + ⋯ + {k}_{t + 1} ) \cdot ( {γ}_{1} + {γ}_{2} + … + {γ}_{t + 1} ) \qquad Relational expression 1$$

$${Σ}_{i = 1}^{t + 1} {χ}_{i} = ( {k}_{1} + {k}_{2} + ⋯ + {k}_{t + 1} ) \cdot ( {x}_{1} + {x}_{2} + ⋯ + {x}_{t + 1} ) \qquad Relational expression 2$$

A reason is as follows:

$${\sum }_{i = 1}^{t + 1} {δ}_{i} = {\sum }_{i = 1}^{t + 1} ( {γ}_{i} {k}_{i} + {\sum }_{j \neq i} ( {α}_{{i}_{,} j} + {β}_{{i}_{.} j} ) ) = {\sum }_{i = 1}^{t + 1} {γ}_{i} {k}_{i} + {\sum }_{i = 1}^{t + 1} ( {\sum }_{j \neq i} ( {α}_{i , j} + {β}_{i , j} ) ) = \text{} ( {γ}_{1} {k}_{1} + {γ}_{2} {k}_{2} + ⋯ + {γ}_{t + 1} {k}_{t + 1} ) + {\sum }_{i = 1}^{t + 1} ( {\sum }_{j \neq i} ( {α}_{i , j} + {β}_{i , j} ) ) = \text{} ( {γ}_{1} {k}_{1} + {γ}_{2} {k}_{2} + ⋯ + {γ}_{t + 1} {k}_{t + 1} ) + {\sum }_{i = 1}^{t + 1} ( {\sum }_{j \neq i} ( {γ}_{i} . {k}_{j} - {β}_{i , j} + {β}_{{i}_{,} j} ) ) = \text{} ( {γ}_{1} {k}_{1} + {γ}_{2} {k}_{2} + ⋯ + {γ}_{t + 1} {k}_{t + 1} ) + {\sum }_{i = 1}^{t + 1} ( {\sum }_{j \neq i} ( {γ}_{i} . {k}_{j} ) ) = ( {γ}_{1} {k}_{1} + {γ}_{2} {k}_{2} + ⋯ + {γ}_{t + 1} {k}_{t + 1} ) + ( ( {γ}_{1} \cdot {k}_{2} + {γ}_{1} . \cdot {k}_{3} + ⋯ + {γ}_{1} \cdot {k}_{t + 1} ) + ( {γ}_{2} \cdot {k}_{1} + {γ}_{2} \cdot {k}_{3} + ⋯ + {γ}_{2} \cdot {k}_{t + 1} ) + … + ( {γ}_{t + 1} \cdot {k}_{1} + {γ}_{t + 1} \cdot {k}_{2} + ⋯ + {γ}_{t + 1} \cdot {k}_{t} ) ) = ( {k}_{1} + {k}_{2} + ⋯ + {k}_{t + 1} ) ( {γ}_{1} + {γ}_{2} + ⋯ + {γ}_{t + 1} )$$

$${\sum }_{i = 1}^{t + 1} {χ}_{i} = {\sum }_{i = 1}^{t + 1} ( {x}_{i} {k}_{i} + {\sum }_{j \neq i} ( {\hat{α}}_{{i}_{,} j} + {\hat{β}}_{i , j} ) ) = {\sum }_{i = 1}^{t + 1} ( {x}_{i} {k}_{i} ) + {\sum }_{i = 1}^{t + 1} ( {\sum }_{j \neq i} ( {\hat{α}}_{i , j} + {\hat{β}}_{{i}_{,} j} ) ) = ( {x}_{I} {k}_{1} + {x}_{2} {k}_{2} + ⋯ + {x}_{t + 1} {k}_{t + 1} ) + {\sum }_{i = 1}^{t + 1} ( {\sum }_{j \neq i} ( {\hat{α}}_{i , j} + {\hat{β}}_{{i}_{,} j} ) ) = ( {x}_{I} {k}_{1} + {x}_{2} {k}_{2} + ⋯ + {x}_{t + 1} {k}_{t + 1} ) + {\sum }_{i = 1}^{t + 1} ( {\sum }_{j \neq i} ( {x}_{i} \cdot {k}_{j} - {\hat{β}}_{i , j} + {\hat{β}}_{{i}_{,} j} ) ) = ( {x}_{1} {k}_{1} + {x}_{2} {k}_{2} + ⋯ + {x}_{t + 1} {k}_{t + 1} ) + {\sum }_{i = 1}^{t + 1} ( {\sum }_{j \neq i} ( {x}_{i} \cdot {k}_{j} ) ) = ( {x}_{I} {k}_{1} + {x}_{2} {k}_{2} + ⋯ + {x}_{t + 1} {k}_{t + 1} ) + ( ( {x}_{1} \cdot {k}_{2} + {x}_{1} \cdot {k}_{3} + ⋯ + {x}_{1} \cdot {k}_{t + 1} ) + ( {x}_{2} \cdot {k}_{1} + {x}_{2} \cdot {k}_{3} + ⋯ + {x}_{2} \cdot {k}_{t + 1} ) + ⋯ + ( {x}_{t + 1} \cdot {k}_{1} + {x}_{t + 1} \cdot {k}_{2} + ⋯ + {x}_{t + 1} \cdot {k}_{t} ) ) = ( {k}_{1} + {k}_{2} + ⋯ + {k}_{t + 1} ) \cdot ( {x}_{1} + {x}_{2} + ⋯ + {x}_{t + 1} )$$

In addition, a public key Γᵢ=γᵢG corresponding to the second random value γᵢ can be calculated.

Further, P can send the intermediate value δᵢ and the public key Γᵢ corresponding to the second random value γᵢ to another participant.

Details are as follows:
P₁ decrypts the received ciphertexts D_{2,1} and \hat{D}_{2,1} by using a corresponding homomorphic encryption private key, to respectively obtain intermediate plaintexts α_{2,1}, \hat{α}_{2,1}, where α_{2,1}=γ₂·k₁−β_{2,1} and \hat{α}_{2,1}=x₂·k₁−\hat{β}_{2,1}; and P₁ decrypts the received ciphertexts D_{3,1} and \hat{D}_{3,1} by using a corresponding homomorphic encryption private key, to respectively obtain intermediate plaintexts α_{3,1}, \hat{α}_{3,1}, where α_{3,1}=γ₃·k₁−β_{3,1} and \hat{α}_{3,1}=x₃·k₁−\hat{β}_{3,1}. Further, δ₁=γᵢk₁+(α_{2,1}+β_{2,1}+α_{3,1}+β_{3,1}) and χ₁=x₁k₁+(\hat{α}_{2,1}+\hat{β}_{2,1}+\hat{α}_{3,1}+\hat{β}_{3,1}) are calculated. In addition, P₁ can calculate a public key Γ₁=γ₁G corresponding to the second random value γ₁. Further, P₁ can send the intermediate value δ₁ and the public key Γ₁ corresponding to the second random value γ₁ to the other participants P₂ and P₃.

P₂ decrypts the received ciphertexts D_{1,2} and \hat{D}_{1,2} by using a corresponding homomorphic encryption private key, to obtain intermediate plaintexts α_{1,2}, \hat{α}_{1,2}, where α_{1,2}=γ₁·k₂−β_{1,2} and \hat{α}_{1,2}=x₁·k₂−\hat{β}_{1,2}; and P₂ decrypts the received ciphertexts D_{3,2} and \hat{D}_{3,2} by using a corresponding homomorphic encryption private key, to obtain intermediate plaintexts α_{3,2}, \hat{α}_{3,2}, where α_{3,2}=γ₃·k₂−β_{3,2} and \hat{α}_{3,2}=x₃·k₂−\hat{β}_{3,2}. Further, δ₂=γ₂k₂+(α_{1,2}+β_{1,2}+α_{3,2}+β_{3,2}) and χ₂=x₂k₂+(\hat{α}1,2+\hat{β}_{1,2}+\hat{α}_{3,2}+\hat{β}_{3,2}) are calculated. In addition, P₂ can calculate a public key Γ₂=γ₂G corresponding to the second random value γ₂. Further, P₂ can send the intermediate value δ₂ and the public key Γ₂ corresponding to the second random value γ₂ to the other participants P₁ and P₂.

P₃ decrypts the received ciphertexts D_{1,3} and \hat{D}_{1,3} by using a corresponding homomorphic encryption private key, to obtain intermediate plaintexts α_{1,3}, \hat{α}_{1,3}, where α_{1,3}=γ₁·k₃−β_{1,3} and \hat{α}_{1,3}=x₁·k₃−\hat{β}_{1,3}; and P₃ decrypts the received ciphertexts D_{2,3} and \hat{D}_{2,3} by using a corresponding homomorphic encryption private key, to obtain intermediate plaintexts α_{2,3}, \hat{α}_{2,3}, where α_{2,3}=γ₂·k₃−β_{2,3} and \hat{α}_{2,3}=x₂·k₃−\hat{β}_{2,3}. Further, δ₃=γ₃k₃+(α_{1,3}+β_{1,3}+α_{2,3}+β_{2,3}) and χ₃=x₃k₃+(\hat{α}_{1,3}+\hat{β}_{1,3}+\hat{α}_{2,3}+\hat{β}_{2,3}) are calculated. In addition, P₃ can calculate a public key Γ₃=γ₃G corresponding to the second random value γ₃. Further, P₃ can send the intermediate value δ₃ and the public key Γ₃ corresponding to the second random value γ₃ to the other participants P₁ and P₂.

So far, Pᵢ locally has δ_{j∈[t+1]}, Γ_{j∈[t+1]}, kᵢ, and χᵢ. Therefore, Pᵢ can calculate a point R=(Σ_{j∈[t+}1]δⱼ)⁻¹·(Σ_{j∈[t+}1]Γⱼ). In fact, it can be obtained from the relational expression 1 that R=(Σ_{j∈[t+1]}δⱼ)⁻¹·(Σ_{j∈[t+1]}Γⱼ)=(k₁+k₂+ . . . +kₜ₊₁)·(γ₁+γ₂+ . . . +γₜ₊₁)⁻¹·(Σ_{j∈[t+1]}Γⱼ)=k⁻¹·γ⁻¹·(Σ_{j∈[t+1]}Γⱼ)=k⁻¹·γ⁻¹·(Σ_{j∈[t+1]}γⱼG)=k⁻¹·y⁻¹·γG=k⁻¹·G. This is the same as the above-mentioned ECDSA form. Pᵢ can calculate r=f(R). As described above, f(R) can be horizontal coordinates of a point R. Therefore, Pᵢ can locally store (r, kᵢ, χᵢ). So far, the offline phase ends.

Examples are as follows:

P₁ locally has δ₁, Γ₁, δ₂, Γ₂, δ₃, Γ₃, k₁, and χ₁. As described above, P₁ can calculate the point R based on δ₁, Γ₁, δ₂, Γ₂, δ₃, Γ₃, and r=f(R). Therefore, P₁ can locally store (r, k₁, χ₁).

Similarly, P₂ locally has δ₁, Γ₁, δ₂, Γ₂, δ₃, Γ₃, k₂, and χ₂. As described above, P₂ can calculate the point R based on δ₁, Γ₁, δ₂, Γ₂, δ₃, Γ₃, and r=f(R). Therefore, P₂ can locally store (r, k₂, ×₂).

Similarly, P₃ locally has δ₁, Γ₁, δ₂, Γ₂, δ₃, Γ₃, k₃, and χ₃. As described above, P₃ can calculate the point R based on δ₁, Γ₁, δ₂, Γ₂, δ₃, Γ₃, and r=f(R). Therefore, P₃ can locally store (r, k₃, ×₃).

In the online phase, each of the at least t+1 participants signs the same message by using the first random value kᵢ, the private key share component mask value χᵢ, and the coordinate component r of the participant in the online phase, to obtain at least a quantity t+1 of signature shares σᵢ.

A hash value of a message m is H(m). Each participant Pᵢ in the at least t+1 participants can calculate H(m) by using locally stored (r, kᵢ, χᵢ), to obtain the signature share sigᵢ=(r, σᵢ). Specifically, σᵢ can be calculated based on the following equation:

$${σ}_{i} = {k}_{i} H ( m ) + {χ}_{i} r$$

As such, after obtaining the at least the quantity t+1 of signature shares, any party can aggregate the at least the quantity t+1 of signature shares into a total signature sig=(r, σ). In addition, correctness of the total signature σ can be verified by using the total public key X. A reason is as follows: A form of the formula is the same as the above-mentioned ECDSA form.

It should be first noted that the following relationship exists:

$${\sum }_{i ∈ [ 1 , t + 1 ]} {x}_{i} = {\sum }_{i ∈ [ 1 , t + 1 ]} {λ}_{i} {s}_{i} = {\prod }_{i ∈ [ 1 , t + 1 ] , i \neq 1} \frac{i}{i - 1} \cdot {s}_{1} + {\prod }_{i ∈ [ 1 , t + 1 ] , i \neq 2} \frac{i}{i - 2} \cdot {s}_{2} + … + {\prod }_{i ∈ [ 1 , t + 1 ] , i \neq t + 1} \frac{i}{i - ( t + 1 )} \cdot {s}_{t + 1} = {\prod }_{i ∈ [ 1 , t + 1 ] , i \neq 1} \frac{i}{i - 1} \cdot {\sum }_{j ∈ [ 1 , n ]} {s}_{1 j} + {\prod }_{i ∈ [ 1 , n ] , i \neq 2} \frac{i}{i - 2} \cdot {\sum }_{j ∈ [ 1 , n ]} {s}_{1 j} + … + {\prod }_{i ∈ [ 1 , t + 1 ] , i \neq t + 1} \frac{i}{i - ( t + 1 )} \cdot {\sum }_{j ∈ [ 1 , n ]} {s}_{1 j} = {s}_{10} + {s}_{20} + … + {s}_{n 0} = f ( 0 )$$

As such, the at least the quantity t+1 of signature shares are aggregated into the total signature σ:

$$σ = {\sum }_{j ∈ [ 1 , t + 1 ]} {σ}_{i} = {\sum }_{j ∈ [ 1 , t + 1 ]} ( {k}_{i} H ( m ) + {χ}_{i} r ) = {\sum }_{j ∈ [ 1 , t + 1 ]} {k}_{i} H ( m ) + {\sum }_{j ∈ [ 1 , t + 1 ]} {χ}_{i} r = ( {k}_{1} + {k}_{2} + … + {k}_{t + 1} ) \cdot H ( m ) + ( {k}_{1} + {k}_{2} + … + {k}_{t + 1} ) \cdot ( {x}_{1} + {x}_{2} + … + {x}_{t + 1} ) \cdot γ = k \cdot H ( m ) + k \cdot x \cdot r$$

Here, x=s₁₀+s₂₀+ . . . +sₙ₀=f(0). It can be seen that σ=k·H(m)+k·x·r here is substantially the same as that Equation (a) in the above-mentioned ECDSA signature algorithm. Therefore, it is clear that verification can be performed by using the total public key X.

The above-mentioned example continues. Any party (which can be any of n=4 participants, or can be a participant other than n=4 participants) obtains t+1=3 signature shares:

$${σ}_{1} = {k}_{1} H ( m ) + {χ}_{1} r$$

$${σ}_{2} = {k}_{2} H ( m ) + {χ}_{2} r$$

$${σ}_{3} = {k}_{3} H ( m ) + {χ}_{3} r$$

First, the following relationship exists:

$${x}_{1} + {x}_{2} + {x}_{3} = {λ}_{1} {s}_{1} + {λ}_{2} {s}_{2} + {λ}_{3} {s}_{3} = \frac{2}{2 - 1} \cdot \frac{3}{3 - 1} \cdot ( {s}_{11} + {s}_{21} + {s}_{31} + {s}_{41} ) + \frac{1}{1 - 2} \cdot \frac{3}{3 - 2} \cdot ( {s}_{12} + {s}_{22} + {s}_{32} + {s}_{42} ) + \frac{1}{1 - 3} \cdot \frac{2}{2 - 3} \cdot ( {s}_{13} + {s}_{23} + {s}_{33} + {s}_{43} ) = 3 \cdot ( {s}_{11} + {s}_{21} + {s}_{31} + {s}_{41} ) - 3 \cdot ( {s}_{12} + {s}_{22} + {s}_{32} + {s}_{42} ) + ( {s}_{13} + {s}_{23} + {s}_{33} + {s}_{43} ) = 3 {f}_{1} ( 1 ) + 3 {f}_{2} ( 1 ) + 3 {f}_{3} ( 1 ) + 3 {f}_{4} ( 1 ) - 3 {f}_{1} ( 2 ) - 3 {f}_{2} ( 2 ) - 3 {f}_{3} ( 2 ) - 3 {f}_{4} ( 2 ) + {f}_{1} ( 3 ) + {f}_{2} ( 3 ) + {f}_{3} ( 3 ) + {f}_{4} ( 3 ) = 3 ( {s}_{10} + {a}_{11} + {a}_{12} ) + 3 ( {s}_{20} + {a}_{21} + {a}_{22} ) + 3 ( {s}_{30} + {a}_{31} + {a}_{32} ) + 3 ( {s}_{40} + {a}_{41} + {a}_{42} ) - 3 ( {s}_{10} + 2 {a}_{11} + 4 {a}_{12} ) - 3 ( {s}_{20} + 2 {a}_{21} + 4 {a}_{22} ) - 3 ( {s}_{30} + 2 {a}_{31} + 4 {a}_{32} ) - 3 ( {s}_{40} + 2 {a}_{41} + 4 {a}_{42} ) + ( {s}_{10} + 3 {a}_{11} + 9 {a}_{12} ) + ( {s}_{20} + 3 {a}_{21} + 9 {a}_{22} ) + ( {s}_{30} + 3 {a}_{31} + 9 {a}_{32} ) + ( {s}_{40} + 3 {a}_{41} + 9 {a}_{42} ) = {s}_{10} + {s}_{20} + {s}_{30} + ( 3 {a}_{11} - 6 {a}_{11} + 3 {a}_{11} ) + ( 3 {a}_{12} - 12 {a}_{12} + 9 {a}_{12} ) + ( 3 {a}_{21} - 6 {a}_{21} + 3 {a}_{21} ) + ( 3 {a}_{22} - 12 {a}_{22} + 9 {a}_{22} ) + ( 3 {a}_{31} - 6 {a}_{31} + 3 {a}_{31} ) + ( 3 {a}_{32} - 12 {a}_{32} + 9 {a}_{32} ) + ( 3 {a}_{41} - 6 {a}_{41} + 3 {a}_{41} ) + ( 3 {a}_{42} - 12 {a}_{42} + 9 {a}_{42} ) = {s}_{10} + {s}_{20} + {s}_{30} + {s}_{40} = f ( 0 )$$

Therefore, σ=Σ_{i∈[1,3]}σᵢ=Σ_{i∈[1,3]}(kᵢH(m)+χᵢr)=Σ_{i∈[1,3]}kᵢ(m)+Σ_{j∈[1,3]}χᵢr=(k₁+k₂+k₃)·H(m)+(k₁+k₂+k₃)·(x₁+x₂+x₃)·r=k·H(m)+k·x·r is calculated.

Here, x=s₁₀+s₂₀+ . . . +s₄₀=f(0). This is equal to the sum of secrets respectively set by the n participants in the distributed threshold signature protocol. It can be seen that σ=k·H(m)+k·x·r here is substantially the same as that Equation (a) in the above-mentioned ECDSA signature algorithm. Therefore, it is clear that verification can be performed by using the total public key X.

The above-mentioned effect of this implementation of this application first lies in that any threshold can be supported.

Similar to the ECC-based cryptography solution, two times of encryption cannot be performed by using the same parameter k. Otherwise, k can be obtained by another person. Therefore, a new parameter k is preferably used in each signature process. The at least t+1 participants can perform the offline phase again, to generate at least t+1 parameters kᵢ, thereby obtaining a new parameter k.

The above-mentioned process can be that the distributed key generation phase is jointly executed by the n participants one time, and then the at least t+1 participants execute the offline phase and the online phase in each time of signature. Alternatively, after the n participants jointly execute the distributed key generation phase one time, the at least t+1 participants execute the offline phase a plurality of times, thereby generating a plurality of different k values. As such, different R values and a corresponding value of r are generated, to be used for signing in each subsequent online phase.

SM2 includes a digital signature algorithm, a key exchange protocol, and a public key encryption algorithm. A basic SM2 signature algorithm includes:

A signer Alice selects an elliptic curve E_{q}(a, b) and a base point g, and shares the information with a verifier Bob, where q is a modulus.

Alice selects a private key x∈ [symbol] in a finite field [symbol] , and generates a public key X=g^{x} based on the private key.

Alice selects a random number k∈ [symbol] in the finite field [symbol] , and calculates K=g^{k}=(x₁,y₁), and x₁ and y₁ are respectively a horizontal coordinate and a vertical coordinate of K points on an elliptic curve.

Alice obtains a digest value H(m) by performing hash calculation on a to-be-signed message m, and calculates:

$$r = H ( m ) + {x}_{1} mod q \qquad Equation ( a )$$

On this basis, the following is calculated:

$$s = {( 1 + x )}^{- 1} \cdot ( k - r \cdot x ) mod p \qquad Equation ( b )$$

Alice generates a signature σ=(r, s), and sends the message m, the signature σ, and the public key X to a signer Bob.

Bob calculates coordinates of a point K′ by using the base point σ, the signature σ, and the public key X:

$${K}^{′} = {g}^{s} \cdot {X}^{r + s} = ( {x}_{1}^{′} , {y}_{1}^{′} ) \qquad Equation ( c )$$

Bob verifies the following equation by using r in the signature σ, the message m, and the horizontal coordinates x₁′ of the point K′:

$$r = H ( m ) + {x}_{1}^{′} mod q \qquad Equation ( d )$$

If the above-mentioned equations are true, the signature is valid; otherwise the signature is invalid.

A reason is as follows: It is equivalent to verifying whether coordinates

$$( {x}_{1}^{′} , {y}_{1}^{′} )$$

of the point K′ are equal to the coordinates (x₁, y₁) of the K point used in the signature:

$$( {x}_{1}^{′} , {y}_{1}^{′} ) = s \cdot G + ( r + s ) \cdot x \cdot G = ( 1 + x ) \cdot s \cdot G + r \cdot x \cdot G = ( k - r \cdot x ) \cdot G + r \cdot x \cdot G = k \cdot G = ( {x}_{1} , {y}_{1} )$$

Alternatively, an exponential form is expressed as follows:

$$( {x}_{1}^{′} , {y}_{1}^{′} ) = {g}^{s} \cdot {X}^{r + s} = {g}^{s} \cdot {g}^{{X}^{( r + s )}} = {g}^{s} \cdot {g}^{X ( r + s )} = {g}^{( 1 + X ) s + Xr} = {g}^{( k - r \cdot X ) + Xr} = {g}^{k} = ( {x}_{1} , {y}_{1} )$$

The basic SM2 signature algorithm can also be extended to a threshold signature algorithm. For example, after the above-mentioned DKG process, each of n signers P₁, P₂, . . . , Pₙ has a secret share of the signer, and has a total public key. A threshold is t, and t<n. Each of at least t+1 signers of the n participants uses a secret share of the signer as a private key share, and signs and broadcasts the same to-be-signed information. Then, any verifier that collects at least t+1 signature shares can restore a total signature, and can verify the total signature by using the total public key, to implement a threshold signature. In the article “SM2 Elliptic Curve Threshold Cryptography” published by Shang Ming, et al. in the Journal of Cryptography in 2014, an SM2-based distributed signature algorithm that satisfies a threshold t-n is constructed. That is, the n participants separately generate private key shards and corresponding public keys based on protocols, and the at least t+1 of the n participants can generate and verify a corresponding SM2 signature only by participating in an SM2 distributed signature protocol. A disadvantage of the algorithm is that (t, n) need to satisfy n≥2t+1, which leads to very inflexible application. For example, the algorithm cannot satisfy a threshold (2, 4) or a threshold (2, 3), which is the most frequently used in actual use.

One or more implementations of this application provide a distributed threshold signature method based on SM2.

This implementation of this application can include two parts: the distributed threshold key generation and the distributed threshold signature. The two parts both specify, in a form of a protocol, a process of how each participant transmits data and performs data processing, to cooperate to implement a specific purpose.

The following first describes a process of a distributed threshold key generation protocol. In this process, assume that there are a total of n participants: P₁, P₂, . . . , and Pₙ. Each participant Pᵢ (i={1, 2, . . . , n}) can generate a respective private key share xᵢ′ based on the distributed key generation protocol.

Each participant Pᵢ can generate a respective public-private key pair for homomorphic encryption, for example, a Paillier public-private key pair (Eᵢ, eᵢ). Here, eᵢ is a private key, and Eᵢ is a corresponding public key. In a homomorphic encryption technology, “homomorphic” processing can be performed on plaintext data. That is, the plaintext data are mapped onto a new and confidential state, so that only a receiver that owns a key can obtain the plaintext data. Paillier homomorphic addition is a public key encryption system widely used in cryptography, which is proposed by Pascal Paillier in 1999. A main feature of Paillier homomorphic addition is that Paillier homomorphic addition has an additive homomorphic property, which means that two ciphertexts are given, and a ciphertext corresponding to the sum of plaintexts of the two ciphertexts can be calculated without decryption. Specifically, assume that there are two plaintexts m1 and m2, and Paillier ciphertexts of the two plaintexts m1 and m2 are respectively c1 and c2. The additive homomorphic property of Paillier can be used to calculate a product of c1 and c2 to obtain a new ciphertext c, which is exactly the ciphertext of the sum of m1 and m2. The additive homomorphic property is an important feature of a Paillier encryption algorithm. A simple representation is E(m₁)·E(m₂)=E(m₁+m₂), where point multiplication · is subsequent homomorphic addition ⊕. The homomorphic property can be completing calculation in a specific form on encrypted data without leaking original data.

After generating a homomorphic encryption public-private key pair, each participant Pᵢ can send a public key to another participant.

For example, after generating public-private keys (E₁, e₁) for Paillier encryption, the participant P₁ broadcasts a homomorphic encryption public key E₁ to another participant; after generating public-private keys (E₂, e₂) for Paillier encryption, the participant P₂ broadcasts a homomorphic encryption public key E₂ to another participant; after generating public-private keys (E₃, e₃) for Paillier encryption, the participant P₃ broadcasts a homomorphic encryption public key E₃ to another participant; after generating public-private keys (E₄, e₄) for Paillier encryption, the participant P₄ broadcasts a homomorphic encryption public key E₄ to another participant; and after generating public-private keys (E₅, e₅) for Paillier encryption, the participant P₅ broadcasts a homomorphic encryption public key E₅ to another participant.

Each participant Pᵢ can generate a second random value γᵢ, and there are five participants P₁, P₂, P₃, P₄, and P₅ that respectively generate second random values γ₁, γ₂, γ₃, γ₄, and γ₅. Assume that the sum of secret values γᵢ generated by each participant Pᵢ is γ, that is

$$γ = {\sum }_{i = 1}^{n} {γ}_{i} .$$

In addition, each participant Pᵢ can generate a t-degree polynomial fᵢ(z)=aᵢ₀+aᵢ₁z+aᵢ₂z²+ . . . +aᵢₜz^{t}, where aᵢ₀ is a secret that is set by Pᵢ Here, γᵢ is set. A threshold here is t, and therefore, a degree of the polynomial is also t.

If a threshold is 2, and a total quantity of participants is 5, that is, t=2, and n=5, there are a total of five participants P₁, P₂, P₃, P₄, and P₅ that respectively construct polynomials by using respectively generated secret values γ₁, γ₂, γ₃, γ₄, and γ₅.

P₁ generates a 2-degree (t=2) polynomial f₁(z)=a₁₀+a₁₁z+a₁₂z², where a₁₀ is a secret γ1 that is set by P₁.

P₂ generates a 2-degree (t=2) polynomial f₂(z)=a₂₀+a₂₁z+a₂₂z², where a₂₀ is a secret γ2 that is set by P₂.

P₃ generates a 2-degree (t=2) polynomial f₃(z)=a₃₀+a₃₁z+a₃₂z², where a₃₀ is a secret γ3 that is set by P₃.

P₄ generates a 2-degree (t=2) polynomial f₄(z)=a₄₀+a₄₁z+a₄₂z², where a₄₀ is a secret γ4 that is set by P₄.

P₅ generates a 2-degree (t=2) polynomial f(z)=a₅₀+a₅₁z+a₅₂z², where a₅₀ is a secret γ5 that is set by P₅.

Further, each participant Pᵢ can generate n secret shares, retain one of the secret shares, and encrypt and send the remaining secret shares to another participant. For example, the participant Pᵢ generates coordinates of n points on a curve corresponding to a polynomial of the participant as n secret shares, retains coordinates of one of the points, and encrypts and sends coordinates of the remaining points to another participant.

Specifically, examples are as follows:

P₁ generates s₁₁=f₁(1), s₁₂=f₁(2), s₁₃=f₁(3), s₁₄=f₁(4), s₁₅=f₁(5), retains s₁₁, encrypts and sends s₁₂ to P₂, encrypts and sends s₁₃ to P₃, encrypts and sends s₁₄ to P₄, and encrypts and sends s₁₅ to P₅.

P₂ generates s₂₁=f₂(1), s₂₂=f₂(2), s₂₃=f₂(3), s₂₄=f₂(4), s₂₅=f₂(5), retains s₂₂, encrypts and sends s₂₁ to P₁, encrypts and sends s₂₃ to P₃, encrypts and sends s₂₄ to P₄, and encrypts and sends s₂₅ to P₅.

P₃ generates s₃₁=f₃(1), s₃₂=f₃(2), s₃₃=f₃(3), s₃₄=f₃(4), s₃₅=f₃(5), retains s₃₃, encrypts and sends s₃₁ to P₁, encrypts and sends s₃₂ to P₂, encrypts and sends s₃₄ to P₄, and encrypts and sends s₃₅ to P₅.

P₄ generates s₄₁=f₄(1),s₄₂=f₄(2), s₄₃=f₄(3), s₄₄=f₄(4), s₄₅=f₄(5), retains s₄₄, encrypts and sends s₄₁ to P₁, encrypts and sends s₄₂ to P₂, encrypts and sends s₄₃ to P₃, and encrypts and sends s₄₅ to P₅.

P₅ generates s₅₁=f₅(1), s₅₂=f₅(2), s₅₃=f₅(3), s₅₄=f₅(4), s₅₅=f₅(5), retains s₅₅, encrypts and sends s₅₁ to P₁, encrypts and sends s₅₂ to P₂, encrypts and sends s₅₃ to P₃; and encrypts and sends s₅₄ to P₄.

In this case, P₁ locally has secret shares s₁₁, s₂₁, s₃₁, s₄₁, and s₅₁ generated by different participants; P₂ locally has secret shares s₁₂, s₂₂, s₃₂, s₄₂, and s₅₂ generated by different participants; P₃ locally has secret shares s₁₃, s₂₃, s₃₃, s₄₃, and s₅₃ generated by different participants; P₄ locally has secret shares s₁₄, s₂₄, s₃₄, s₄₄, and s₅₄ generated by different participants; and P₅ locally has secret shares s₁₅, s₂₅, s₃₅, s₄₅, and s₅₅ generated by different participants.

In addition, each participant Pᵢ can calculate a homomorphic encryption value Rᵢ=Eᵢ(γᵢ) corresponding to a secret value γᵢ generated by the participant, and broadcast the homomorphic encryption value to another participant.

Then, each participant Pᵢ can obtain the sum of secret shares by summarizing a secret share sᵢᵢ retained by each participant and a secret share sⱼᵢ obtained from another participant Pⱼ. For example, a summarization method is summarization. For example, the sum of secret shares of the participant Pᵢ is

$${ω}_{i} = {\sum }_{j = 1}^{n} {s}_{ji} .$$

Specifically, examples are as follows: the participant P₁ can calculate that the sum of secret shares ω₁ is ω₁=s₁₁+s₂₁+s₃₁+s₄₁+s₅₁; the participant P₂ can calculate that the sum of secret shares ω₂ is ω₂=s₁₂+s₂₂+s₃₂+s₄₂+s₅₂, the participant P₃ can calculate that the sum of secret shares ω₃ is ω₃=s₁₃+s₂₃+s₃₃+s₄₃+s₅₃; the participant P₄ can calculate that the sum of secret shares ω₄ is ω₄=s₁₄+s₂₄+s₃₄+s₄₄+s₅₄; and the participant P₅ can calculate that the sum of secret shares ω₅ is ω₅=s₁₅+s₂₅+s₃₅+s₄₅+s₅₅.

In addition, each participant Pᵢ can further generate a public verification parameter Aᵢₖ=aᵢₖG corresponding to the polynomial of degree t of each participant, where k=0, 1, . . . , t, and publish the public verification parameter to each participant. Details are as follows: the participant P₁ generates A₁ₖ=a₁ₖG, where k=0, 1, . . . , t=2, including A₁₀=a₁₀G=s₁₀G, A₁₁=a₁₁G, and A₁₂=a₁₂G, and broadcasts {A₁₀, A₁₁, A₁₂} to P₂, P₃, P₄, and P₅; the participant P₂ generates A₂ₖ=a₂ₖG, where k=0, 1, . . . , t=2, including A₂₀=a₂₀G=s₂₀G, A₂₁=a₂₁G, and A₂₂=a₂₂G, and broadcasts {A₂₀, A₂₁, A₂₂} to P₁, P₃, P₄, and P₅; the participant P₃ generates A₃ₖ=a₃ₖG, where k=0, 1, . . . , t=2, including A₃₀=a₃₀G=s₃₀G, A₃₁=a₃₁G, and A₃₂=a₃₂G, and broadcasts {A₃₀, A₃₁, A₃₂} to P₁, P₂, P₄, and P₅; the participant P₄ generates A₄ₖ=a₄ₖG, where k=0, 1, . . . , t=2, including A₄₀=a₄₀G=s₄₀G, A₄₁=a₄₁G, and A₄₂=a₄₂G, and broadcasts {A₄₀, A₄₁, A₄₂} to P₁, P₂, P₃, and P₅; and the participant P₅ generates A₅ₖ=a₅ₖG, where k=0, 1, . . . , t=2, including A₅₀=a₅₀G=s₅₀G, A₅₁=a₅₁G, and A₅₂=a₅₂G, and broadcasts {A₅₀, A₅₁, A₅₂} to P₁, P₂, P₃, and P₄.

Each participant Pᵢ can further verify, based on public verification parameters {Aⱼ₀, Aⱼ₁, . . . , Aⱼₜ} of Pᵢ, the secret share sⱼᵢ sent by Pⱼ, for example, based on the following formula:

$${s}_{ji} G = {A}_{j 0} + {iA}_{j 1} + … + {i}^{t} {A}_{jt}$$

Details are as follows:

The participant P₁ verifies s₂₁ based on s₂₁G=A₂₀+A₂₁+A₂₂, verifies s₃₁ based on s₃₁G=A₃₀+A₃₁+A₃₂, verifies s₄₁ based on s₄₁G=A₄₀+A₂₁+A₄₂, and verifies s₅₁ based on s₅₁G=A₅₀+A₅₁+A₅₂; the participant P₂ verifies s₁₂ based on s₁₂G=A₁₀₊₂A₁₁+2²A₁₂, verifies s₃₂ based on s₃₂G=A₃₀+2A₃₁+2²A₃₂, verifies s₄₂ based on s₄₂G=A₄₀+2A₂₁₊₂₂A₄₂, and verifies s₅₂ based on s₅₂G=A₅₀+2A₅₁+2²A₅₂; the participant P₃ verifies s₁₃ based on s₁₃G=A₁₀+3A₁₁+3²A₁₂, verifies s₂₃ based on s₂₃G=A₃₀+3A₃₁+3²A₃₂, verifies s₄₃ based on s₄₃G=A₄₀+3A₂₁+3²A₄₂, and verifies s₅₃ based on s₅₃G=A₅₀+3A₅₁+3²A₅₂; the participant P₄ verifies s₁₄ based on s₁₄G=A₁₀+4A₁₁+4²A₁₂, verifies s₂₄ based on s₂₄G=A₂₀+4A₂₁+4²A₂₂, verifies s₄₂ based on s₃₄G=A₄₀+4A₂₁+4²A₄₂, and verifies s₅₂ based on s₅₄G=A₅₀+4A₅₁+4²A₅₂; and the participant P₅ verifies s₁₅ based on s₁₅G=A₁₀+5A₁₁+5²A₁₂, verifies s₂₅ based on s₂₅G=A₂₀+5A₂₁+5²A₂₂, verifies s₃₅ based on s₃₅G=A₃₀+5A₃₁+5²A₃₂, and verifies s₄₅ based on s₄₅G=A₄₀+5A₄₁+5²A₄₂.

Any party can terminate a protocol if verification fails.

In another aspect, each participant Pᵢ can randomly select a first random value xᵢ∈ [symbol] , and five participants P₁, P₂, P₃, P₄, and P₅ respectively generate first random values x₁, x₂, x₃, x₄, and x₅. Corresponding public keys are respectively x₁=g^{x}^{₁}, x₂=g^{x}^{₂}, x₃=g^{x}^{₃}, x₄=g^{x}^{₄}, and x₅=g^{x}^{₅}. Each participant Pᵢ can broadcast, to another participant P_{i,j≠i}, a public key corresponding to a first random value generated by the participant. In this case, Pᵢ locally has {x₁, x₂, x₃, . . . , Xₙ}. Specifically, each of the five participants P₁, P₂, P₃, P₄, and P₅ locally has {x₁, x₂, x₃, x₄, x₅}.

Therefore, each participant Pᵢ can collect a public key set {Xⱼ}_{j∈[1,n]} and a second random value homomorphic ciphertext set {Rⱼ}_{je[1,n]} that correspond to the first random value.

Each participant Pᵢ can calculate the total public key X based on the public key set {Xⱼ}_{j∈[1,n]} corresponding to the first random value. A calculation method is similar to the above-mentioned method. For example, the following formula is used here:

$$X = {\prod }_{i = 1}^{n} {X}_{i} = {\prod }_{i = 1}^{n} {g}^{{x}_{i}} = {g}^{{x}_{1}} \cdot {g}^{{x}_{2}} \cdot … \cdot {g}^{{x}_{n}} = {g}^{{x}_{1} + {x}_{2} + … + {x}_{n}} = {g}^{x}$$

As described above, the total public key can be used to verify the subsequent aggregated total signature. x=x₁+x₂+ . . . +xₙ.

In addition, each participant Pᵢ can randomly select a first mask β_{i,j}∈ [symbol] between participants for Pⱼ can calculate a first intermediate ciphertext D_{i,j} based on a homomorphic algorithm, and send the first intermediate ciphertext to Pᵢ, for example, encrypt and calculate D_{i,j}=Xᵢ⊙Rⱼ⊕Eⱼ(−β_{i,j})=Eⱼ(xᵢ·γⱼ−β_{i,j}) by using Paillier.

As such, if the participant Pᵢ can receive D_{j,i}=xⱼ⊙Rᵢ⊕Eᵢ(−β_{j,i})=Eᵢ(xⱼ·γᵢ−β_{j,i})=Eᵢ(α_{i,j}), the participant can perform decryption by using a homomorphic encryption private key of the participant, for example, perform decryption by using a private key e₁ corresponding to the public key Eᵢ for Paillier encryption, to obtain xᵢ·γᵢ−β_{j,i}=α_{i,j}. Further, Pᵢ can calculate the first intermediate value

$${δ}_{i} = {γ}_{i} \cdot ( 1 + {x}_{i} ) + {\sum }_{j = 1 , j \neq i}^{n} ( {α}_{i , j} + {β}_{i , j} ) ,$$

and broadcast the first intermediate value δᵢ to another participant.

In a next step, after collecting the first intermediate value δ_{j,j∈[1,n]}, the participant Pᵢ can calculate

$$γ \cdot ( 1 + x ) = {\sum }_{j = 1}^{n} {δ}_{j} ,$$

and can use

$${x}_{i}^{′} = \frac{{ω}_{i}}{γ ( 1 + x )}$$

as a private key shard of the participant.

For example, for the five participants P₁, P₂, P₃, P₄, and P₅:

P₁ randomly selects a first mask β_{1,2} between participants for P₂, encrypts and calculates a first intermediate ciphertext D_{1,2}=x₁⊙R₂⊕E₂(−β_{1,2})=E₁(x₁·R₂)⊕E₂(−β_{1,2})=E₂(x₁·γ₂−β_{1,2}) by using Paillier, and sends D_{1,2} to P₂. Similarly, P₁ randomly selects a first mask β_{1,3} between participants for P₃, calculates a first intermediate ciphertext D_{1,3}=x₁⊙R₃⊕E₃(−β_{1,3})=E₃(x₁·γ₃−β_{1,3}), and sends D_{1,3} to P₃. Similarly, P₁ randomly selects a first mask β_{1,4} between participants for P₄, calculates a first intermediate ciphertext D_{1,4}=x₁⊙R₄⊕E₄(−β_{1,4})=E₄(x₁·γ₄−β_{1,4}), and sends D_{1,4} to P₄. Similarly, P₁ randomly selects a first mask β_{1,5} between participants for P₅, calculates a first intermediate ciphertext D_{1,5}=x₁⊙R₅⊕E₅(−β_{1,5})=E₅(x₁·γ₅−β_{1,5}), and sends D_{1,5} to P₅.

P₂ randomly selects a first mask β_{2,1} between participants for P₁, encrypts and calculates a first intermediate ciphertext D_{2,1}=x₂⊙R₁⊕E₁(−β_{2,1})=E₁(x₂·R₁)⊕E₁(−β_{2,1})=E₁(x₂·γ₁−β_{2,1}) by using Paillier, and sends D_{2,1} to P₁. Similarly, P₂ randomly selects a first mask β_{2,3} between participants for P₃, calculates a first intermediate ciphertext D_{2,3}=x₂⊙R₃⊕E₃(−β_{2,3})=E₃(x₂·γ₃−β_{2,3}), and sends D_{2,3} to P₃. Similarly, P₂ randomly selects a first mask β_{2,4} between participants for P₄, calculates a first intermediate ciphertext D_{2,4}=x₂⊙R₄⊕E₄(−β_{2,4})=E₄(x₂·γ₄−β_{2,4}), and sends D_{2,4} to P₄. Similarly, P₂ randomly selects a first mask β_{2,5} between participants for P₅, calculates a first intermediate ciphertext D_{2,5}=x₂⊙R₅⊕E₅(−β_{2,5})=E₅(x₂·γ₅−β_{2,5}), and sends D_{2,5} to P₅.

P₃ randomly selects a first mask β3,1 between participants for P₁, encrypts and calculates a first intermediate ciphertext D_{3,1}=x₃⊙R₁⊕E₁(−β_{3,1})=E₁(x₃·R₁)⊕E₁(−β_{3,1})=E₁(x₃·γ₁−β_{3,1}) by using Paillier, and sends D_{3,1} to P₁. Similarly, P₃ randomly selects a first mask β_{3,2} between participants for P₂, calculates a first intermediate ciphertext D_{3,2}=x₃⊙R₂⊕E₂(−β_{3,2})=E₂(x₃·γ₂−β_{3,2}), and sends D_{3,2} to P₂. Similarly, P₃ randomly selects a first mask β_{3,4} between participants for P₄, calculates a first intermediate ciphertext D_{3,4}=x₃⊙R₄⊕E₄(−β_{4,3})=E₄(x₃·γ₄−β_{3,4}), and sends D_{3,4} to P₄. Similarly, P₃ randomly selects a first mask β_{3,5} between participants for P₅, calculates a first intermediate ciphertext D_{3,5}=x₃⊙R₅⊕E₅(−β_{3,5})=E₅(x₃·γ₅−β_{3,5}), and sends D_{3,5} to P₅.

P₄ randomly selects a first mask β_{4,1} between participants for P₁, encrypts and calculates a first intermediate ciphertext D_{4,1}=x₄⊙R₁⊕E₁(−β_{4,1})=E₁(x₄·R₁)⊕E₁(−β_{4,1})=E₁(x₄·γ₁−β_{4,1}) by using Paillier, and sends D_{4,1} to P₁. Similarly, P₄ randomly selects a first mask β_{4,2} between participants for P₂, calculates a first intermediate ciphertext D_{4,2}=x₄⊙R₂⊕E₂(−β_{4,2})=E₂(x₄·γ₂−β_{4,2}), and sends D_{4,2} to P₂. Similarly, P₄ randomly selects a first mask β43 between participants for P₃, calculates a first intermediate ciphertext D_{4,3}=x₄⊙R₃⊕E₃(−β_{4,3})=E₃(x₄·γ₃−β_{4,3}), and sends D_{4,3} to P₃. Similarly, P₄ randomly selects a first mask β_{4,5} between participants for P₅, calculates a first intermediate ciphertext D_{4,5}=x₄⊙R₅⊕E₅(−β_{4,5})=E₅(x₄·γ₅−β_{4,5}), and sends D_{4,5} to P₅.

P₅ randomly selects a first mask β_{5,1} between participants for P₁, encrypts and calculates a first intermediate ciphertext D_{5,1}=x₅⊙R₁⊕E₁(−β_{5,1})=E₁(x₅·R₁)⊕E₁(−β_{5,1})=E₁(x₅·γ₁−β_{5,1}) by using Paillier, and sends D_{5,1} to P₁. Similarly, P₅ randomly selects a first mask β_{5,2} between participants for P₂, calculates a first intermediate ciphertext D_{5,2}=x₅⊙R₂⊕E₂(−β_{5,2})=E₂(x₅·γ₂−β_{5,2}), and sends D_{5,2} to P₂. Similarly, P₅ randomly selects a first mask β_{5,3} between participants for P₃, calculates a first intermediate ciphertext D_{5,3}=x₅⊙R₃⊕E₃(−β_{5,3})=E₃(x₅·γ₃−β_{5,3}), and sends D_{5,3} to P₃. Similarly, P₅ randomly selects a first mask β_{5,4} between participants for P₄, calculates a first intermediate ciphertext D_{5,4}=x₅⊙R₄⊕E₄(−β_{5,4})=E₄(x₅·γ₃−β_{5,4}), and sends D_{5,4} to P₄.

As such, P₁ can receive D_{2,1}, D_{3,1}, D_{4,1}, and D_{5,1}. Therefore, P₁ can obtain x₂·γ₁−β_{2,1}=α_{1,2}, x₃·γ₁-s_{3,1}=α_{1,3}, x₄·γ₁−β_{4,1}=α_{1,4}, and x₅·γ₁−β_{5,1}=α_{1,5} through decryption. Further, P₁ can calculate an intermediate value

$${δ}_{1} = {γ}_{1} \cdot ( 1 + {x}_{1} ) + {\sum }_{j = 1 , j \neq 1}^{5} ( {α}_{1 , j} + {β}_{1 , j} ) = {γ}_{1} \cdot ( 1 + {x}_{1} ) + ( {x}_{2} \cdot {γ}_{1} - {β}_{2 , 1} + {x}_{3} \cdot {γ}_{1} - {β}_{3 , 1} + {x}_{4} \cdot {γ}_{1} - {β}_{4 , 1} + {x}_{5} \cdot {γ}_{1} - {β}_{5 , 1} + {β}_{1 , 2} + {β}_{1 , 3} + {β}_{1 , 4} + {β}_{1 , 5} ) ,$$

and broadcast δ₁.

Similarly, P₂ can receive D_{1,2}, D_{3,2}, D_{4,2}, and D_{5,2}. Therefore, P₂ can obtain x₁·γ₂−β_{1,2}=α_{2,1}, x₃·γ₂−β_{3,2}=α_{2,3}, x₄·γ₂−β_{4,2}=α_{2,4}, and x₅·γ₂−β_{5,2}=α_{2,5} through decryption. Further, P₂ can calculate an intermediate value

$${δ}_{2} = {γ}_{2} \cdot ( 1 + {x}_{2} ) + {\sum }_{j = 1 , j \neq 2}^{5} ( {α}_{2 , j} + {β}_{2 , j} ) = {γ}_{2} \cdot ( 1 + {x}_{2} ) + ( {x}_{1} \cdot {γ}_{2} - {β}_{1 , 2} + {x}_{3} \cdot {γ}_{2} - {β}_{3 , 2} + {x}_{4} \cdot {γ}_{2} - {β}_{4 , 2} + {x}_{5} \cdot {γ}_{2} - {β}_{5 , 2} + {β}_{2 , 1} + {β}_{2 , 3} + {β}_{2 , 4} + {β}_{2 , 5} ) ,$$

and broadcast δ₂.

Similarly, P₃ can receive D_{1,3}, D_{2,3}, D_{4,3}, and D_{5,3}. Therefore, P₃ can obtain x₁·γ₃−β_{1,3}=α_{3,1}, x₂·γ₃−β_{2,3}=α_{3,2}, x₄·γ₃−β_{4,3}=α_{3,4}, and x₅·γ₃−β_{5,3}=α_{3,5} through decryption. Further, P₃ can calculate an intermediate value

$${δ}_{3} = {γ}_{3} \cdot ( 1 + {x}_{3} ) + {\sum }_{j = 1 , j \neq 3}^{5} ( {α}_{3 , j} + {β}_{3 , j} ) = {γ}_{3} \cdot ( 1 + {x}_{3} ) + ( {x}_{1} \cdot {γ}_{3} - {β}_{1 , 3} + {x}_{2} \cdot {γ}_{3} - {β}_{2 , 3} + {x}_{4} \cdot {γ}_{3} - {β}_{4 , 3} + {x}_{5} \cdot {γ}_{3} - {β}_{5 , 3} + {β}_{3 , 1} + {β}_{3 , 2} + {β}_{3 , 4} + {β}_{3 , 5} ) ,$$

and broadcast δ₃.

Similarly, P₄ can receive D_{1,4}, D_{2,4}, D_{3,4}, and D_{5,4}. Therefore, P₄ can obtain x₁·γ₄−β_{1,4}=α_{4,1}, x₂·γ₄−β_{2,4}=α_{4,2}, x₃·γ₄−β_{3,4}=α_{4,3}, and x₅·γ₄−β_{5,4}=α_{4,5} through decryption. Further, P₄ can calculate an intermediate value

$${δ}_{4} = {γ}_{4} \cdot ( 1 + {x}_{4} ) + {\sum }_{j = 1 , j \neq 4}^{5} ( {α}_{4 , j} + {β}_{4 , j} ) = {γ}_{4} \cdot ( 1 + {x}_{4} ) + ( {x}_{1} \cdot {γ}_{4} - {β}_{1 , 4} + {x}_{2} \cdot {γ}_{4} - {β}_{2 , 4} + {x}_{3} \cdot {γ}_{4} - {β}_{3 , 4} + {x}_{5} \cdot {γ}_{4} - {β}_{5 , 4} + {β}_{4 , 1} + {β}_{4 , 2} + {β}_{4 , 3} + {β}_{4 , 5} ) ,$$

and broadcast δ₄.

Similarly, P₅ can receive D_{1,5}, D_{2,5}, D_{3,5}, and D_{4,5}. Therefore, P₅ can obtain x₁·γ5−β_{1,5}=α_{5,1}, x₂·γ₅−β_{2,5=α5,2}, x₃·γ₅−β_{3,5}=α_{5,3}, and x₄·γ₅−β_{4,5}=α_{5,4} through decryption. Further, P₅ can calculate an intermediate value

$${δ}_{5} = {γ}_{5} \cdot ( 1 + {x}_{5} ) + {\sum }_{j = 1 , j \neq 5}^{5} ( {α}_{5 , j} + {β}_{5 , j} ) = {γ}_{5} \cdot ( 1 + {x}_{5} ) + ( {x}_{1} \cdot {γ}_{5} - {β}_{1 , 5} + {x}_{2} \cdot {γ}_{5} - {β}_{2 , 5} + {x}_{3} \cdot {γ}_{5} - {β}_{3 , 5} + {x}_{4} \cdot {γ}_{5} - {β}_{4 , 5} + {β}_{5 , 1} + {β}_{5 , 2} + {β}_{5 , 3} + {β}_{5 , 4} ) ,$$

and broadcast δ₅.

In a next step, after collecting δ_{j,j∈[1,5]}, the participant P₁ can calculate

$${\sum }_{j = 1}^{5} {δ}_{j} = {γ}_{1} \cdot ( 1 + {x}_{1} ) + ( {x}_{2} \cdot {γ}_{1} - {β}_{2 , 1} + {x}_{3} \cdot {γ}_{1} - {β}_{3 , 1} + {x}_{4} \cdot {γ}_{1} - {β}_{4 , 1} + {x}_{5} \cdot {γ}_{1} - {β}_{5 , 1} + {β}_{1 , 2} + {β}_{1 , 3} + {β}_{1 , 4} + {β}_{1 , 5} ) + {γ}_{2} \cdot ( 1 + {x}_{2} ) + ( {x}_{1} \cdot {γ}_{2} - {β}_{1 , 2} + {x}_{3} \cdot {γ}_{2} - {β}_{3 , 2} + {x}_{4} \cdot {γ}_{2} - {β}_{4 , 2} + {x}_{5} \cdot {γ}_{2} - {β}_{5 , 2} + {β}_{2 , 1} + {β}_{2 , 3} + {β}_{2 , 4} + {β}_{2 , 5} ) + {γ}_{3} \cdot ( 1 + {x}_{3} ) + ( {x}_{1} \cdot {γ}_{3} - {β}_{1 , 3} + {x}_{2} \cdot {γ}_{3} - {β}_{2 , 3} + {x}_{4} \cdot {γ}_{3} - {β}_{4 , 3} + {x}_{5} \cdot {γ}_{3} - {β}_{5 , 3} + {β}_{3 , 1} + {β}_{3 , 2} + {β}_{3 , 4} + {β}_{3 , 5} ) + {γ}_{4} \cdot ( 1 + {x}_{4} ) + ( {x}_{1} \cdot {γ}_{4} - {β}_{1 , 4} + {x}_{2} \cdot {γ}_{4} - {β}_{2 , 4} + {x}_{3} \cdot {γ}_{4} - {β}_{3 , 4} + {x}_{5} \cdot {γ}_{4} - {β}_{5 , 4} + {β}_{4 , 1} + {β}_{4 , 2} + {β}_{4 , 3} + {β}_{4 , 5} ) + {γ}_{5} \cdot ( 1 + {x}_{5} ) + ( {x}_{1} \cdot {γ}_{5} - {β}_{1 , 5} + {x}_{2} \cdot {γ}_{5} - {β}_{2 , 5} + {x}_{3} \cdot {γ}_{5} - {β}_{3 , 5} + {x}_{4} \cdot {γ}_{5} - {β}_{4 , 5} + {β}_{5 , 1} + {β}_{5 , 2} + {β}_{5 , 3} + {β}_{5 , 4} ) = {γ}_{1} \cdot ( 1 + {x}_{1} ) + ( {x}_{2} \cdot {γ}_{1} + {x}_{3} \cdot {γ}_{1} + {x}_{4} \cdot {γ}_{1} + {x}_{5} \cdot {γ}_{1} ) + {γ}_{2} \cdot ( 1 + {x}_{2} ) + ( {x}_{1} \cdot {γ}_{2} + {x}_{3} \cdot {γ}_{2} + {x}_{4} \cdot {γ}_{2} + {x}_{5} \cdot {γ}_{2} ) + {γ}_{3} \cdot ( 1 + {x}_{3} ) + ( {x}_{1} \cdot {γ}_{3} + {x}_{2} \cdot {γ}_{3} + {x}_{4} \cdot {γ}_{3} + {x}_{5} \cdot {γ}_{3} ) + {γ}_{4} \cdot ( 1 + {x}_{4} ) + ( {x}_{1} \cdot {γ}_{4} + {x}_{2} \cdot {γ}_{4} + {x}_{3} \cdot {γ}_{4} + {x}_{5} \cdot {γ}_{4} ) + {γ}_{5} \cdot ( 1 + {x}_{5} ) + ( {x}_{1} \cdot {γ}_{5} + {x}_{2} \cdot {γ}_{5} + {x}_{3} \cdot {γ}_{5} + {x}_{4} \cdot {γ}_{5} ) = {γ}_{1} \cdot ( 1 + {x}_{1} + {x}_{2} + {x}_{3} + {x}_{4} + {x}_{5} ) + {γ}_{2} \cdot ( 1 + {x}_{1} + {x}_{2} + {x}_{3} + {x}_{4} + {x}_{5} ) + {γ}_{3} \cdot ( 1 + {x}_{1} + {x}_{2} + {x}_{3} + {x}_{4} + {x}_{5} ) + {γ}_{4} \cdot ( 1 + {x}_{1} + {x}_{2} + {x}_{3} + {x}_{4} + {x}_{5} ) + {γ}_{5} \cdot ( 1 + {x}_{1} + {x}_{2} + {x}_{3} + {x}_{4} + {x}_{5} ) = ( {γ}_{1} + {γ}_{2} + {γ}_{3} + {γ}_{4} + {γ}_{5} ) \cdot ( 1 + {x}_{1} + {x}_{2} + {x}_{3} + {x}_{4} + {x}_{5} ) = γ \cdot ( 1 + x ) .$$

Similarly, after collecting δ_{j,j∈[1,5]}, P₂ can calculate

$${\sum }_{j = 1}^{5} {δ}_{j} = γ \cdot ( 1 + x ) .$$

Similarly, after collecting δ_{j,j∈[1,5]}, P₃ can calculate

$${\sum }_{j = 1}^{5} {δ}_{j} = γ \cdot ( 1 + x ) .$$

Similarly, after collecting δ_{j,j∈[1,5]}, P₄ can calculate

$${\sum }_{j = 1}^{5} {δ}_{j} = γ \cdot ( 1 + x ) .$$

Similarly, after collecting δ_{j,j∈[1,5]}, P₅ can calculate

$${\sum }_{j = 1}^{5} {δ}_{j} = γ \cdot ( 1 + x ) .$$

Further, the participant P₁ can use

$${x}_{1}^{′} = \frac{{ω}_{1}}{γ ( 1 + x )}$$

as a private key share (namely, a private key shard) of the participant.

Similarly, the participant P₂ can use

$${x}_{2}^{′} = \frac{{ω}_{2}}{γ ( 1 + x )}$$

as a private key share of the participant.

Similarly, the participant P₃ can use

$${x}_{3}^{′} = \frac{{ω}_{3}}{γ ( 1 + x )}$$

as a private key share of the participant.

Similarly, the participant P₄ can use

$${x}_{4}^{′} = \frac{{ω}_{4}}{γ ( 1 + x )} 1$$

as a private key share of the participant.

Similarly, the participant P₅ can use

$${x}_{5}^{′} = \frac{{ω}_{5}}{γ ( 1 + x )}$$

as a private key share of the participant.

As such, each participant Pᵢ finally obtains the sum of first random values xᵢ and the sum of second random values γᵢ that are respectively generated by all the participants. However, because a process of exchanging information between participants is combined with a design of homomorphic encryption, an intermediate ciphertext, and an intermediate value, the first random values xᵢ and the second random values γᵢ of any participant Pᵢ are not exposed. Further, with reference to the sum of secret shares obtained based on the distributed key generation protocol, each participant Pᵢ can obtain a private key share

$${x}_{i}^{′}$$

of the participant.

The following describes a distributed signature process. The process can include two parts: an offline phase and an online phase. In the above-mentioned distributed key generation process, n participants need to jointly participate in a protocol process. In the following distributed threshold signature process, only at least t+1 participants need to participate in a protocol process. In a specific case, a threshold t=2 is still used as an example here.

In the offline phase, a respective private key share

$${x}_{i}^{′}$$

is updated, a respective third random value kᵢ and a corresponding third random value homomorphic ciphertext Kᵢ and third random value public key Gᵢ are generated, Kᵢ and Gᵢ are broadcast, a second mask is generated, and a second intermediate plaintext is exchanged through homomorphic encryption. Details can specifically include:

S21: First, each participant Pᵢ in t+1 participants calculates a Lagrange coefficient

$${l}_{i} ( 0 ) = {\prod }_{1 \leq m \leq t + 1 , m \neq i} \frac{{P}_{m}}{{P}_{m} - {P}_{i}} ,$$

and updates a private key share

$${x}_{i}^{″} ← {l}_{i} ( 0 ) \cdot {x}_{i}^{′}$$

of the participant by using the Lagrange coefficient. Here, for example, if i is 1, 2, or 3: a participant P₁ calculates a Lagrange coefficient

$${l}_{1} ( 0 ) = {\prod }_{1 \leq m \leq t + 1 , m \neq 1} \frac{{P}_{m}}{{P}_{m} - {P}_{i}} = {\prod }_{1 \leq m \leq 3 , m \neq 1} \frac{m}{m - 1} = \frac{2}{2 - 1} \cdot \frac{3}{3 - 1} = 3 ,$$

and updates a private key share

$${x}_{1}^{″} ← {l}_{1} ( 0 ) \cdot {x}_{1}^{′}$$

of the participant, a participant P₂ calculates a Lagrange coefficient

$${l}_{2} ( 0 ) = {\prod }_{1 \leq m \leq t + 1 , m \neq 2} \frac{{P}_{m}}{{P}_{m} - {P}_{i}} = {\prod }_{1 \leq m \leq 3 , m \neq 2} \frac{m}{m - 2} = \frac{1}{1 - 2} \cdot \frac{3}{3 - 2} = - 3 ,$$

and updates a private key share

$${x}_{2}^{″} ← {l}_{2} ( 0 ) \cdot {x}_{2}^{′}$$

of the participant, and a participant P₃ calculates a Lagrange coefficient

$${l}_{3} ( 0 ) = {\prod }_{1 \leq m \leq t + 1 , m \neq 3} \frac{{P}_{m}}{{P}_{m} - {P}_{i}} = {\prod }_{1 \leq m \leq 3 , m \neq 3} \frac{m}{m - 3} = \frac{1}{1 - 3} \cdot \frac{2}{2 - 3} = 1 ,$$

and updates a private key share

$${x}_{3}^{″} ← {l}_{3} ( 0 ) \cdot {x}_{3}^{′}$$

of the participant.

Next, each of the t+1 participants generates a third random value kᵢ and a corresponding third random value homomorphic ciphertext Kᵢ and third random value public key Gᵢ, and broadcasts the third random value homomorphic ciphertext Kᵢ and the third random value public key Gᵢ. Specifically, for example, the participant Pᵢ, i∈[1, t+1] generates the third random value kᵢ, and kᵢ∈ [symbol] . The participant Pᵢ can calculate the third random value homomorphic ciphertext, for example, a Paillier ciphertext Kᵢ=Eᵢ(kᵢ), and calculate the third random value public key Gᵢ, for example, Gᵢ=g^{k}^{ᵢ}. Specifically, when t+1 is 3, the participants are P₁, P₂, and P₃: P₁ generates a third random value k₁, calculates a Paillier ciphertext K₁=E₁(k₁) of the third random value, calculates a third random value public key G₁=g^{k}^{₁}, and broadcast K₁ and G₁; P₂ generates a third random value k₂, calculates a Paillier ciphertext K₂=E₂(k₂) of the third random value, calculates a third random value public key G₂=g^{k}^{₂}, and broadcast K₂ and G₂; and P₃ generates a third random value k₃, calculates a Paillier ciphertext K₃=E₃(k₃) of the third random value, calculates a third random value public key G₃=g^{k}^{₃}, and broadcast K₃ and G₃.

In addition, each participant Pᵢ further generates a second mask, and exchanges a second intermediate plaintext through homomorphic encryption. The method can specifically include: Pᵢ generates a second mask \hat{B}_{i,j} for the participant Pⱼ, calculates a second intermediate ciphertext \hat{D}_{i,j} based on an updated private key share

$${x}_{i}^{″} ,$$

a received third random value homomorphic ciphertext Kᵢ, and a homomorphic ciphertext of the second mask \hat{B}_{i,j}, exchanges the second intermediate ciphertext \hat{D}_{i,j} with another participant Pᵢ, and decrypts the second intermediate ciphertext \hat{D}_{j,i} to obtain the second intermediate plaintext \hat{α}_{i,j}. Specifically, S22 and S23 can be performed.

S22: For Kᵢ sent by Pⱼ, the participant Pᵢ that receives broadcast selects one second mask \hat{B}_{i,j}∈ [symbol] . Here, [symbol] indicates that a value range of a subscript in the limited field is q to the power of 5. This is a proven value range with cryptographic security. The second mask \hat{B}_{i,j} can be a large value selected in the range [symbol] . Further, Pᵢ can calculate a second intermediate ciphertext \hat{D}_{i,j} based on a homomorphic algorithm, and send the second intermediate ciphertext to Pⱼ:

$${\hat{D}}_{i , j} = {x}_{i}^{″} ⊙ {K}_{j} ⊕ {E}_{j} ( - {\hat{β}}_{i , j} ) = {E}_{j} ( {x}_{i}^{″} \cdot {k}_{j} - {\hat{β}}_{i , j} ) = {E}_{j} ( {\hat{α}}_{j , i} )$$

Details are as follows:

After receiving K₂=E₂(k₂) the broadcast by P₂, P₁ selects one second mask \hat{β}_{1,2}∈ [symbol] . Further, P₁ can calculate a second intermediate ciphertext \hat{D}_{1,2} based on the homomorphic algorithm, and send the second intermediate ciphertexts to P₂.

$${\hat{D}}_{1 , 2} = {x}_{1}^{″} ⊙ {K}_{2} ⊕ {E}_{2} ( - {\hat{β}}_{1 , 2} ) = {E}_{2} ( {x}_{1}^{″} \cdot {k}_{2} - {\hat{β}}_{1 , 2} ) = {E}_{2} ( {\hat{α}}_{2 , 1} )$$

As such, P₂ receives \hat{D}_{1,2}=E₂(\hat{α}_{1,2}). Although P₂ has a corresponding Paillier private key e₂, and k₂ is also generated by P₂, due to a mask function of the second mask \hat{β}_{1,2} selected by P₁, P₂ cannot infer a private key share

$${x}_{1}^{″}$$

of P₁, thereby completing information transmission on this basis. The following is similar, and details are omitted.

Similarly, after receiving K₃=E₃(k₃) the broadcast by P₃, P₁ selects one second mask \hat{β}_{1,3}∈ [symbol] . Further, P₁ can calculate a second intermediate ciphertext \hat{D}_{1,3} based on the homomorphic algorithm, and send the second intermediate ciphertexts to P₃.

$${\hat{D}}_{1 , 3} = {x}_{1}^{″} ⊙ {K}_{3} ⊕ {E}_{3} ( - {\hat{β}}_{1 , 3} ) = {E}_{3} ( {x}_{1}^{″} \cdot {k}_{3} - {\hat{β}}_{1 , 3} ) = {E}_{3} ( {\hat{α}}_{3 , 1} )$$

Similarly, after receiving K₁=E₁(k₁) the broadcast by P₁, P₂ selects one second mask \hat{β}_{2,1}∈ [symbol] . Further, P₂ can calculate a second intermediate ciphertext \hat{D}_{2,1} based on the homomorphic algorithm, and send the second intermediate ciphertexts to P₁.

$${\hat{D}}_{2 , 1} = {x}_{2}^{″} ⊙ {K}_{1} ⊕ {E}_{1} ( - {\hat{β}}_{2 , 1} ) = {E}_{1} ( {x}_{2}^{″} \cdot {k}_{1} - {\hat{β}}_{2 , 1} ) = {E}_{1} ( {\hat{α}}_{1 , 2} )$$

Similarly, after receiving K₃=E₃(k₃) the broadcast by P₃, P₂ selects one second mask \hat{β}_{2,3}∈ [symbol] . Further, P₂ can calculate a second intermediate ciphertext \hat{D}_{2,3} based on the homomorphic algorithm, and send the second intermediate ciphertexts to P₃.

$${\hat{D}}_{2 , 3} = {x}_{2}^{″} ⊙ {K}_{3} ⊕ {E}_{3} ( - {\hat{β}}_{2 , 3} ) = {E}_{3} ( {x}_{2}^{″} \cdot {k}_{3} - {\hat{β}}_{2 , 3} ) = {E}_{3} ( {\hat{α}}_{3 , 2} )$$

Similarly, after receiving K₁=E₁(k₁) the broadcast by P₁, P₃ selects one second mask \hat{β}_{3,1}∈ [symbol] . Further, P₃ can calculate a second intermediate ciphertext \hat{D}_{3,1} based on the homomorphic encryption algorithm, and send the second intermediate ciphertexts to P₁.

$${\hat{D}}_{3 , 1} = {x}_{3}^{″} ⊙ {K}_{1} ⊕ {E}_{1} ( - {\hat{β}}_{3 , 1} ) = {E}_{1} ( {x}_{3}^{″} \cdot {k}_{1} - {\hat{β}}_{3 , 1} ) = {E}_{1} ( {\hat{α}}_{1 , 3} )$$

Similarly, after receiving K₂=E₂(k₂) the broadcast by P₂, P₃ selects one second mask \hat{β}_{3,2}∈ [symbol] . Further, P₃ can calculate a second intermediate ciphertext \hat{D}_{3,2} based on the homomorphic encryption algorithm, and send the second intermediate ciphertexts to P₂.

$${\hat{D}}_{3 , 2} = {x}_{3}^{″} ⊙ {K}_{2} ⊕ {E}_{2} ( - {\hat{β}}_{3 , 2} ) = {E}_{2} ( {x}_{3}^{″} \cdot {k}_{2} - {\hat{β}}_{3 , 2} ) = {E}_{2} ( {\hat{α}}_{2 , 3} )$$

S23: Further, each participant Pᵢ decrypts the received second intermediate ciphertext \hat{D}_{j,i} by using a corresponding homomorphic encryption private key, to obtain a plaintext \hat{α}_{i,j}, referred to as a second intermediate plaintext here, where

$${\hat{α}}_{i , j} = {x}_{j}^{″} \cdot {k}_{i} - {\hat{β}}_{j , i} .$$

So far, Pᵢ locally has kᵢ, a respective updated private key:

$${x}_{i}^{″} ,$$

and (\hat{α}_{i,j}, \hat{β}_{i,j}, g^{k}^{ⱼ}=Gⱼ, j∈[1, t+1]) for Pⱼ.

In the online phase, each participant Pᵢ in the at least t+1 participants calculates total coordinates K of a third random value public key by using a collected third random value public key Gᵢ, calculates r of a signature share for a message m by using the total coordinates K, and further calculates a component sᵢ of the signature share for the message m based on r, a respective third random value kᵢ, a respective updated private key share

$${x}_{i}^{″} ,$$

and a second intermediate plaintext \hat{α}_{i,j} and a second mask \hat{B}_{i,j} for the participant Pⱼ, to obtain the signature share σᵢ(r, sᵢ).

S31: Each participant Pᵢ in the at least t+1 participants can collect the third random value public key G_{j,j∈[1,t+1]}, to calculate the total coordinates

$$K = {\prod }_{j = 1}^{t + 1} {G}_{j} = {g}^{{\sum }_{j = 1}^{t + 1} {k}_{j}} = ( {x}_{1} , {y}_{1} )$$

based on at least t+1 third random value public keys. x₁ and y₁ are respectively a horizontal coordinate and a vertical coordinate of K points on an elliptic curve.

In addition, Pᵢ can obtains a digest value H(m) by performing hash calculation on the to-be-signed message m, and calculate r=H(m)+x₁ mod q in the signature share based on the total coordinates K. This is similar to Equation (a).

The any participant Pᵢ is specific to the same message m. That is, H(m) also remains the same. In addition, the sum of t+1 parameters kⱼ also remains the same, and the total coordinates K also remain the same. Therefore, r in the signature share calculated by the any participant Pᵢ also remains the same.

S32: Pᵢ can calculate a component sᵢ of the signature share for the message m based on r, a respective third random value kᵢ, a respective updated private key share

$${x}_{i}^{″} ,$$

and a second intermediate plaintext \hat{α}_{i,j} and a second mask \hat{B}_{i,j} for the participant Pⱼ, to obtain the signature share σᵢ(r, sᵢ).

Specifically, sᵢ is calculated based on the following equation:

$${s}_{i} = {k}_{i} \cdot {x}_{i}^{″} + {\sum }_{j = 1 , j \neq i}^{t + 1} ( {\hat{α}}_{i , j} + {\hat{β}}_{j , i} ) + r \cdot {x}_{i}^{″} = {l}_{i} ( 0 ) \cdot {k}_{i} \cdot {x}_{i}^{′} + {\sum }_{j = 1 , j \neq i}^{t + 1} ( {\hat{α}}_{i , j} + {\hat{β}}_{i , j} ) + {l}_{i} ( 0 ) \cdot r \cdot {x}_{i}^{′}$$

Here,

$${l}_{i} ( 0 ) = {\prod }_{1 \leq m \leq t + 1 , m \neq i} \frac{{p}_{m}}{{P}_{m} - {P}_{i}} .$$

For short

$${l}_{i} ( 0 ) = {\prod }_{1 \leq m \leq t + 1 , m \neq i} \frac{m}{m - i} . {x}_{i}^{″}$$

is the updated private key share, that is, is equal to

$${l}_{i} ( 0 ) \cdot {x}_{i}^{′} .$$

As such, after obtaining at least t+1 signature shares, any party can aggregate the at least t+1 signature shares into a total signature

$$σ = ( r , {\sum }_{i = 1}^{t + 1} {s}_{i} - r ) .$$

It can be proved that

$$s = {\sum }_{i = 1}^{t + 1} {s}_{i} - r = \frac{k + r}{1 + x} - r = \frac{k - r \cdot x}{1 + x} ,$$

that is, (1+x)⁻¹·(k−r·x). It can be seen that s in the total signature σ is in a same form as s in Equation (b) in the above-mentioned basic SM2 signature algorithm. Therefore, correctness of the total signature σ can be verified by using the total public key X.

In addition, the total private key is the sum of updated private key shares:

$$\begin{matrix}{x}_{1}^{″} + {x}_{2}^{″} + {x}_{3}^{″} = {l}_{1} ( 0 ) \cdot {x}_{1}^{′} + {l}_{2} ( 0 ) \cdot {x}_{2}^{′} + {l}_{3} ( 0 ) \cdot {x}_{3}^{′} \\ = \begin{matrix}{l}_{1} ( 0 ) \cdot \frac{{ω}_{1}}{γ ( 1 + x )} + {l}_{2} ( 0 ) \cdot \frac{{ω}_{2}}{γ ( 1 + x )} + \\ {l}_{3} ( 0 ) \cdot \frac{{ω}_{3}}{γ ( 1 + x )} = \frac{γ}{γ ( 1 + x )} = \frac{1}{1 + x}\end{matrix}\end{matrix}$$

The above-mentioned example continues. Any party (which can be any of n=5 participants, or can be a participant other than n=5 participants) obtains t+1=3 signature shares:

For example, P₁ calculates the following based on

$$\begin{matrix}{s}_{1} = {l}_{1} ( 0 ) \cdot {k}_{1} \cdot {x}_{1}^{′} + ( {\hat{α}}_{1 , 2} + {\hat{β}}_{2 , 1} + {\hat{α}}_{1 , 3} + {\hat{β}}_{3 , 1} ) + {l}_{1} ( 0 ) \cdot r \cdot {x}_{1}^{′} \\ = {l}_{1} ( 0 ) \cdot {k}_{1} \cdot {x}_{1}^{′} + ( {l}_{2} ( 0 ) \cdot {k}_{1} \cdot {x}_{2}^{′} + {l}_{3} ( 0 ) \cdot {k}_{1} \cdot {x}_{3}^{′} ) + {l}_{1} ( 0 ) \cdot r \cdot {x}_{1}^{′} \\ = {k}_{1} \cdot ( {l}_{1} ( 0 ) \cdot {x}_{1}^{′} + {l}_{2} ( 0 ) \cdot {x}_{2}^{′} + {l}_{3} ( 0 ) \cdot {x}_{3}^{′} ) + {l}_{1} ( 0 ) \cdot {rx}_{1}^{′}\end{matrix}$$

Similarly, P₂ calculates the following based on

$${\hat{α}}_{i , j} = {x}_{j}^{″} \cdot {k}_{i} - {\hat{β}}_{j , i} :$$

$${s}_{2} = {k}_{2} \cdot ( {l}_{2} ( 0 ) \cdot {x}_{2}^{′} + {l}_{1} ( 0 ) \cdot {x}_{1}^{′} + {l}_{3} ( 0 ) \cdot {x}_{3}^{′} ) + {l}_{2} ( 0 ) \cdot {rx}_{2}^{′}$$

Similarly, P₃ calculates the following based on

$${\hat{α}}_{i , j} = {x}_{j}^{″} \cdot {k}_{i} - {\hat{β}}_{j , i} :$$

$${s}_{3} = {k}_{3} \cdot ( {l}_{3} ( 0 ) \cdot {x}_{3}^{′} + {l}_{1} ( 0 ) \cdot {x}_{1}^{′} + {l}_{2} ( 0 ) \cdot {x}_{2}^{′} ) + {l}_{3} ( 0 ) \cdot {rx}_{3}^{′}$$

Therefore:

$$\begin{matrix}{s}_{1} + {s}_{2} + {s}_{3} = \frac{{k}_{1}}{1 + x} + {l}_{1} ( 0 ) \cdot {rx}_{1}^{′} + \frac{{k}_{2}}{1 + x} + {l}_{2} ( 0 ) \cdot {rx}_{2}^{′} + \frac{{k}_{3}}{1 + x} + {l}_{3} ( 0 ) \cdot {rx}_{3}^{′} \\ = \frac{{k}_{1} + {k}_{2} + {k}_{3}}{1 + x} + r \cdot ( {l}_{1} ( 0 ) \cdot {x}_{1}^{′} + {l}_{2} ( 0 ) \cdot {x}_{2}^{′} + {l}_{3} ( 0 ) \cdot {x}_{3}^{′} ) = \frac{k + r}{1 + x}\end{matrix}$$

It should be noted that the above-mentioned examples are mainly described by using a case in which there are exactly t+1 participants. Actually, there can be more than t+1 participants. That is, when there are more than t+1 participants in a distributed signature protocol phase, after the above-mentioned process, an aggregated signature the same as that in a case of t+1 participants can be obtained, so that the aggregated signature can still be verified by the total public key.

Similar to the ECC-based cryptography solution, two times of encryption cannot be performed by using the same parameter k. Otherwise, k can be obtained by another person. Therefore, a new parameter k is preferably used in each signature process. The at least t+1 participants can perform the offline phase again, to generate at least t+1 parameters kj, thereby obtaining a new parameter k.

The above-mentioned process can be that the distributed key generation phase is jointly executed by the n participants one time, and then the at least t+1 participants execute the offline phase and the online phase in each time of signature. Alternatively, after the n participants jointly execute the distributed key generation phase one time, the at least t+1 participants execute the offline phase a plurality of times, thereby generating a plurality of different k values. As such, different R values and a corresponding value of r are generated, to be used for signing in each subsequent online phase.

In this application, an additive homomorphic algorithm solution such as Paillier is used to replace a multi-party MPC multiplication protocol used in a document “SM2 Elliptic Curve Threshold Cryptography”, to overcome a limitation condition n≥2t+1, thereby achieving a distributed threshold signature algorithm of any threshold.

Second, in an entire distributed threshold key generation process, no participant can determine a complete total private key, and only determines a respective threshold private key shard xᵢ″, and only t+1 participants in the n persons can sign. In a distributed threshold signature process, not all of the n persons need to participate, and a distributed signature can be implemented provided that at least t+1 of the n persons participate, thereby improving a system fault tolerance rate.

In addition, this implementation of this application supports an offline-online mode. Only one round of interaction is needed between participants in the online phase, which greatly simplifies signature complexity.

In the distributed threshold signature, the key shard (namely, the key share) usually needs to be updated to ensure security. The following lists some cases in which the key shard may need to be updated:

In a case of a member change, in the distributed threshold signature, leaving or joining of a member may cause a change in the key shard. When a new member joins, the existing key shard needs to be recalculated and allocated, to ensure that the new member can participate in a signature operation. Similarly, when members leave, key shards of the members need to be removed.

In a case of a threshold change, to change a threshold, the key shard needs to be recalculated and allocated. Because a quantity of key shards is closely related to the threshold, modifying the threshold causes a change in the key shard.

If the key share in the distributed threshold signature solution is updated, it is better to keep a corresponding total private key and a corresponding total public key unchanged after the member change and/or the threshold change. As such, because the total public key is unchanged, the total signature obtained by aggregating signature shares implemented by the at least t+1 participants based on the distributed threshold signature solution can still be verified by the same total public key. In contrast, if a corresponding total public key changes after the key share in the distributed threshold signature solution is updated, the new total public key needs to be distributed. That is, keeping the total public key unchanged can avoid distributing a new total public key, especially when any party other than the participant needs to verify the total signature based on the total public key.

Assume that a first participant set [symbol] before a change includes n participants {P₁, . . . , Pₙ}, and a second participant set [symbol] obtained after the change includes n′ participants {P₁, . . . , Pₙ′}. It is possible that n′>n, that is, a new participant joins; or it is possible that n′<n, that is, a participant exits. A threshold changes from t to t′ through the change. Based on the above-mentioned solutions, the following describes one or more implementations of a key share updating method in a distributed threshold signature solution of this application, including:

S310: Each of at least t+1 participants in a third set [symbol] obtained by intersecting the first participant set [symbol] existing before the change and the second participant set [symbol] obtained after the change generates a new t′-degree random polynomial by using an original private key share component as a secret value.

Assume that S is a subset of participant indices, and satisfies |S|=t+1. The third set [symbol] can be obtained by intersecting the first participant set [symbol] existing before the change and the second participant set [symbol] obtained after the change. In this case, [symbol] satisfies [symbol] ={Pᵢ}_{i∈S}⊆ [symbol] ∩ [symbol] . That is, the participant in the set [symbol] is both a member of the old set [symbol] and a member of the new set [symbol] , which also indicates that the second participant set [symbol] obtained after the change includes at least t+1 members in the first participant set [symbol] existing before the change.

Each of the at least t+1 participants Pᵢ in the third set [symbol] has an original private key share component xᵢ. Specifically, as described above, each participant Pᵢ calculates a Lagrange coefficient

$${λ}_{i} = {\prod }_{j ∈ [ 1 , t + 1 ] , j \neq i} \frac{j}{j - i} ,$$

and calculates the private key share component xᵢ=λᵢsᵢ. Here, sᵢ is a private key share obtained by n participants in the first participant set [symbol] existing before the change by using an original distributed threshold key generation process. For a specific calculation process, references are made to the above-mentioned descriptions.

Further, each of the at least t+1 participants in the third set [symbol] can generate the new t′-degree random polynomial by using the original private key share component as a secret value. For example, the t+1 participants Pᵢ, i={1, 2, . . . , t+1} in [symbol] generate the new t′-degree random polynomial:

$${f}_{i}^{′} ( z ) = {a}_{i , {t}^{′}}^{′} {z}^{{t}^{′}} + … + {a}_{i , 1}^{′} z + {x}_{i}$$

It can be seen that xᵢ is used as a secret value in the new t′-degree random polynomial.

In fact, there is a new total polynomial:

$${f}^{′} ( z ) = {\sum }_{i = 1}^{t} {a}_{i , {t}^{′}}^{′} \cdot {z}^{{t}^{′}} + … + {\sum }_{i = 1}^{t} {a}_{i , 1}^{′} \cdot z + {\sum }_{i = 1}^{t} {x}_{i}$$

Here

$${a}_{i 1}^{′} , … , {a}_{i t}^{′}$$

that represent coefficients in the t′-degree polynomial generated by Pᵢ are different from coefficients aᵢ₁, . . . , aᵢₜ used in a process of previously generating a new private key share sᵢ based on the distributed key generation protocol.

S320: Each of the at least t+1 participants in the third set [symbol] generates n′ new secret shares based on the new t′-degree random polynomial generated by the participant, retains one secret share, and encrypts and sends the remaining secret share to another participant in the second set [symbol] .

For example, each of the at least t+1 participants in the third set [symbol] generates n′ new secret shares, denoted as

$${s}_{i j}^{′} = {{f}_{i}^{′} ( j )}_{j ∈ [ 1 , {n}^{′} ]} ,$$

based on the new t′-degree random polynomial generated by the participant.

Further, each of the at least t+1 participants in the third set [symbol] can retain one secret share, and encrypts and sends the remaining secret share to the other n′ participants in the second set [symbol] . For example, each participant Pᵢ in t+1 participants in the [symbol] retains

$${s}_{ii}^{′} ,$$

and sends

$${s}_{ij}^{′}$$

to Pⱼ (j∈[1, n′] and j≠i).

In addition, each participant Pᵢ can further generate a public verification parameter

$${A}_{i , l}^{′} = {a}_{i , l}^{′} G$$

corresponding to the polynomial of degree t′ of each participant, where I=0, 1, . . . , t′, and publish the public verification parameter to each participant.

Further, each participant Pᵢ can further verify, based on public verification parameters

$$\{ {A}_{j , 0}^{′} , {A}_{j , 1}^{′} , … , {A}_{j , {t}^{′}}^{′} \}$$

sent by Pⱼ, the secret share

$${f}_{j}^{′} ( i )$$

sent by Pⱼ, for example, based on the following equation:

$${f}_{j}^{′} ( i ) G = {A}_{j , 0}^{′} + i {A}_{j , 1}^{′} + {i}^{{t}^{′}} {A}_{j , {t}^{′}}^{′}$$

Any party can terminate a protocol if verification fails.

In another aspect, each participant Pᵢ can calculate the total public key X′. A calculation method is similar to the above-mentioned method. For example, the following formula is used here:

$${X}^{′} = {\sum }_{j = 1}^{{t}^{′}} {A}_{j , 0}^{′}$$

As described above, the total public key can be used to verify the total signature obtained by aggregating new signature shares generated subsequently by using updated secret shares.

S330: Each participant in the second participant set [symbol] generates a new private key share based on a local new secret share.

If the original private key share of each participant Pᵢ is sᵢ, the new private key share

$${s}_{i}^{′}$$

can be obtained in the following method:

$${s}_{i}^{′} = {\sum }_{j = 1}^{{n}^{′} + 1} {s}_{j i}^{′}$$

It can be proved that the new total private key is x′=Σ_{i∈t+1} xᵢ=f′(0)=f(0), that is, is the same as the original total private key. Clearly, the new total public key is also the same as the original total public key. Therefore, the original total public key can still be used to verify the total signature obtained by aggregating new signature shares generated subsequently by using updated secret shares.

In a specific example, a first participant set [symbol] existing before a change includes n=4 participants {P₁, . . . , P₄}, and a second participant set [symbol] obtained after the change includes n′=5 participants {P₁, . . . , P₅}. n′=5>n=4. That is, a new participant joins, for example, a new participant P₅ joins. Assume that a threshold existing before the change and a threshold obtained after the change are 2, that is, t=t′=2. The following steps are included.

S410: Each of at least 3 participants in a third set [symbol] obtained by intersecting the first participant set [symbol] existing before the change and the second participant set [symbol] obtained after the change generates a new t′=2-degree random polynomial by using an original private key share component as a secret value.

If the third set [symbol] can be obtained by intersecting the first participant set [symbol] existing before the change and the second participant set [symbol] obtained after the change, [symbol] satisfies [symbol] ={Pᵢ}_{i∈S}⊆ [symbol] ∩ [symbol] , that is, the participant in the set [symbol] is a member of the old set [symbol] and a member of the new set [symbol] , and [symbol] may be any one of the four sets {P₁, P₂, P₃}, {P₁, P₂, P₄}, {P₁, P₃, P₄}, {P₂, P₃, P₄}. The following provides descriptions by using an example in which [symbol] is {P₁, P₂, P₃}. The same is true to another case.

A process in which four participants in the first participant set [symbol] existing before the change generates a key share by based on a distributed threshold key generation protocol is described. As described above, a main related conclusion is as follows: P₁ sets a secret s₁₀, and a private key share is s₁=s₁₁+s₂₁+s₃₁+s₄₁; P₂ sets a secret s₂₀, and a private key share is s₂=s₁₂+s₂₂+s₃₂+s₄₂; P₃ sets a secret s₃₀, and a private key share is s₃=s₁₃+s₂₃+s₃₃+s₄₃; and P₄ sets a secret s₄₀, and a private key share is s₄=s₁₄+s₂₄+s₃₄+s₄₄.

Original private key share components generated by t+1=3 participants in an offline phase before the change are respectively, for example, x₁=λ₁s₁, x₂=λ₂s₂, and x₃=λ₃s₃. Here,

$${λ}_{1} = {\prod }_{j ∈ [ 1 , 3 ] , j \neq 1} \frac{j}{j - 1} = \frac{2}{2 - 1} \cdot \frac{3}{3 - 1} , {λ}_{2} = {\prod }_{j ∈ [ 1 , 3 ] , j \neq 2} \frac{j}{j - 2} = \frac{1}{1 - 2} \cdot \frac{3}{3 - 2} ,$$

and

$${λ}_{3} = {\prod }_{j ∈ [ 1 , 3 ] , j \neq 3} \frac{j}{j - 3} = \frac{1}{1 - 3} \cdot \frac{2}{2 - 3} .$$

In this case, an original total private key is x=Σ_{i∈[1,t+1]}xᵢ=s₁₀+s₂₀+s₃₀+s₄₀=f(0). For specific derivation, references can be made to the above-mentioned descriptions.

For P₁, P₂, and P₃ in the second participant set [symbol] obtained after the change: P₁ calculates a Lagrange coefficient

$${λ}_{1} = {\prod }_{k ∈ S , k \neq 1} \frac{k}{k - 1} = \frac{2}{2 - 1} \cdot \frac{3}{3 - 1} ,$$

and calculates

$${x}_{1} = {λ}_{1} {s}_{1} = \frac{2}{2 - 1} \cdot \frac{3}{3 - 1} \cdot {s}_{1} ; {P}_{2}$$

calculates a Lagrange coefficient

$${λ}_{2} = {\prod }_{k ∈ S , k \neq 2} \frac{k}{k - 2} = \frac{1}{1 - 2} \cdot \frac{3}{3 - 2} ,$$

and calculates

$${x}_{2} = {λ}_{2} {s}_{2} = \frac{1}{1 - 2} \cdot \frac{3}{3 - 2} \cdot {s}_{2} ;$$

and P₃ calculates a Lagrange coefficient

$${λ}_{3} = {\prod }_{k ∈ S , k \neq 3} \frac{k}{k - 3} = \frac{1}{1 - 3} \cdot \frac{2}{2 - 3} ,$$

and calculates

$${x}_{3} = {λ}_{3} {s}_{3} = \frac{1}{1 - 3} \cdot \frac{2}{2 - 3} \cdot {s}_{3} .$$

Then, P₁ generates a random t′=2-degree subpolynomial

$${f}_{1}^{′} ( z ) = {a}_{1 , 2}^{′} {z}^{2} + {a}_{1 , 1}^{′} z + {x}_{1} ;$$

P₂ generates a random t′=2-degree subpolynomial

$${f}_{2}^{′} ( z ) = {a}_{2 , 2}^{′} {z}^{2} + {a}_{2 , 1}^{′} z + {x}_{2} ;$$

and P₃ generates a random t′=2-degree subpolynomial

$${f}_{3}^{′} ( z ) = {a}_{3 , 2}^{′} {z}^{2} + {a}_{3 , 1}^{′} z + {x}_{3} .$$

In this case, there is the following new polynomial:

$${f}^{′} ( z ) = {a}_{1 , 2}^{′} {z}^{2} + {a}_{1 , 1}^{′} z + {x}_{1} + {a}_{2 , 2}^{′} {z}^{2} + {a}_{2 , 1}^{′} z + {x}_{2} + {a}_{3 , 2}^{′} {z}^{2} + {a}_{3 , 1}^{′} z + {x}_{3} = ( {a}_{1 , 2}^{′} + {a}_{2 , 2}^{′} + {a}_{3 , 2}^{′} ) {z}^{2} + ( {a}_{1 , 1}^{′} + {a}_{2 , 1}^{′} + {a}_{3 , 1}^{′} ) z + ( {x}_{1} + {x}_{2} + {x}_{3} ) .$$

S420: P₁ generates

$${f}_{1}^{′} ( 1 ) , {f}_{1}^{′} ( 2 ) , {f}_{1}^{′} ( 3 ) , {f}_{1}^{′} ( 4 ) , and {f}_{1}^{′} ( 5 ) ,$$

retains

$${f}_{1}^{′} ( 1 ) ,$$

encrypts and sends

$${f}_{1}^{′} ( 2 )$$

to P₂, encrypts and sends

$${f}_{1}^{′} ( 3 )$$

to P₃, encrypts and sends

$${f}_{1}^{′} ( 4 )$$

to P₄, and encrypts and sends

$${f}_{1}^{′} ( 5 )$$

to P₅; P₂ generates

$${f}_{2}^{′} ( 1 ) , {f}_{2}^{′} ( 2 ) , {f}_{2}^{′} ( 3 ) , {f}_{2}^{′} ( 4 ) ,$$

and

$${f}_{2}^{′} ( 5 ) ,$$

retains

$${f}_{2}^{′} ( 2 ) ,$$

encrypts and sends

$${f}_{2}^{′} ( 1 )$$

to P₁, encrypts and sends

$${f}_{2}^{′} ( 3 )$$

to P₃, encrypts and sends

$${f}_{2}^{′} ( 4 )$$

to P₄, and encrypts and sends

$${f}_{2}^{′} ( 5 )$$

to P₅; and P₃ generates

$${f}_{3}^{′} ( 1 ) , {f}_{3}^{′} ( 2 ) , {f}_{3}^{′} ( 3 ) , {f}_{3}^{′} ( 4 ) ,$$

and

$${f}_{3}^{′} ( 5 ) ,$$

retains

$${f}_{3}^{′} ( 3 ) ,$$

encrypts and sends

$${f}_{3}^{′} ( 1 )$$

to P₁, encrypts and sends

$${f}_{3}^{′} ( 2 )$$

to P₂, encrypts and sends

$${f}_{3}^{′} ( 4 )$$

to P₄, and encrypts and sends

$${f}_{3}^{′} ( 5 )$$

### to P₅.

In this case, P₁ locally has

$${f}_{1}^{′} ( 1 ) , {f}_{2}^{′} ( 1 ) , and {f}_{3}^{′} ( 1 ) ;$$

P₂ locally gas

$${f}_{1}^{′} ( 2 ) , {f}_{2}^{′} ( 2 ) , and {f}_{3}^{′} ( 2 ) ;$$

P₃ locally has

$${f}_{1}^{′} ( 3 ) , {f}_{2}^{′} ( 3 ) , and {f}_{3}^{′} ( 3 ) ;$$

P₄ locally has

$${f}_{1}^{′} ( 4 ) , {f}_{2}^{′} ( 4 ) , and {f}_{3}^{′} ( 4 ) ;$$

and P₅ locally has

$${f}_{1}^{′} ( 5 ) , {f}_{2}^{′} ( 5 ) , and {f}_{3}^{′} ( 5 ) .$$

In addition, the participant P₁ can generate

$${A}_{1 , l}^{′} = {a}_{1 , l}^{′} G ,$$

where l=0, 1, . . . , t′=2, including

$${A}_{1 , 0}^{′} = {a}_{1 , 0}^{′} G = {x}_{1} G , {A}_{1 , 1}^{′} = {a}_{1 , 1}^{′} G , and {A}_{1 , 2}^{′} = {a}_{1 , 2}^{′} G ,$$

and broadcast

$$\{ {A}_{1 , 0}^{′} , {A}_{1 , 1}^{′} , {A}_{1 , 2}^{′} \}$$

to P₂, P₃, P₄, and P₅; the participant P₂ can generate

$${A}_{2 , l}^{′} = {a}_{2 , l}^{′} G ,$$

where l=0, 1, . . . , t′=2, including

$${A}_{2 , 0}^{′} = {a}_{2 , 0}^{′} G = {x}_{2} G , {A}_{2 , 1}^{′} = {a}_{2 , 1}^{′} G , and {A}_{2 , 2}^{′} = {a}_{2 , 2}^{′} G ,$$

and broadcast

$$\{ {A}_{2 , 0}^{′} , {A}_{2 , 1}^{′} , {A}_{2 , 2}^{′} \}$$

to P₁, P₃, P₄, and P₅; and the participant P₃ can generate

$${A}_{3 , l}^{′} = {a}_{3 , l}^{′} G ,$$

where l=0, 1, . . . , t′=2, including

$${A}_{3 , 0}^{′} = {a}_{3 , 0}^{′} G = {x}_{3} G , {A}_{3 , 1}^{′} = {a}_{3 , 1}^{′} G , and {A}_{3 , 2}^{′} = {a}_{3 , 2}^{′} G ,$$

and broadcast

$$\{ {A}_{3 , 0}^{′} , {A}_{3 , 1}^{′} , {A}_{3 , 2}^{′} \}$$

to P₁, P₂, P₄, and P₅.

Further, the participant P₁ can verify

$${f}_{2}^{′} ( 1 )$$

based on

$${f}_{2}^{′} ( 1 ) G = {A}_{2 , 0}^{′} + {A}_{2 , 1}^{′} + {A}_{2 , 2}^{′} ,$$

and verify

$${f}_{3}^{′} ( 1 )$$

based on

$${f}_{3}^{′} ( 1 ) G = {A}_{3 , 0}^{′} + {A}_{3 , 1}^{′} + {A}_{3 , 2}^{′} ;$$

the participant P₂ can verify

$${f}_{1}^{′} ( 2 )$$

based on

$${f}_{1}^{′} ( 2 ) G = {A}_{1 , 0}^{′} + 2 {A}_{1 , 1}^{′} + {2}^{2} {A}_{1 , 2}^{′} ,$$

and verify

$${f}_{3}^{′} ( 2 )$$

based on

$${f}_{3}^{′} ( 2 ) G = {A}_{3 , 0}^{′} + 2 {A}_{3 , 1}^{′} + {2}^{2} {A}_{3 , 2}^{′} ;$$

the participant P₃ can verify

$${f}_{1}^{′} ( 2 )$$

based on

$${f}_{1}^{′} ( 3 ) G = {A}_{3 , 0}^{′} + 3 {A}_{3 , 1}^{′} + {3}^{3} {A}_{3 , 2}^{′} ,$$

and verify

$${f}_{2}^{′} ( 3 )$$

based on

$${f}_{2}^{′} ( 3 ) G = {A}_{2 , 0}^{′} + 3 {A}_{2 , 1}^{′} + {3}^{3} {A}_{2 , 2}^{′} ;$$

the participant P₄ can verify

$${f}_{1}^{′} ( 4 )$$

based on

$${f}_{1}^{′} ( 4 ) G = {A}_{1 , 0}^{′} + 4 {A}_{1 , 1}^{′} + {4}^{4} {A}_{1 , 2}^{′} ,$$

verify

$${f}_{2}^{′} ( 4 )$$

based on

$${f}_{2}^{′} ( 4 ) G = {A}_{2 , 0}^{′} + 4 {A}_{2 , 1}^{′} + {4}^{4} {A}_{2 , 2}^{′} ,$$

and verify

$${f}_{3}^{′} ( 4 )$$

based on

$${f}_{3}^{′} ( 4 ) G = {A}_{3 , 0}^{′} + 4 {A}_{3 , 1}^{′} + {4}^{4} {A}_{3 , 2}^{′} ;$$

and the participant P₅ can verify

$${f}_{1}^{′} ( 5 )$$

based on

$${f}_{1}^{′} ( 5 ) G = {A}_{1 , 0}^{′} + 5 {A}_{1 , 1}^{′} + {5}^{5} {A}_{1 , 2}^{′} ,$$

verify

$${f}_{2}^{′} ( 5 )$$

based on

$${f}_{2}^{′} ( 5 ) G = {A}_{2 , 0}^{′} + 5 {A}_{2 , 1}^{′} + {5}^{5} {A}_{2 , 2}^{′} ,$$

and verify

$${f}_{3}^{′} ( 5 )$$

based on

$${f}_{3}^{′} ( 5 ) G = {A}_{3 , 0}^{′} + 5 {A}_{3 , 1}^{′} + {5}^{5} {A}_{3 , 2}^{′} .$$

Any party can terminate a protocol if verification fails.

In another aspect, each participant Pᵢ can calculate the total public key X′. A calculation method is similar to the above-mentioned method. For example, the following formula is used here:

$${X}^{′} = {\sum }_{j = 1}^{{t}^{′}} {A}_{j , 0}^{′} = {A}_{1 , 0}^{′} + {A}_{2 , 0}^{′} + {A}_{3 , 0}^{′} = ( {x}_{1} + {x}_{2} + {x}_{3} ) \cdot G$$

As described above, the new total public key X′ can be used to verify the total signature obtained by aggregating new signature shares generated subsequently by using updated secret shares. In addition, not only a total quantity of participants can be dynamically changed, but also a threshold can be dynamically changed; and a total public-private key (X, x) remains unchanged. Based on the solutions in this application, any threshold signature solution based on a discrete logarithm problem can be constructed, including a threshold ECDSA, threshold SM2, and a threshold Schnorr signature solution, and the threshold t and the total quantity n of participants can be dynamically changed without assuming that honest participants occupy a majority.

S430: P₁ calculates a new private key share

$${s}_{1}^{′} = {\sum }_{i ∈ S} {f}_{i}^{′} ( 1 ) = {f}_{1}^{′} ( 1 ) + {f}_{2}^{′} ( 1 ) + {f}_{3}^{′} ( 1 ) ;$$

P₂ calculates a new private key share

$${s}_{2}^{′} = {\sum }_{i ∈ S} {f}_{i}^{′} ( 2 ) = {f}_{1}^{′} ( 2 ) + {f}_{2}^{′} ( 2 ) + {f}_{3}^{′} ( 2 ) ;$$

P₃ calculates a new private key share

$${s}_{3}^{′} = {\sum }_{i ∈ S} {f}_{i}^{′} ( 3 ) = {f}_{1}^{′} ( 3 ) + {f}_{2}^{′} ( 3 ) + {f}_{3}^{′} ( 3 ) ;$$

P₄ calculates a new private key share

$${s}_{4}^{′} = {\sum }_{i ∈ S} {f}_{i}^{′} ( 4 ) = {f}_{1}^{′} ( 4 ) + {f}_{2}^{′} ( 4 ) + {f}_{3}^{′} ( 4 ) ;$$

and P₅ calculates a new private key share

$${s}_{5}^{′} = {\sum }_{i ∈ S} {f}_{i}^{′} ( 5 ) = {f}_{1}^{′} ( 5 ) + {f}_{2}^{′} ( 5 ) + {f}_{3}^{′} ( 5 ) .$$

New private key share components of t+1=3 participants in the offline phase after the change are respectively, for example,

$${x}_{1}^{′} = {λ}_{1} {s}_{1}^{′} , {x}_{2}^{′} = {λ}_{2} {s}_{2}^{′} , and {x}_{3}^{′} = {λ}_{3} {s}_{3}^{′} .$$

### Here,

$${λ}_{1} = {\prod }_{j ∈ [ 1 , 3 ] , j \neq 1} \frac{j}{j - 1} = \frac{2}{2 - 1} \cdot \frac{3}{3 - 1} , \\ {λ}_{2} = {\prod }_{j ∈ [ 1 , 3 ] , j \neq 2} \frac{j}{j - 2} = \frac{1}{1 - 2} \cdot \frac{3}{3 - 2} ,$$

and

$${λ}_{3} = {\prod }_{j ∈ [ 1 , 3 ] , j \neq 3} \frac{j}{j - 3} = \frac{1}{1 - 3} \cdot \frac{2}{2 - 3} .$$

In this case, the new total private key is:

$${x}^{′} = {\sum }_{i ∈ [ 1 , t + 1 ]} {x}_{i}^{′} = {x}_{1}^{′} + {x}_{2}^{′} + {x}_{3}^{′} = {λ}_{1} {s}_{1}^{′} + {λ}_{2} {s}_{2}^{′} + {λ}_{3} {s}_{3}^{′} = \frac{2}{2 - 1} \cdot \frac{3}{3 - 1} \cdot ( {f}_{1}^{′} ( 1 ) + {f}_{2}^{′} ( 1 ) + {f}_{3}^{′} ( 1 ) ) + \frac{1}{1 - 2} \cdot \frac{3}{3 - 2} \cdot ( {f}_{1}^{′} ( 2 ) + {f}_{2}^{′} ( 2 ) + {f}_{3}^{′} ( 2 ) ) + \frac{1}{1 - 3} \cdot \frac{2}{2 - 3} \cdot ( {f}_{1}^{′} ( 3 ) + {f}_{2}^{′} ( 3 ) + {f}_{3}^{′} ( 3 ) ) = 3 {f}_{1}^{′} ( 1 ) + 3 {f}_{2}^{′} ( 1 ) + 3 {f}_{3}^{′} ( 1 ) - 3 {f}_{1}^{′} ( 2 ) - 3 {f}_{2}^{′} ( 2 ) - 3 {f}_{3}^{′} ( 2 ) + {f}_{1}^{′} ( 3 ) + {f}_{2}^{′} ( 3 ) + {f}_{3}^{′} ( 3 ) = 3 ( {x}_{1} + {a}_{1 , 1}^{′} + {a}_{1 , 2}^{′} ) + 3 ( {x}_{2} + {a}_{2 , 1}^{′} + {a}_{2 , 2}^{′} ) + 3 ( {x}_{3} + {a}_{3 , 1}^{′} + {a}_{3 , 2}^{′} ) - 3 ( {x}_{1} + 2 {a}_{1 , 1}^{′} + 4 {a}_{1 , 2}^{′} ) - 3 ( {x}_{2} + 2 {a}_{2 , 1}^{′} + 4 {a}_{2 , 2}^{′} ) - 3 ( {x}_{3} + 2 {a}_{3 , 1}^{′} + 4 {a}_{3 , 2}^{′} ) + ( {x}_{1} + 3 {a}_{1 , 1}^{′} + 9 {a}_{1 , 2}^{′} ) + ( {x}_{2} + 3 {a}_{2 , 1}^{′} + 9 {a}_{2 , 2}^{′} ) + ( {x}_{3} + 3 {a}_{3 , 1}^{′} + 9 {a}_{3 , 2}^{′} ) = {x}_{1} + {x}_{2} + {x}_{3} + ( 3 {a}_{1 , 1}^{′} - 6 {a}_{1 , 1}^{′} + 3 {a}_{1 , 1}^{′} ) + ( 3 {a}_{1 , 2}^{′} - 12 {a}_{1 , 2}^{′} + 9 {a}_{1 , 2}^{′} ) + ( 3 {a}_{2 , 1}^{′} - 6 {a}_{2 , 1}^{′} + 3 {a}_{2 , 1}^{′} ) + ( 3 {a}_{2 , 2}^{′} - 12 {a}_{2 , 2}^{′} + 9 {a}_{2 , 2}^{′} ) + ( 3 {a}_{3 , 1}^{′} - 6 {a}_{3 , 1}^{′} + 3 {a}_{3 , 1}^{′} ) + ( 3 {a}_{3 , 2}^{′} - 12 {a}_{3 , 2}^{′} + 9 {a}_{3 , 2}^{′} ) = {x}_{1} + {x}_{2} + {x}_{3} = {f}^{′} ( 0 ) = f ( 0 )$$

It can be seen that the new total private key is equal to the original total private key, that is, x′=x. It is clear that a corresponding new total public key is also equal to an original total public key. Therefore, the original total public key can still be used to verify the total signature obtained by aggregating new signature shares generated subsequently by using updated secret shares.

In another specific example, a first participant set [symbol] existing before a change includes n=4 participants {P₁, . . . , P₄}, and a second participant set [symbol] obtained after the change includes n′=3 participants {P₁, P₂, P₃}. n′=3<n=4. That is, a participant exits. For example, a participant P₄ exits. Assume that a threshold existing before the change and a threshold obtained after the change are 2, that is, t=t′=2. The following steps are included.

S510: Each of at least 3 participants in a third set [symbol] obtained by intersecting the first participant set [symbol] existing before the change and the second participant set [symbol] obtained after the change generates a new t′=2-degree random polynomial by using an original private key share component as a secret value.

If the third set [symbol] can be obtained by intersecting the first participant set [symbol] existing before the change and the second participant set [symbol] obtained after the change, [symbol] satisfies [symbol] ={Pᵢ}_{i∈S}⊆ [symbol] ⋅ [symbol] , that is, the participant in the set [symbol] is a member of the old set [symbol] and a member of the new set [symbol] . In this case, [symbol] is {P₁, P₂, P₃}.

A process in which four participants in the first participant set [symbol] existing before the change generates a key share by based on a distributed threshold key generation protocol is described. As described above, a main related conclusion is as follows: P₁ sets a secret s₁₀, and a private key share is s₁=s₁₁+s₂₁+s₃₁+s₄₁; P₂ sets a secret s₂₀, and a private key share is s₂=s₁₂+s₂₂+s₃₂+s₄₂; P₃ sets a secret s₃₀, and a private key share is s₃=s₁₃+s₂₃+s₃₃+s₄₃; and P₄ sets a secret s₄₀, and a private key share is s₄=s₁₄+s₂₄+s₃₄+s₄₄.

Original private key share components generated by t+1=3 participants in an offline phase before the change are respectively, for example, ×1=λ₁s₁, x₂=λ₂s₂, and x₃=λ₃s₃. Here,

$${λ}_{1} = {\prod }_{j ∈ [ 1 , 3 ] , j \neq 1} \frac{j}{j - 1} = \frac{2}{2 - 1} \cdot \frac{3}{3 - 1} , \\ {λ}_{2} = {\prod }_{j ∈ [ 1 , 3 ] , j \neq 2} \frac{j}{j - 2} = \frac{1}{1 - 2} \cdot \frac{3}{3 - 2} ,$$

and

$${λ}_{3} = {\prod }_{j ∈ [ 1 , 3 ] , j \neq 3} \frac{j}{j - 3} = \frac{1}{1 - 3} \cdot \frac{2}{2 - 3} .$$

In this case, an original total private key is x=Σ_{i∈[1,t+1]}xᵢ=s₁₀+s₂₀+s₃₀+s₄₀=f(0). For specific derivation, references can be made to the above-mentioned descriptions.

For P₁, P₂, and P₃ in the second participant set [symbol] obtained after the change: P₁ calculates a Lagrange coefficient

$${λ}_{1} = {\prod }_{k ∈ S , k \neq 1} \frac{k}{k - 1} = \frac{2}{2 - 1} \cdot \frac{3}{3 - 1} ,$$

and calculates

$${x}_{1} = {λ}_{1} {s}_{1} = \frac{2}{2 - 1} \cdot \frac{3}{3 - 1} \cdot {s}_{1} ; {P}_{2}$$

calculates a Lagrange coefficient

$${λ}_{2} = {\prod }_{k ∈ S , k \neq 2} \frac{k}{k - 2} = \frac{1}{1 - 2} \cdot \frac{3}{3 - 2} ,$$

and calculates

$${x}_{2} = {λ}_{2} {s}_{2} = \frac{1}{1 - 2} \cdot \frac{3}{3 - 2} \cdot {s}_{2} ;$$

and P₃ calculates a Lagrange coefficient

$${λ}_{3} = {\prod }_{k ∈ S , k \neq 3} \frac{k}{k - 3} = \frac{1}{1 - 3} \cdot \frac{2}{2 - 3} ,$$

and calculates

$${x}_{3} = {λ}_{3} {s}_{3} = \frac{1}{1 - 3} \cdot \frac{2}{2 - 3} \cdot {s}_{3} .$$

Then, P₁ generates a random t′=2-degree subpolynomial

$${f}_{1}^{′} ( z ) = {a}_{1 , 2}^{′} {z}^{2} + {a}_{1 ,}^{′} z + {x}_{1} ;$$

P₂ generates a random t′=2-degree subpolynomial

$${f}_{2}^{′} ( z ) = {a}_{2 , 2}^{′} {z}^{2} + {a}_{2 , 1}^{′} z + {x}_{2} ;$$

and P₃ generates a random t′=2-degree subpolynomial

$${f}_{3}^{′} ( z ) = {a}_{3 , 2}^{′} {z}^{2} + {a}_{3 , 1}^{′} z + {x}_{3} .$$

In this case, there is the following new polynomial:

$${f}^{′} ( z ) = {a}_{1 , 2}^{′} {z}^{2} + {a}_{1 , 1}^{′} z + {x}_{1} + {a}_{2 , 2}^{′} {z}^{2} + {a}_{2 , 1}^{′} z + {x}_{2} + {a}_{3 , 2}^{′} {z}^{2} + {a}_{3 , 1}^{′} z + {x}_{3} = ( {a}_{1 , 2}^{′} + {a}_{2 , 2}^{′} + {a}_{3 , 2}^{′} ) {z}^{2} + ( {a}_{1 , 1}^{′} + {a}_{2 , 1}^{′} + {a}_{3 , 1}^{′} ) z + ( {x}_{1} + {x}_{2} + {x}_{3} ) .$$

S520: P₁ generates

$${f}_{1}^{′} ( 1 ) , {f}_{1}^{′} ( 2 ) ,$$

and

$${f}_{1}^{′} ( 3 ) ,$$

retains

$${f}_{1}^{′} ( 1 ) ,$$

encrypts and sends

$${f}_{1}^{′} ( 2 )$$

to P₂, and encrypts and sends

$${f}_{1}^{′} ( 3 )$$

to P₃; P₂ generates

$${f}_{2}^{′} ( 1 ) , {f}_{2}^{′} ( 2 ) ,$$

and

$${f}_{2}^{′} ( 3 ) ,$$

retains

$${f}_{2}^{′} ( 2 ) ,$$

encrypts and sends

$${f}_{2}^{′} ( 1 )$$

to P₁, and encrypts and sends

$${f}_{2}^{′} ( 3 )$$

to P₃; and P₃ generates

$${f}_{3}^{′} ( 1 ) , {f}_{3}^{′} ( 2 ) ,$$

and

$${f}_{3}^{′} ( 3 ) ,$$

retains

$${f}_{3}^{′} ( 3 ) ,$$

encrypts and sends

$${f}_{3}^{′} ( 1 )$$

to P₁, and encrypts and sends

$${f}_{3}^{′} ( 2 )$$

### to P₂.

In this case, P₁ locally has

$${f}_{1}^{′} ( 1 ) , {f}_{2}^{′} ( 1 ) ,$$

and

$${f}_{3}^{′} ( 1 ) ;$$

P₂ locally has

$${f}_{1}^{′} ( 2 ) , {f}_{2}^{′} ( 2 ) , and {f}_{3}^{′} ( 2 ) ;$$

and P₃ locally has

$${f}_{1}^{′} ( 3 ) , {f}_{2}^{′} ( 3 ) ,$$

and

$${f}_{3}^{′} ( 3 ) .$$

In addition, the participant P₁ can generate

$${A}_{1 , l}^{′} = {a}_{1 , l}^{′} G ,$$

where l=0, 1, . . . , t′=2, including

$${A}_{1 , 0}^{′} = {a}_{1 , 0}^{′} G = {x}_{1} G , {A}_{1 , 1}^{′} = {a}_{1 , 1}^{′} G , and {A}_{1 , 2}^{′} = {a}_{1 , 2}^{′} G ,$$

and broadcast

$$\{ {A}_{1 , 0}^{′} , {A}_{1 , 1}^{′} , {A}_{1 , 2}^{′} \}$$

to P₂ and P₃; the participant P₂ can generate

$${A}_{2 , l}^{′} = {a}_{2 , l}^{′} G ,$$

where l=0, 1, . . . , t′=2, including

$${A}_{2 , 0}^{′} = {a}_{2 , 0}^{′} G = {x}_{2} G , {A}_{2 , 1}^{′} = {a}_{2 , 1}^{′} G ,$$

and

$${A}_{2 , 2}^{′} = {a}_{2 , 2}^{′} G ,$$

and broadcast

$$\{ {A}_{2 , 0}^{′} , {A}_{2 , 1}^{′} , {A}_{2 , 2}^{′} \}$$

to P₁ and P₃; and the participant P₃ can generate

$${A}_{3 , l}^{′} = {a}_{3 , l}^{′} G ,$$

where l=0, 1, . . . , t′=2, including

$${A}_{3 , 0}^{′} = {a}_{3 , 0}^{′} G = {x}_{3} G ,$$

$${A}_{3 , 1}^{′} = {a}_{3 , 1}^{′} G , and {A}_{3 , 2}^{′} = {a}_{3 , 2}^{′} G ,$$

and broadcast

$$\{ {A}_{3 , 0}^{′} , {A}_{3 , 1}^{′} , {A}_{3 , 2}^{′} \}$$

to P₁ and P₂.

Further, the participant P₁ can verify

$${f}_{2}^{′} ( 1 )$$

based on

$${f}_{2}^{′} ( 1 ) G = {A}_{2 , 0}^{′} + {A}_{2 , 1}^{′} + {A}_{2 , 2}^{′} ,$$

and verify

$${f}_{3}^{′} ( 1 )$$

based on

$${f}_{3}^{′} ( 1 ) G = {A}_{3 , 0}^{′} + {A}_{3 , 1}^{′} + {A}_{3 , 2}^{′} ;$$

the participant P₂ can verify

$${f}_{1}^{′} ( 2 )$$

based on

$${f}_{1}^{′} ( 2 ) G = {A}_{1 , 0}^{′} + 2 {A}_{1 , 1}^{′} + {2}^{2} {A}_{1 , 2}^{′} ,$$

and verify

$${f}_{3}^{′} ( 2 )$$

based on

$${f}_{3}^{′} ( 2 ) G = {A}_{3 , 0}^{′} + 2 {A}_{3 , 1}^{′} + {2}^{2} {A}_{3 , 2}^{′} ;$$

and the participant P₃ can verify

$${f}_{1}^{′} ( 2 )$$

based on

$${f}_{1}^{′} ( 3 ) G = {A}_{3 , 0}^{′} + 3 {A}_{3 , 1}^{′} + {3}^{3} {A}_{3 , 2}^{′} ,$$

and verify

$${f}_{2}^{′} ( 3 )$$

based on

$${f}_{2}^{′} ( 3 ) G = {A}_{2 , 0}^{′} + 3 {A}_{2 , 1}^{′} + {3}^{3} {A}_{2 , 2}^{′} .$$

Any party can terminate a protocol if verification fails.

In another aspect, each participant Pᵢ can calculate the total public key X′. A calculation method is similar to the above-mentioned method. For example, the following formula is used here:

$${X}^{′} = {{\sum }^{{t}^{′}}}_{i = 1} {A}_{j , 0}^{′} = {A}_{1 , 0}^{′} + {A}_{2 , 0}^{′} + {A}_{3 , 0}^{′} = ( {x}_{1} + {x}_{2} + {x}_{3} ) \cdot G$$

As described above, the new total public key X′ can be used to verify the total signature obtained by aggregating new signature shares generated subsequently by using updated secret shares.

S530: P₁ calculates a new private key share

$${s}_{1}^{′} = {\sum }_{i ∈ S} {f}_{i}^{′} ( 1 ) = {f}_{1}^{′} ( 1 ) + {f}_{2}^{′} ( 1 ) + {f}_{3}^{′} ( 1 ) ;$$

P₂ calculates a new private key share

$${s}_{2}^{′} = {\sum }_{i ∈ S} {f}_{i}^{′} ( 2 ) = {f}_{1}^{′} ( 2 ) + {f}_{2}^{′} ( 2 ) + {f}_{3}^{′} ( 2 ) ;$$

and P₃ calculates a new private key share

$${s}_{3}^{′} = {\sum }_{i ∈ S} {f}_{i}^{′} ( 3 ) = {f}_{1}^{′} ( 3 ) + {f}_{2}^{′} ( 3 ) + {f}_{3}^{′} ( 3 ) .$$

New private key share components of t+1=3 participants in the offline phase after the change are respectively, for example,

$${x}_{1}^{′} = {λ}_{1} {s}_{1}^{′} , {x}_{2}^{′} = {λ}_{2} {s}_{2}^{′} , and {x}_{3}^{′} = {λ}_{3} {s}_{3}^{′} .$$

### Here

$${λ}_{1} = {\prod }_{j ∈ [ 1 , 3 ] , j \neq 1} \frac{j}{j - 1} = \frac{2}{2 - 1} \cdot \frac{3}{3 - 1} ,$$

$${λ}_{2} = {\prod }_{j ∈ [ 1 , 3 ] , j \neq 2} \frac{j}{j - 2} = \frac{1}{1 - 2} \cdot \frac{3}{3 - 2} ,$$

and

$${λ}_{3} = {\prod }_{j ∈ [ 1 , 3 ] , j \neq 3} \frac{j}{j - 3} = \frac{1}{1 - 3} \cdot \frac{2}{2 - 3} .$$

In this case, the new total private key is:

$${x}^{′} = {\sum }_{i ∈ [ 1 , t + 1 ]} {x}_{i}^{′} = {x}_{1}^{′} + {x}_{2}^{′} + {x}_{3}^{′} = {λ}_{1} {s}_{1}^{′} + {λ}_{2} {s}_{2}^{′} + {λ}_{3} {s}_{3}^{′} = \frac{2}{2 - 1} \cdot \frac{3}{3 - 1} \cdot ( {f}_{1}^{′} ( 1 ) + {f}_{2}^{′} ( 1 ) + {f}_{3}^{′} ( 1 ) ) + \frac{1}{1 - 2} \cdot \frac{3}{3 - 2} \cdot ( {f}_{1}^{′} ( 2 ) + {f}_{2}^{′} ( 2 ) + {f}_{3}^{′} ( 2 ) ) + \frac{1}{1 - 3} \cdot \frac{2}{2 - 3} \cdot ( {f}_{1}^{′} ( 3 ) + {f}_{2}^{′} ( 3 ) + {f}_{3}^{′} ( 3 ) ) = 3 {f}_{1}^{′} ( 1 ) + 3 {f}_{2}^{′} ( 1 ) + 3 {f}_{3}^{′} ( 1 ) - 3 {f}_{1} ( 2 ) - 3 {f}_{2}^{′} ( 2 ) - \\ 3 {f}_{3}^{′} ( 2 ) + {f}_{1} ( 3 ) + {f}_{2}^{′} ( 3 ) + {f}_{3}^{′} ( 3 ) = 3 ( {x}_{1} + {a}_{1 , 1}^{′} + {a}_{1 , 2}^{′} ) + 3 ( {x}_{2} + {a}_{2 , 1}^{′} + {a}_{2 , 2}^{′} ) + \\ 3 ( {x}_{3} + {a}_{3 , 1}^{′} + {a}_{3 , 2}^{′} ) - 3 ( {x}_{1} + 2 {a}_{1 , 1}^{′} + 4 {a}_{1 , 2}^{′} ) - 3 ( {x}_{2} + 2 {a}_{2 , 1}^{′} + 4 {a}_{2 , 2}^{′} ) - 3 ( {x}_{3} + 2 {a}_{3 , 1}^{′} + 4 {a}_{3 , 2}^{′} ) + ( {x}_{1} + 3 {a}_{1 , 1}^{′} + 9 {a}_{1 , 2}^{′} ) + ( {x}_{2} + 3 {a}_{2 , 1}^{′} + 9 {a}_{2 , 2}^{′} ) + ( {x}_{3} + 3 {a}_{3 , 1}^{′} + 9 {a}_{3 , 2}^{′} ) = {x}_{1} + {x}_{2} + {x}_{3} + ( 3 {a}_{1 , 1}^{′} - 6 {a}_{1 , 1}^{′} + 3 {a}_{1 , 1}^{′} ) + ( 3 {a}_{1 , 2}^{′} - 12 {a}_{{1}_{4} 2}^{′} + 9 {a}_{1 , 2}^{′} ) + ( 3 {a}_{2 , 1}^{′} - 6 {a}_{2 , 1}^{′} + 3 {a}_{2 , 1}^{′} ) + ( 3 {a}_{2 , 2}^{′} - 12 {a}_{2 , 2}^{′} + 9 {a}_{2 , 2}^{′} ) + ( 3 {a}_{3 , 1}^{′} - 6 {a}_{3 , 1}^{′} + 3 {a}_{3 , 1}^{′} ) + ( 3 {a}_{3 , 2}^{′} - 12 {a}_{3 , 2}^{′} + 9 {a}_{3 , 2}^{′} ) = {x}_{1} + {x}_{2} + {x}_{3} = {f}^{′} ( 0 ) = f ( 0 )$$

It can be seen that the new total private key is equal to the original total private key, that is, x′=x. It is clear that a corresponding new total public key is also equal to an original total public key. Therefore, the original total public key can still be used to verify the total signature obtained by aggregating new signature shares generated subsequently by using updated secret shares.

In still another specific example, a first participant set [symbol] existing before a change includes n=4 participants {P₁, . . . , P₄}, a second participant set [symbol] obtained after the change remains unchanged, and the threshold changes from 2 to 1, that is, t=2, t′=1. The following steps are included.

S610: Each of at least 3 participants in a third set [symbol] obtained by intersecting the first participant set [symbol] existing before the change and the second participant set [symbol] obtained after the change generates a new t′=1-degree random polynomial by using an original private key share component as a secret value.

If the third set [symbol] can be obtained by intersecting the first participant set [symbol] existing before the change and the second participant set [symbol] obtained after the change, [symbol] satisfies [symbol] ={Pᵢ}_{i∈S}⊆ [symbol] ∩ [symbol] , that is, the participant in the set [symbol] is a member of the old set [symbol] and a member of the new set [symbol] , and [symbol] may be any one of the four sets {P₁, P₂, P₃}, {P₁, P₂, P₄}, {P₁, P₃, P₄}, {P₂, P₃, P₄}. The following provides descriptions by using an example in which [symbol] is {P₁, P₂, P₃}. The same is true to another case.

A process in which four participants in the first participant set [symbol] existing before the change generates a key share by based on a distributed threshold key generation protocol is described. As described above, a main related conclusion is as follows: P₁ sets a secret s₁₀, and a private key share is s₁=s₁₁+s₂₁+s₃₁+s₄₁; P₂ sets a secret s₂₀, and a private key share is s₂=s₁₂+s₂₂+s₃₂+s₄₂; P₃ sets a secret s₃₀, and a private key share is s₃=s₁₃+s₂₃+s₃₃+s₄₃; and P₄ sets a secret s₄₀, and a private key share is s₄=s₁₄+s₂₄+s₃₄+s₄₄.

Original private key share components generated by t+1=3 participants in an offline phase before the change are respectively, for example, ×1=λ₁s₁, x₂=λ₂s₂, and x₃=λ₃s₃. Here,

$${λ}_{1} = {\prod }_{j ∈ [ 1 , 3 ] , j \neq 1} \frac{j}{j - 1} = \frac{2}{2 - 1} \cdot \frac{3}{3 - 1} ,$$

$${λ}_{2} = {\prod }_{j ∈ [ 1 , 3 ] , j \neq 2} \frac{j}{j - 2} = \frac{1}{1 - 2} \cdot \frac{3}{3 - 2} , and$$

$${λ}_{3} = {\prod }_{j ∈ [ 1 , 3 ] , j \neq 3} \frac{j}{j - 3} = \frac{1}{1 - 3} \cdot \frac{2}{2 - 3}$$

In this case, an original total private key is x=Σ_{i∈[1,t+1]}xᵢ=s₁₀+s₂₀+s₃₀+s₄₀=f(0). For specific derivation, references can be made to the above-mentioned descriptions.

For P₁, P₂, and P₃ in the second participant set P′ obtained after the change: P₁ calculates a Lagrange coefficient

$${λ}_{1} = {\prod }_{k ∈ S , k \neq 1} \frac{k}{k - 1} = \frac{2}{2 - 1} \cdot \frac{3}{3 - 1} ,$$

and calculates

$${x}_{1} = {λ}_{1} {s}_{1} = \frac{2}{2 - 1} \cdot \frac{3}{3 - 1} \cdot {s}_{1} ;$$

P₂ calculates a Lagrange coefficient

$${λ}_{2} = {\prod }_{k ∈ S , k \neq 2} \frac{k}{k - 2} = \frac{1}{1 - 2} \cdot \frac{3}{3 - 2} ,$$

and calculates

$${x}_{2} = {λ}_{2} {s}_{2} = \frac{1}{1 - 2} \cdot \frac{3}{3 - 2} \cdot {s}_{2} ;$$

and P₃ calculates a Lagrange coefficient

$${λ}_{3} = {\prod }_{k ∈ S , k \neq 3} \frac{k}{k - 3} = \frac{1}{1 - 3} \cdot \frac{2}{2 - 3} ,$$

and calculates

$${x}_{3} = {λ}_{3} {s}_{3} = \frac{1}{1 - 3} \cdot \frac{2}{2 - 3} \cdot {s}_{3} .$$

Then, P₁ generates a random t′=1-degree subpolynomial

$${f}_{1}^{′} ( z ) = {a}_{1 , 1}^{′} z + {x}_{1} ;$$

P₂ generates a random t′=1-degree subpolynomial

$${f}_{2}^{′} ( z ) = {a}_{2 , 1}^{′} z + {x}_{2} ;$$

and P₃ generates a random t′=1-degree subpolynomial

$${f}_{3}^{′} ( z ) = {a}_{3 , 1}^{′} z + {x}_{3} .$$

In this case, there is the following new polynomial:

$${f}^{′} ( z ) = {a}_{1 , 1}^{′} z + {x}_{1} + {a}_{2 , 1}^{′} z + {x}_{2} + {a}_{3 , 1}^{′} z + {x}_{3} = ( {a}_{1 , 1}^{′} + {a}_{2 , 1}^{′} + {a}_{3 , 1}^{′} ) z + ( {x}_{1} + {x}_{2} + {x}_{3} ) .$$

S620: P₁ generates

$${f}_{1}^{′} ( 1 ) , {f}_{1}^{′} ( 2 ) , {f}_{1}^{′} ( 3 ) ,$$

and

$${f}_{1}^{′} ( 4 ) ,$$

retains

$${f}_{1}^{′} ( 1 ) ,$$

encrypts and sends

$${f}_{1}^{′} ( 2 )$$

to P₂, encrypts and sends

$${f}_{1}^{′} ( 3 )$$

to P₃, encrypts and sends

$${f}_{1}^{′} ( 4 )$$

to P₄, P₂ generates

$${f}_{2}^{′} ( 1 ) , {f}_{2}^{′} ( 2 ) , {f}_{2}^{′} ( 3 ) , and {f}_{2}^{′} ( 4 ) ,$$

retains

$${f}_{2}^{′} ( 2 ) ,$$

encrypts and sends

$${f}_{2}^{′} ( 1 )$$

to P₁, encrypts and sends

$${f}_{2}^{′} ( 3 )$$

to P₃, and encrypts and sends

$${f}_{2}^{′} ( 4 )$$

to P₄; P₃ generates

$${f}_{3}^{′} ( 1 ) , {f}_{3}^{′} ( 2 ) , {f}_{3}^{′} ( 3 ) , and {f}_{3}^{′} ( 4 ) ,$$

retains

$${f}_{3}^{′} ( 3 ) ,$$

encrypts and sends

$${f}_{3}^{′} ( 1 )$$

to P₁, encrypts and sends

$${f}_{3}^{′} ( 2 )$$

to P₂, and encrypts and sends

$${f}_{3}^{′} ( 4 )$$

### to P₄.

In this case, P₁ locally has

$${f}_{1}^{′} ( 1 ) , {f}_{2}^{′} ( 1 ) , and {f}_{3}^{′} ( 1 ) ;$$

P₂ locally has

$${f}_{1}^{′} ( 2 ) , {f}_{2}^{′} ( 2 ) , and {f}_{3}^{′} ( 2 ) ;$$

P₃ locally has

$${f}_{1}^{′} ( 3 ) , {f}_{2}^{′} ( 3 ) , and {f}_{3}^{′} ( 3 ) ;$$

and P₄ locally has

$${f}_{1}^{′} ( 4 ) , {f}_{2}^{′} ( 4 ) , and {f}_{3}^{′} ( 4 ) .$$

In addition, the participant P₁ can generate

$${A}_{1 , l}^{′} = {a}_{1 , l}^{′} G ,$$

where l=0, 1, . . . , t′=1, including

$${A}_{1 , 0}^{′} = {a}_{1 , 0}^{′} G = {x}_{1} G and {A}_{1 , 1}^{′} = {a}_{1 , 1}^{′} G ,$$

and broadcast

$$\{ {A}_{1 , 0}^{′} , {A}_{1 , 1}^{′} \}$$

to P₂, P₃, and P₄; the participant P₂ can generate

$${A}_{2 , l}^{′} = {a}_{2 , l}^{′} G ,$$

where l=0, 1, . . . , t′=2, including

$${A}_{2 , 0}^{′} = {a}_{2 , 0}^{′} G = {x}_{2} G and {A}_{2 , 1}^{′} = {a}_{2 , 1}^{′} G ,$$

and broadcast

$$\{ {A}_{2 , 0}^{′} , {A}_{2 , 1}^{′} \}$$

to P₁, P₃, and P₄; and the participant P₃ can generate

$${A}_{3 , l}^{′} = {a}_{3 , l}^{′} G ,$$

where l=0, 1, . . . , t′=2, including

$${A}_{3 , 0}^{′} = {a}_{3 , 0}^{′} G = {x}_{3} G and {A}_{3 , 1}^{′} = {a}_{3 , 1}^{′} G ,$$

and broadcast

$$\{ {A}_{3 , 0}^{′} , {A}_{3 , 1}^{′} \}$$

to P₁, P₂, and P₄.

Further, the participant P₁ can verify

$${f}_{2}^{′} ( 1 )$$

based on

$${f}_{2}^{′} ( 1 ) G = {A}_{2 , 0}^{′} + {A}_{2 , 1}^{′} ,$$

and verify

$${f}_{3}^{′} ( 1 )$$

based on

$${f}_{3}^{′} ( 1 ) G = {A}_{3 , 0}^{′} + {A}_{3 , 1}^{′} ;$$

the participant P₂ can verify

$${f}_{1}^{′} ( 2 )$$

based on

$${f}_{1}^{′} ( 2 ) G = {A}_{1 , 0}^{′} + 2 {A}_{1 , 1}^{′} ,$$

and verify

$${f}_{3}^{′} ( 2 )$$

based on

$${f}_{3}^{′} ( 2 ) G = {A}_{3 , 0}^{′} + 2 {A}_{3 , 1}^{′} ;$$

the participant P₃ can verify

$${f}_{1}^{′} ( 2 )$$

based on

$${f}_{1}^{′} ( 3 ) G = {A}_{3 , 0}^{′} + 3 {A}_{3 , 1}^{′} ,$$

and verify

$${f}_{2}^{′} ( 3 )$$

based on

$${f}_{2}^{′} ( 3 ) G = {A}_{2 , 0}^{′} + 3 {A}_{2 , 1}^{′} ;$$

and the participant P₄ can verify

$${f}_{1}^{′} ( 4 )$$

based on

$${f}_{1}^{′} ( 4 ) G = {A}_{1 , 0}^{′} + 4 {A}_{1 , 1}^{′} ,$$

verify

$${f}_{2}^{′} ( 4 )$$

based on

$${f}_{2}^{′} ( 4 ) G = {A}_{2 , 0}^{′} + 4 {A}_{2 , 1}^{′} ,$$

and verify

$${f}_{3}^{′} ( 4 )$$

based on

$${f}_{3}^{′} ( 4 ) G = {A}_{3 , 0}^{′} + 4 {A}_{3 , 1}^{′} .$$

Any party can terminate a protocol if verification fails.

In another aspect, each participant Pᵢ can calculate the total public key X′. A calculation method is similar to the above-mentioned method. For example, the following formula is used here:

$${X}^{′} = {\sum }_{j = 1}^{{t}^{′}} {A}_{j , 0}^{′} = {A}_{1 , 0}^{′} + {A}_{2 , 0}^{′} + {A}_{3 , 0}^{′} = ( {x}_{1} + {x}_{2} + {x}_{3} ) \cdot G$$

As described above, the new total public key X′ can be used to verify the total signature obtained by aggregating new signature shares generated subsequently by using updated secret shares.

S630: P₁ calculates a new private key share:

$${s}_{1}^{′} = {Σ}_{i ∈ S} {f}_{i}^{′} ( 1 ) = {f}_{1}^{′} ( 1 ) + {f}_{2}^{′} ( 1 ) + {f}_{3}^{′} ( 1 ) ;$$

P₂ calculates a new private key share

$${s}_{2}^{′} = {Σ}_{i ∈ S} {f}_{i}^{′} ( 2 ) = {f}_{1}^{′} ( 2 ) + {f}_{2}^{′} ( 2 ) + {f}_{3}^{′} ( 2 ) ;$$

P₃ calculates a new private key share

$${s}_{3}^{′} = {\sum }_{i ∈ S} {f}_{i}^{′} ( 3 ) = {f}_{1}^{′} ( 3 ) + {f}_{2}^{′} ( 3 ) + {f}_{3}^{′} ( 3 ) ;$$

and P₄ calculates a new private key share

$${s}_{4}^{′} = {\sum }_{i ∈ S} {f}_{i}^{′} ( 4 ) = {f}_{1}^{′} ( 4 ) + {f}_{2}^{′} ( 4 ) + {f}_{3}^{′} ( 4 ) .$$

New private key share components of t′+1=2 participants in the offline phase after the change are respectively, for example.

$${x}_{1}^{′} = {λ}_{1} {s}_{1}^{′} , {x}_{2}^{′} = {λ}_{2} {s}_{2}^{′} , and {x}_{3}^{′} = {λ}_{3} {s}_{3}^{′} .$$

### Here,

$${λ}_{1} = {\prod }_{j ∈ [ 1 , 3 ] , j \neq 1} \frac{j}{j - 1} = \frac{2}{2 - 1} \cdot \frac{3}{3 - 1} ,$$

$${λ}_{2} = {\prod }_{j ∈ [ 1 , 3 ] , j \neq 2} \frac{j}{j - 2} = \frac{1}{1 - 2} \cdot \frac{3}{3 - 2} ,$$

and

$${λ}_{3} = {\prod }_{j ∈ [ 1 , 3 ] , j \neq 3} \frac{j}{j - 3} = \frac{1}{1 - 3} \cdot \frac{2}{2 - 3} .$$

In this case, the new total private key is:

$${x}^{′} = {\sum }_{i ∈ [ 1 , t + 1 ]} {x}_{i}^{′} = {x}_{1}^{′} + {x}_{2}^{′} + {x}_{3}^{′} = {λ}_{1} {s}_{1}^{′} + {λ}_{2} {s}_{2}^{′} + {λ}_{3} {s}_{3}^{′} = \frac{2}{2 - 1} \cdot \frac{3}{3 - 1} \cdot ( {f}_{1}^{′} ( 1 ) + {f}_{2}^{′} ( 1 ) + {f}_{3}^{′} ( 1 ) ) + \frac{1}{1 - 2} \cdot \frac{3}{3 - 2} \cdot ( {f}_{1}^{′} ( 2 ) + {f}_{2}^{′} ( 2 ) + {f}_{3}^{′} ( 2 ) ) + \frac{1}{1 - 3} \cdot \frac{2}{2 - 3} \cdot ( {f}_{1}^{′} ( 3 ) + {f}_{2}^{′} ( 3 ) + {f}_{3}^{′} ( 3 ) ) = 3 {f}_{1}^{′} ( 1 ) + 3 {f}_{2}^{′} ( 1 ) + 3 {f}_{3}^{′} ( 1 ) - 3 {f}_{1}^{′} ( 2 ) - 3 {f}_{2}^{′} ( 2 ) - 3 {f}_{3}^{′} ( 2 ) + {f}_{1}^{′} ( 3 ) + {f}_{2}^{′} ( 3 ) + {f}_{3}^{′} ( 3 ) = 3 ( {x}_{1} + {a}_{1 , 1}^{′} + {a}_{1 , 2}^{′} ) + 3 ( {x}_{2} + {a}_{2 , 1}^{′} + {a}_{2 , 2}^{′} ) + 3 ( {x}_{3} + {a}_{3 , 1}^{′} + {a}_{3 , 2}^{′} ) - 3 ( {x}_{1} + 2 {a}_{1 , 1}^{′} + 4 {a}_{1 , 2}^{′} ) - 3 ( {x}_{2} + 2 {a}_{2 , 1}^{′} + 4 {a}_{2 , 2}^{′} ) - 3 ( {x}_{3} + 2 {a}_{3 , 1}^{′} + 4 {a}_{3 , 2}^{′} ) + ( {x}_{1} + 3 {a}_{1 , 1}^{′} + 9 {a}_{1 , 2}^{′} ) + ( {x}_{2} + 3 {a}_{2 , 1}^{′} + 9 {a}_{2 , 2}^{′} ) + ( {x}_{3} + 3 {a}_{3 , 1}^{′} + 9 {a}_{3 , 2}^{′} ) = {x}_{1} + {x}_{2} + {x}_{3} + ( 3 {a}_{1 , 1}^{′} - 6 {a}_{1 , 1}^{′} + 3 {a}_{1 , 1}^{′} ) + ( 3 {a}_{1 , 2}^{′} - 12 {a}_{1 , 2}^{′} + 9 {a}_{1 , 2}^{′} ) + ( 3 {a}_{2 , 1}^{′} - 6 {a}_{2 , 1}^{′} + 3 {a}_{2 , 1}^{′} ) + ( 3 {a}_{2 , 2}^{′} - 12 {a}_{2 , 2}^{′} + 9 {a}_{2 , 2}^{′} ) + ( 3 {a}_{3 , 1}^{′} - 6 {a}_{3 , 1}^{′} + 3 {a}_{3 , 1}^{′} ) + ( 3 {a}_{3 , 2}^{′} - 12 {a}_{3 , 2}^{′} + 9 {a}_{3 , 2}^{′} ) = {x}_{1} + {x}_{2} + {x}_{3} = {f}^{′} ( 0 ) = f ( 0 )$$

It can be seen that the new total private key is equal to the original total private key, that is, x′=x. It is clear that a corresponding new total public key is also equal to an original total public key. Therefore, the original total public key can still be used to verify the total signature obtained by aggregating new signature shares generated subsequently by using updated secret shares.

In yet another specific example, a first participant set [symbol] existing before a change includes n=4 participants {P₁, . . . , P₄}, and a second participant set [symbol] obtained after the change includes n′=3 participants {P₁, P₂, P₃}. n′=3<n=4. That is, a participant exits. For example, a participant P₄ exits, and the threshold changes from 2 to 1, that is, t=2, t′=1. The following steps are included.

S710: Each of at least 3 participants in a third set [symbol] obtained by intersecting the first participant set [symbol] existing before the change and the second participant set [symbol] obtained after the change generates a new t′=1-degree random polynomial by using an original private key share component as a secret value.

If the third set [symbol] can be obtained by intersecting the first participant set [symbol] existing before the change and the second participant set [symbol] obtained after the change, [symbol] satisfies [symbol] ={Pᵢ}_{i∈S}⊆ [symbol] ⋅ [symbol] , that is, the participant in the set [symbol] is a member of the old set [symbol] and a member of the new set [symbol] . In this case, [symbol] is {P₁, P₂, P₃}.

A process in which four participants in the first participant set [symbol] existing before the change generates a key share by based on a distributed threshold key generation protocol is described. As described above, a main related conclusion is as follows: P₁ sets a secret s₁₀, and a private key share is s₁=s₁₁+s₂₁+s₃₁+s₄₁; P₂ sets a secret s₂₀, and a private key share is s₂=s₁₂+s₂₂+s₃₂+s₄₂; P₃ sets a secret s₃₀, and a private key share is s₃=s₁₃+s₂₃+s₃₃+s₄₃; and P₄ sets a secret s₄₀, and a private key share is s₄=s₁₄+s₂₄+s₃₄+s₄₄.

Original private key share components generated by t+1=3 participants in an offline phase before the change are respectively, for example, ×1=λ₁s₁, x₂=λ₂s₂, and x₃=λ₃s₃. Here,

$${λ}_{1} = {\prod }_{j ∈ [ 1 , 3 ] , j \neq 1} \frac{j}{j - 1} = \frac{2}{2 - 1} \cdot \frac{3}{3 - 1} ,$$

$${λ}_{2} = {\prod }_{j ∈ [ 1 , 3 ] , j \neq 2} \frac{j}{j - 2} = \frac{1}{1 - 2} \cdot \frac{3}{3 - 2} , and$$

$${λ}_{3} = {\prod }_{j ∈ [ 1 , 3 ] , j \neq 3} \frac{j}{j - 3} = \frac{1}{1 - 3} .$$

In this case, an original total private key is x=Σ_{i∈[1,+1]}xᵢ=s₁₀+s₂₀+s₃₀+s₄₀=f(0). For specific derivation, references can be made to the above-mentioned descriptions.

For P₁, P₂, and P₃ in the second participant set [symbol] obtained after the change: P₁ calculates a Lagrange coefficient

$${λ}_{1} = {\prod }_{k ∈ S , k \neq 1} \frac{k}{k - 1} = \frac{2}{2 - 1} \cdot \frac{3}{3 - 1} ,$$

and calculates

$${x}_{1} = {λ}_{1} {s}_{1} = \frac{2}{2 - 1} \cdot \frac{3}{3 - 1} \cdot {s}_{1} ;$$

P₂ calculates a Lagrange coefficient

$${λ}_{2} = {\prod }_{k ∈ S , k \neq 2} \frac{k}{k - 2} = \frac{1}{1 - 2} \cdot \frac{3}{3 - 2} ,$$

and calculates

$${x}_{2} = {λ}_{2} {s}_{2} = \frac{1}{1 - 2} \cdot \frac{3}{3 - 2} \cdot {s}_{2} ;$$

and P₃ calculates a Lagrange coefficient

$${λ}_{3} = {\prod }_{k ∈ S , k \neq 3} \frac{k}{k - 3} = \frac{1}{1 - 3} \cdot \frac{2}{2 - 3} ,$$

and calculates

$${x}_{3} = {λ}_{3} {s}_{3} = \frac{1}{1 - 3} \cdot \frac{2}{2 - 3} \cdot {s}_{3} .$$

Then, P₁ generates a random t′=1-degree subpolynomial

$${f}_{1}^{′} ( z ) = {a}_{1 , 1}^{′} z + {x}_{1} ;$$

P₂ generates a random t′=1-degree subpolynomial

$${f}_{2}^{′} ( z ) = {a}_{2 , 1}^{′} z + {x}_{2} ;$$

and P₃ generates a random t′=1-degree subpolynomial

$${f}_{3}^{′} ( z ) = {a}_{3 , 1}^{′} z + {x}_{3} .$$

In this case, there is the following new polynomial:

$${f}^{′} ( z ) = {a}_{1 , 1}^{′} z + {x}_{1} + {a}_{2 , 1}^{′} z + {x}_{2} + {a}_{3 , 1}^{′} z + {x}_{3} = ( {a}_{1 , 1}^{′} + {a}_{2 , 1}^{′} + {a}_{3 , 1}^{′} ) z + ( {x}_{1} + {x}_{2} + {x}_{3} ) .$$

S720: P₁ generates

$${f}_{1}^{′} ( 1 ) , {f}_{1}^{′} ( 2 ) , and {f}_{1}^{′} ( 3 ) ,$$

retains

$${f}_{1}^{′} ( 1 ) ,$$

encrypts and sends

$${f}_{1}^{′} ( 2 )$$

to P₂, and encrypts and sends

$${f}_{1}^{′} ( 3 )$$

to P₃; P₂ generates

$${f}_{2}^{′} ( 1 ) , {f}_{2}^{′} ( 2 ) , and {f}_{2}^{′} ( 3 ) ,$$

retains

$${f}_{2}^{′} ( 2 ) ,$$

encrypts and sends

$${f}_{2}^{′} ( 1 )$$

to P₁, and encrypts and sends

$${f}_{2}^{′} ( 3 )$$

to P₃; and P₃ generates

$${f}_{3}^{′} ( 1 ) , {f}_{3}^{′} ( 2 ) , and {f}_{3}^{′} ( 3 ) ,$$

retains

$${f}_{3}^{′} ( 3 ) ,$$

encrypts and sends

$${f}_{3}^{′} ( 1 )$$

to P₁, and encrypts and sends

$${f}_{3}^{′} ( 2 )$$

### to P₂.

In this case, P₁ locally has

$${f}_{1}^{′} ( 1 ) , {f}_{2}^{′} ( 1 ) , and {f}_{3}^{′} ( 1 ) ;$$

P₂ locally has

$${f}_{1}^{′} ( 2 ) , {f}_{2}^{′} ( 2 ) , and {f}_{3}^{′} ( 2 ) ;$$

and P₃ locally has

$${f}_{1}^{′} ( 3 ) , {f}_{2}^{′} ( 3 ) , and {f}_{3}^{′} ( 3 ) .$$

In addition, the participant P₁ can generate

$${A}_{1 , l}^{′} = {a}_{1 , l}^{′} G ,$$

where l=0, 1, . . . , t′=1, including

$${A}_{1 , 0}^{′} = {a}_{1 , 0}^{′} G = {x}_{1} G and {A}_{1 , 1}^{′} = {a}_{1 , 1}^{′} G ,$$

and broadcast

$$\{ {A}_{1 , 0}^{′} , {A}_{1 , 1}^{′} \}$$

to P₂ and P₃; the participant P₂ can generate

$${A}_{2 , 1}^{′} = {a}_{2 , 1}^{′} G ,$$

where l=0, 1, . . . , t′=2, including

$${A}_{2 , 0}^{′} = {a}_{2 , 0}^{′} G = {x}_{2} G and {A}_{2 , 1}^{′} = {a}_{2 , 1}^{′} G ,$$

and broadcast

$$\{ {A}_{2 , 0}^{′} , {A}_{2 , 1}^{′} \}$$

to P₁ and P₃; and the participant P₃ can generate

$${A}_{3 , 1}^{′} = {a}_{3 , 1}^{′} G ,$$

where l=0, 1, . . . , t′=2, including

$${A}_{3 , 0}^{′} = {a}_{3 , 0}^{′} G = {x}_{3} G and {A}_{3 , 1}^{′} = {a}_{3 , 1}^{′} G ,$$

and broadcast

$$\{ {A}_{3 , 0}^{′} , {A}_{3 , 1}^{′} \}$$

to P₁ and P₂.

Further the participant P₁ can verify

$${f}_{2}^{′} ( 1 )$$

based on

$${f}_{2}^{′} ( 1 ) G = {A}_{2 , 0}^{′} + {A}_{2 , 1}^{′} ,$$

and verify

$${f}_{3}^{′} ( 1 )$$

based on

$${f}_{3}^{′} ( 1 ) G = {A}_{3 , 0}^{′} + {A}_{3 , 1}^{′} ;$$

the participant P₂ can verify

$${f}_{1}^{′} ( 2 )$$

based on

$${f}_{1}^{′} ( 2 ) G = {A}_{1 , 0}^{′} + 2 {A}_{1 , 1}^{′} ,$$

and verify

$${f}_{3}^{′} ( 2 )$$

based on

$${f}_{3}^{′} ( 2 ) G = {A}_{3 , 0}^{′} + 2 {A}_{3 , 1}^{′} ;$$

and the participant P₃ can verify

$${f}_{1}^{′} ( 2 )$$

based on

$${f}_{1}^{′} ( 3 ) G = {A}_{3 , 0}^{′} + 3 {A}_{3 , 1}^{′} ,$$

and verify

$${f}_{2}^{′} ( 3 )$$

based on

$${f}_{2}^{′} ( 3 ) G = {A}_{2 , 0}^{′} + 3 {A}_{2 , 1}^{′} .$$

Any party can terminate a protocol if verification fails.

In another aspect, each participant Pᵢ can calculate the total public key X′. A calculation method is similar to the above-mentioned method. For example, the following formula is used here:

$${X}^{′} = {\sum }_{j = 1}^{{t}^{′}} {A}_{j , 0}^{′} = {A}_{1 , 0}^{′} + {A}_{2 , 0}^{′} + {A}_{3 , 0}^{′} = ( {x}_{1} + {x}_{2} + {x}_{3} ) \cdot G$$

As described above, the new total public key X′ can be used to verify the total signature obtained by aggregating new signature shares generated subsequently by using updated secret shares.

S730: P₁ calculates a new private key share

$${s}_{1}^{′} = {Σ}_{i ∈ S} {f}_{i}^{′} ( 1 ) = {f}_{1}^{′} ( 1 ) + {f}_{2}^{′} ( 1 ) + {f}_{3}^{′} ( 1 ) ;$$

P₂ calculates a new private key share

$${s}_{2}^{′} = {Σ}_{i ∈ S} {f}_{i}^{′} ( 2 ) = {f}_{1}^{′} ( 2 ) + {f}_{2}^{′} ( 2 ) + {f}_{3}^{′} ( 2 ) ;$$

and P₃ calculates a new private key share

$${s}_{3}^{′} = {Σ}_{i ∈ S} {f}_{i}^{′} ( 3 ) = {f}_{1}^{′} ( 3 ) + {f}_{2}^{′} ( 3 ) + {f}_{3}^{′} ( 3 ) .$$

New private key share components of t′+1=2 participants in the offline phase after the change are respectively, for example,

$${x}_{1}^{′} = {λ}_{1} {s}_{1}^{′} and {x}_{2}^{′} = {λ}_{2} {s}_{2}^{′} .$$

### Here,

$${λ}_{1} = {\prod }_{j ∈ [ 1 , 2 ] , j \neq 1} \frac{j}{j - 1} = \frac{2}{2 - I} and {λ}_{2} = {\prod }_{j ∈ [ 1 , 2 ] , j \neq 2} \frac{j}{j - 2} = \frac{1}{1 - 2} .$$

In this case, the new total private key is:

$${x}^{′} = {\sum }_{i ∈ [ 1 , t + 1 ]} {x}_{i}^{′} = {x}_{1}^{′} + {x}_{2}^{′} = {λ}_{1} {s}_{1}^{′} + {λ}_{2} {s}_{2}^{′} = \frac{2}{2 - 1} \cdot ( {f}_{1}^{′} ( 1 ) + {f}_{2}^{′} ( 1 ) + {f}_{3}^{′} ( 1 ) ) + \frac{1}{1 - 2} \cdot ( {f}_{1}^{′} ( 2 ) + {f}_{2}^{′} ( 2 ) + {f}_{3}^{′} ( 2 ) ) = 2 {f}_{1}^{′} ( 1 ) + 2 {f}_{2}^{′} ( 1 ) + 2 {f}_{3}^{′} ( 1 ) - {f}_{1}^{′} ( 2 ) - {f}_{2}^{′} ( 2 ) - {f}_{3}^{′} ( 2 ) = 2 ( {x}_{1} + {a}_{1 , 1}^{′} ) + 2 ( {x}_{2} + {a}_{2 , 1}^{′} ) - ( {x}_{1} + 2 {a}_{1 , 1}^{′} ) - ( {x}_{2} + 2 {a}_{2 , 1}^{′} ) - ( {x}_{3} + 2 {a}_{3 , 1}^{′} ) = {x}_{1} + {x}_{2} + {x}_{3} = {f}^{′} ( 0 ) = f ( 0 )$$

It can be seen that the new total private key is equal to the original total private key, that is, x′=x. It is clear that a corresponding new total public key is also equal to an original total public key. Therefore, the original total public key can still be used to verify the total signature obtained by aggregating new signature shares generated subsequently by using updated secret shares.

Based on the dynamic protocol of this solution, any threshold signature solution based on a discrete logarithm problem can be constructed, including a threshold ECDSA, threshold SM2, and a threshold Schnorr signature solution. According to the distributed threshold signature solution provided in this application, a complete private key does not exist in the entire process, and private key shard leakage and loss can be tolerated to a certain extent. This effectively avoids a security risk brought by improper private key management. In addition, in the distributed threshold signature solution and the distributed key updating solution provided in this application, the threshold t and the total quantity n of participants can be dynamically changed, to keep the total public key unchanged, thereby avoiding distributing the new total public key.

CN109150539A discloses a blockchain-based distributed CA authentication system, method, and apparatus. Although a threshold (k, n) is mentioned, in this solution, a centralized certificate management center needs to divide a private key into n shards, the shards are distributed to n different nodes, and distributed signatures of k nodes are implemented. That is, in the solution, an authority still needs to be centralized, and is not completely decentralized. The reason is that no breakthrough is found in cryptography, that is, completely distributed key generation and threshold signature implementation solutions are found from an underlying layer of an algorithm.

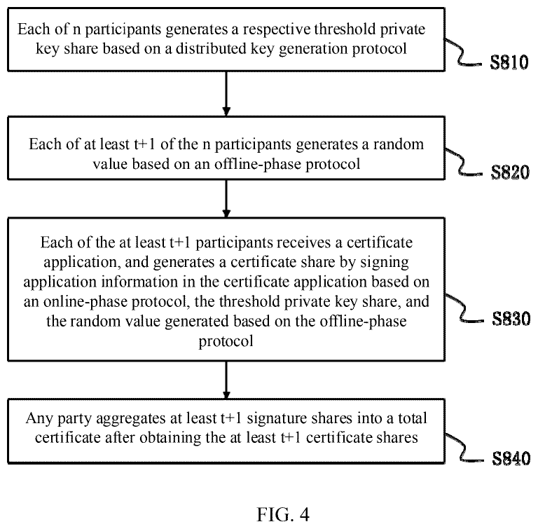

This application provides the following distributed digital certificate implementation method based on the distributed key generation and distributed threshold signature solution implemented above. As shown in FIG. 4, the method includes the following steps.

S810: Each of n participants generates a respective threshold private key share based on a distributed key generation protocol.

S820: Each of at least t+1 of the n participants generates a random value based on an offline-phase protocol.

S810 and S820 can be implemented in Method 1 or Method 2:

### Method 1:

In the distributed key generation phase, each of the n participants generates a respective private key share based on the distributed key generation protocol, generates a homomorphic encryption public-private key pair, and sends a homomorphic encryption public key to another participant.

In an offline phase of a distributed signature, each of the at least t+1 participants generates a first random value and a second random value of the participant, further obtains a coordinate component based on a homomorphic encryption algorithm of the homomorphic encryption public-private key pair, the offline-phase protocol, and the second random value, and obtains a private key share mask value based on a respective private key share.

Method 1 is the distributed key generation phase in the distributed threshold signature and the offline phase of the distributed signature that are implemented based on the ECDSA. Details are omitted.

### Method 2:

In the distributed key generation phase, each of the n participants generates a first random value and a second random value, and exchanges the first random value and the second random value with another participant after homomorphic encryption; and each participant generates a private key share based on the first random value, the second random value, and a sum of secret shares generated based on the distributed key generation protocol that are collected.

In an offline phase of a distributed signature, each of the at least t+1 participants updates the private key share of the participant, and generates and broadcasts a third random value of the participant and a corresponding third random value public key.

Method 2 is the distributed key generation phase in the distributed threshold signature and the offline phase of the distributed signature that are implemented based on SM2. Details are omitted.

S830: Each of the at least t+1 participants receives a certificate application, and generates a certificate share by signing application information in the certificate application based on an online-phase protocol, the threshold private key share, and the random value generated based on the offline-phase protocol.

The certificate application can include application information, and can specifically include a public key of an application subject, and can further include identity information of the application subject, etc. Therefore, each of the t+1 participants can sign the application information, to generate the certificate share.

S840: Any party aggregates at least t+1 signature shares into a total certificate after obtaining the at least t+1 certificate shares.

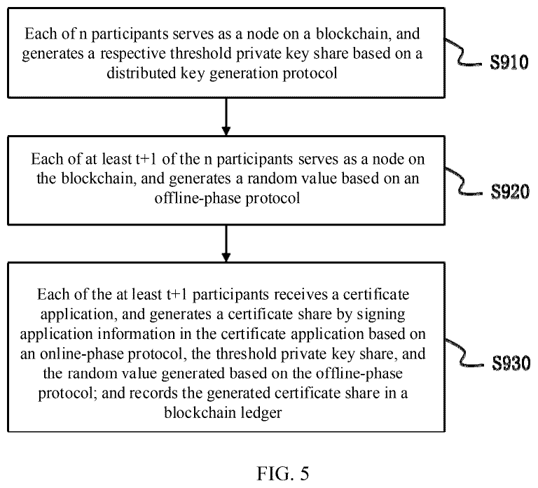

This application further provides the following blockchain-based distributed digital certificate implementation method based on the distributed key generation and distributed threshold signature solution implemented above. As shown in FIG. 5, the method includes the following steps.

S910: Each of n participants serves as a node on a blockchain, and generates a respective threshold private key share based on a distributed key generation protocol.

S920: Each of at least t+1 of the n participants serves as a node on the blockchain, and generates a random value based on an offline-phase protocol.

S930: Each of the at least t+1 participants receives a certificate application, and generates a certificate share by signing application information in the certificate application based on an online-phase protocol, the threshold private key share, and the random value generated based on the offline-phase protocol; and records the generated certificate share in a blockchain ledger.

In an implementation, the generated certificate share is recorded in a blockchain ledger, which can be recorded in a receipt. For example, at least t+1 certificate shares generated by the at least t+1 participants are recorded in a receipt of the blockchain ledger. In addition, the total certificate can also be stored in the blockchain ledger.

In a blockchain system, different participants can establish a distributed blockchain network by using deployed nodes. A decentralized (or multi-centralized) distributed ledger constructed using a chain block structure is stored on each node (or most nodes, for example, consensus nodes) in the distributed blockchain network Such a blockchain system needs to resolve a problem of consistency and correctness of respective ledger data on a plurality of decentralized (or multi-centralized) nodes. Each node (or a plurality of nodes) runs a blockchain program, and under a design of specific fault tolerance needs, a consensus mechanism is used to ensure that all loyal nodes have the same transactions, so as to ensure that all the loyal nodes achieve consistent execution results for the same transactions, and package the transactions and the execution results into blocks.

The transaction execution result or related information can be recorded in a receipt in the blockchain. Specifically, the execution result/related information can be represented as an event in the receipt. A structure of the event is, for example, in the following format:
Event:
[topic][msg]
[topic][msg]
. . .

In the above-mentioned example, there can be one or more events. Each event can include fields such as a topic and data. Through the embedded SDK, the blockchain client device or the blockchain node can listen for an event of a specific topic, obtain content of a corresponding msg when the event of the specific topic is detected, and can perform predetermined processing after detecting the specific topic or certain content in the corresponding msg.

In this event mechanism, the node can store an execution result in a msg corresponding to a certain topic, so that a listener (that is, a client device or a blockchain node in which the blockchain SDK is embedded) that listens for the topic can obtain the corresponding execution result. An event to be listened for can be registered with the blockchain node through the SDK. Specifically, the blockchain node can bind a hook function to the generated event in running blockchain platform code (the hook function can be edited together with the platform code in a development phase). The hook function is a callback function, can be called when the event to be listened for occurs, and can execute specific processing logic. Listening for code can include, for example, listening for one or more of transaction content of a blockchain transaction, a generated receipt, etc. After the event to be listened for is registered with the blockchain node through the SDK, the blockchain node can store a mapping relationship between the event to be listened for and a listener (for example, a network connection of a client device/node that initiates event listening and in which the SDK is embedded, which usually can include information such as an IP address and a port number). When the hook function detects that a corresponding event topic occurs, the hook function can be called, and then the hook function can query the mapping relationship, and push the event that is listened for to the network connection. As such, the SDK that initiates the listening can obtain the event that is listened for by using the maintained network connection. After all transactions in the blockchain are executed and organized into blocks, the blockchain platform code can listen for the receipt in the transaction result, and broadcast the event that is listened for to the SDK that initiates the listening. Here, in this monitoring mechanism, the node can listen for a registered specific topic event, and when such an event occurs, obtain a msg corresponding to the topic by using a maintained connection, to obtain content in the msg. The content in the msg here includes a public verification parameter. In conclusion, the public verification parameter can be broadcast by using the event mechanism in the blockchain, and broadcast content can be received by using the event monitoring mechanism.

Based on such a monitoring mechanism, any participant (which can be one of the participants, or can be any participant other than the participant, for example, a user who needs to verify a certificate of a website to access the website) can collect at least t+1 certificate shares on the blockchain ledger, for example, by monitoring an event of a specific topic.

Further, after the at least t+1 certificate shares are obtained, the at least t+1 certificate shares can be aggregated into a total certificate. Details are as described above. As previously described, the total certificate can be stored in the blockchain ledger.

In addition, the n participants further generate a total public key based on the distributed key generation protocol, and any party verifies correctness of a total certificate based on the total public key after obtaining the total certificate and the total public key.

In the above-mentioned implementations of this application, based on the above-mentioned distributed key generation and threshold signature implementation solutions, dependence on a centralization institution can be avoided, to become more flexible and robust. Private key shard leakage and loss can be tolerated to a certain extent. This effectively avoids a security risk brought by improper private key management, and is more suitable for a decentralization scenario such as a blockchain.

In addition, with reference to the above-mentioned key share updating solution, a total quantity of participants can be dynamically changed, and a threshold can be dynamically changed. This makes it possible and easy to implement that the total public key remains unchanged when the participant dynamically joins or exits and the threshold is dynamically changed.

This application further provides one or more implementations of a distributed threshold signature implementation method, including:

Each of n participants generates a respective threshold private key share based on a distributed key generation protocol.

Each of at least t+1 of the n participants generates a random value based on an offline-phase protocol.

Each of the at least t+1 participants generates a signature share by signing a message based on an online-phase protocol, a threshold private key share, and the random value generated based on the offline-phase protocol.

After obtaining at least t+1 signature shares, any party aggregates the at least t+1 signature shares into a total signature.

The n participants further generate a total public key based on the distributed key generation protocol, and any party verifies correctness of the total signature based on the total public key after obtaining the total signature and the total public key.

The distributed key generation phase, an offline phase, and an online phase specifically include: in the distributed key generation phase, each of the n participants generates a respective private key share based on the distributed key generation protocol, generates a homomorphic encryption public-private key pair, and sends a homomorphic encryption public key to another participant; in an offline phase of a distributed signature, each of the at least t+1 participants generates a first random value and a second random value of the participant, further obtains a coordinate component based on a homomorphic encryption algorithm of the homomorphic encryption public-private key pair, the offline-phase protocol, and the second random value, and obtains a private key share component mask value based on a respective private key share; and in an online phase of the distributed signature, each of the at least t+1 participants receives a certificate application, and obtains the signature share by signing the message based on the first random value of the participant, the private key share component mask value, and the coordinate component.

The distributed key generation phase, an offline phase, and an online phase specifically include: in the distributed key generation phase, each of the n participants generates a first random value and a second random value, and exchanges the first random value and the second random value with another participant after homomorphic encryption; and each participant generates a private key share based on the first random value, the second random value, and a sum of secret shares generated based on the distributed key generation protocol that are collected; in an offline phase of a distributed signature, each of the at least t+1 participants updates the private key share of the participant, and generates and broadcasts a third random value of the participant and a corresponding third random value public key; and in an online phase of the distributed signature, each of the at least t+1 participants receives a certificate application, calculates total coordinates of the third random value public key after collecting the third random value public key, calculates r in a signature share for the message based on the total coordinates, and further calculates a component sᵢ of the signature share for the message based on r, the third random value of the participant, and an updated private key share of the participant, to obtain the signature share.

The following describes one or more implementations of a computer device according to this application. The computer device includes: a processor; and a storage, where the storage stores a program, and when the processor executes the program, the following operations are performed: generating a respective threshold private key share based on a distributed key generation protocol; generating a random value based on an offline-phase protocol; and generating a signature share by signing a message based on an online-phase protocol, the threshold private key share, and the random value generated based on the offline-phase protocol.

The following describes one or more implementations of a storage medium according to this application. The storage medium is configured to store a program, and when the program is executed, the following operations are performed: generating a respective threshold private key share based on a distributed key generation protocol; generating a random value based on an offline-phase protocol; and generating a signature share by signing a message based on an online-phase protocol, the threshold private key share, and the random value generated based on the offline-phase protocol.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers obtain the corresponding hardware circuit structure by programming the improved method process into the hardware circuit. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system into a PLD without requesting a chip manufacturer to design and produce an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). Currently, the Very-High-Speed Integrated Circuit Hardware Description Language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or an embedded microprocessor. Examples of the controller include but are not limited to the following microprocessors: ARC 625D, Atmel AT91SAM, Microchip PIC18F26K20, and Silicon Labs C8051F320. The memory controller can also be implemented as a part of control logic of a storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, an embedded microcontroller, etc. Therefore, the controller can be considered as a hardware component, and an apparatus that is configured to implement various functions and that is included in the controller can also be considered as a structure in the hardware component. Alternatively, the apparatus configured to implement various functions can even be considered as both a software module implementing a method and a structure in the hardware component.

Systems, apparatuses, modules, or units that are set forth in the above-mentioned implementations can be embodied by a computer chip or an entity or by a product with a specific function. A typical implementation device is a server system. Certainly, this application does not exclude that with development of future computer technologies, a computer that implements a function of the above-mentioned implementation can be, for example, a personal computer, a laptop computer, a vehicle-mounted man-machine interaction device, a cellular phone, a camera phone, a smartphone, a personal digital assistant, a media player, a navigation device, an e-mail device, a game console, a tablet computer, a wearable device, or a combination of any of these devices.

Although one or more implementations of this specification provide method operating steps as described in the implementations or a flowchart, more or fewer operating steps may be included on the basis of conventional or noncreative means. A sequence of steps listed in the implementations is merely one of various step execution sequences and does not indicate a sole execution sequence. In practice, when being executed by an apparatus or an end-user device product, the steps can be performed sequentially or in parallel (for example, by parallel processors or in a multi-thread processing environment, or even in a distributed data processing environment) based on the method shown in the implementations or the accompanying drawings. The terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, the existence of additional identical or equivalent elements in the process, method, product, or device that includes the elements is not excluded. For example, if the words first, second, etc. are used for indicating names, they do not indicate any particular order.

For ease of description, the above-mentioned apparatus is described by dividing functions into various modules. Certainly, during implementation of one or more implementations of this specification, the functions of the modules can be implemented in same one or more pieces of software and/or hardware, or modules implementing the same function can be implemented by using a combination of a plurality of sub-modules or sub-units, etc. The described apparatus implementations are merely examples. For example, division into the units is merely logical function division and there can be other division methods in actual implementation. For example, a plurality of units or components can be combined or integrated into another system, or some features can be ignored or not performed. In addition, the displayed or discussed mutual couplings or direct couplings or communication connections can be implemented by using some interfaces. The indirect couplings or communication connections between the apparatuses or units can be implemented in electronic, mechanical, or other forms.

This application is described with reference to a flowchart and/or a block diagram of a method, an apparatus (system), and a computer program product according to some implementations of this application. It should be understood that computer program instructions may be used to implement each process and/or each block in the flowcharts and/or the block diagrams and a combination of a process and/or a block in the flowcharts and/or the block diagrams. These computer program instructions can be provided to a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions may be stored in a computer-readable storage that can instruct the computer or any other programmable data processing device to work in a specific method, so that the instructions stored in the computer-readable storage generate an artifact that includes an instruction apparatus. The instruction apparatus implements a specific function in one or more processes in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more central processing units (CPU), input/output interfaces, network interfaces, and memories.

The memory can include a non-persistent storage, a random access memory (RAM), a nonvolatile memory, and/or another form in a computer-readable medium, for example, a read-only memory (ROM) or a flash random access memory (flash RAM). The memory is an example of the computer-readable medium.

Computer-readable media, including permanent and non-permanent, removable and non-removable media, can be implemented by any method or technology for information storage. The information can be computer-readable instructions, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. As described in this specification, the computer-readable medium does not include computer-readable transitory media such as a modulated data signal and a carrier.

A person skilled in the art should understand that one or more implementations of this specification can be provided as methods, systems, or computer program products. Therefore, the one or more implementations of this specification can use a form of hardware only implementations, software only implementations, or implementations with a combination of software and hardware. Moreover, the one or more implementations of this specification can use the form of a computer program product implemented on one or more computer available storage media (including, but not limited to, disk storage, CD-ROM, optical memory, etc.), where the computer available program code is included.

The one or more implementations of this specification can be described in a common context of a computer executable instruction executed by a computer, for example, a program module. Typically, program modules include routines, programs, objects, components, data structures, etc. that perform specific tasks or implement specific abstract data types. The one or more implementations of this specification can also be practiced in a distributed computing environment where tasks are performed by remote processing devices that are connected through a communication network. In a distributed computing environment, the program module can be located in both local and remote computer storage media including storage devices.

The implementations of this specification are described in a progressive method. For same or similar parts in the implementations, references can be made to each other. Each implementation focuses on a difference from another implementation. Particularly, the system implementations are basically similar to the method implementations, and therefore are described briefly. For related parts, reference can be made to some descriptions in the method implementations. In the description of this specification, references to term “an implementation”, “some implementations”, “examples”, “specific examples”, or “some examples” mean that specific features, structures, materials, or characteristics described in conjunction with this implementation or example are included in at least one implementation or example of this specification. In this specification, it is unnecessary for the explanatory representation of the above-mentioned terms to refer to the same implementation or example. Moreover, the specific features, structures, materials, or characteristics described can be combined in any one or more implementations or examples in a suitable method. In addition, without contradicting each other, a person skilled in the art can combine and integrate different implementations or examples described in this specification and features of the different implementations or examples.

The above-mentioned descriptions are merely implementations of the one or more implementations of this specification, and are not intended to limit the one or more implementations of this specification. A person skilled in the art knows that one or more implementations of this specification can have various modifications and changes. Any modifications, equivalent replacements, improvements, etc. made without departing from the spirit and principle of this specification shall fall within the scope of the claims.

What is claimed is:

1. A computer-implemented method for distributed digital certificate implementation, comprising:
generating, by each of n participants, a respective threshold private key share based on a distributed key generation protocol;
generating, by each of at least t+1 of the n participants, a random value based on an offline-phase protocol;
receiving, by each of the at least t+1 participants, a certificate application;
generating, as a generated signature share, a certificate share by signing application information in the certificate application based on an online-phase protocol, the respective threshold private key share, and the random value generated based on the offline-phase protocol; and
aggregating, by any party, at least t+1 signature shares into a total certificate after obtaining the at least t+1 certificate shares.

2. The computer-implemented method of claim 1, wherein each of the n participants serves as a node on a blockchain.

3. The computer-implemented method of claim 1, comprising:
recording the generated signature share in a blockchain ledger.

4. The computer-implemented method of claim 1, wherein the n participants further generate a total public key based on the distributed key generation protocol, and any party verifies correctness of a total certificate based on the total public key after obtaining the total certificate and the total public key.

5. The computer-implemented method of claim 4, wherein the total public key is stored in a blockchain ledger.

6. The computer-implemented method of claim 4, wherein the total certificate is stored in a blockchain ledger.

7. The computer-implemented method of claim 1, wherein a distributed key generation phase, an offline phase, and an online phase comprise:
in the distributed key generation phase, each of the n participants generates a respective private key share based on the distributed key generation protocol, generates a homomorphic encryption public-private key pair, and sends a homomorphic encryption public key to another participant;
in an offline phase of a distributed signature, each of the at least t+1 participants generates a first random value and a second random value of the participant, further obtains a coordinate component based on a homomorphic encryption algorithm of the homomorphic encryption public-private key pair, the offline-phase protocol, and the second random value, and obtains a private key share component mask value based on a respective private key share; and
in an online phase of the distributed signature, each of the at least t+1 participants receives the certificate application, and obtains the certificate share by signing the application information in the certificate application based on the first random value of the participant, the private key share component mask value, and the coordinate component.

8. The computer-implemented method of claim 7, wherein a distributed key generation phase, an offline phase, and an online phase comprise:
in the distributed key generation phase, each of the n participants generates a first random value and a second random value, and exchanges the first random value and the second random value with another participant after homomorphic encryption; and each participant generates a private key share based on the first random value, the second random value, and a sum of secret shares generated based on the distributed key generation protocol that are collected;
in an offline phase of a distributed signature, each of the at least t+1 participants updates the private key share of the participant, and generates and broadcasts a third random value of the participant and a corresponding third random value public key; and
in an online phase of the distributed signature, each of the at least t+1 participants receives the certificate application, calculates total coordinates of the corresponding third random value public key after collecting the corresponding third random value public key, calculates r in a signature share for a message based on the total coordinates, and further calculates a component sᵢ of the signature share for the application information in the certificate application based on r, the third random value of the participant, and an updated private key share of the participant, to obtain the certificate share.

9. A non-transitory, computer-readable medium storing one or more instructions executable by a computer system to perform one or more operations for distributed digital certificate implementation, comprising:
generating, by each of n participants, a respective threshold private key share based on a distributed key generation protocol;
generating, by each of at least t+1 of the n participants, a random value based on an offline-phase protocol;
receiving, by each of the at least t+1 participants, a certificate application;
generating, as a generated signature share, a certificate share by signing application information in the certificate application based on an online-phase protocol, the respective threshold private key share, and the random value generated based on the offline-phase protocol; and
aggregating, by any party, at least t+1 signature shares into a total certificate after obtaining the at least t+1 certificate shares.

10. The non-transitory, computer-readable medium of claim 9, wherein each of the n participants serves as a node on a blockchain.

11. The non-transitory, computer-readable medium of claim 9, comprising:
recording the generated signature share in a blockchain ledger.

12. The non-transitory, computer-readable medium of claim 9, wherein the n participants further generate a total public key based on the distributed key generation protocol, and any party verifies correctness of a total certificate based on the total public key after obtaining the total certificate and the total public key.

13. The non-transitory, computer-readable medium of claim 12, wherein the total public key is stored in a blockchain ledger.

14. The non-transitory, computer-readable medium of claim 12, wherein the total certificate is stored in a blockchain ledger.

15. The non-transitory, computer-readable medium of claim 9, wherein a distributed key generation phase, an offline phase, and an online phase comprise:
in the distributed key generation phase, each of the n participants generates a respective private key share based on the distributed key generation protocol, generates a homomorphic encryption public-private key pair, and sends a homomorphic encryption public key to another participant;
in an offline phase of a distributed signature, each of the at least t+1 participants generates a first random value and a second random value of the participant, further obtains a coordinate component based on a homomorphic encryption algorithm of the homomorphic encryption public-private key pair, the offline-phase protocol, and the second random value, and obtains a private key share component mask value based on a respective private key share; and
in an online phase of the distributed signature, each of the at least t+1 participants receives the certificate application, and obtains the certificate share by signing the application information in the certificate application based on the first random value of the participant, the private key share component mask value, and the coordinate component.

16. The non-transitory, computer-readable medium of claim 9, wherein a distributed key generation phase, an offline phase, and an online phase comprise:
in the distributed key generation phase, each of the n participants generates a first random value and a second random value, and exchanges the first random value and the second random value with another participant after homomorphic encryption; and each participant generates a private key share based on the first random value, the second random value, and a sum of secret shares generated based on the distributed key generation protocol that are collected;
in an offline phase of a distributed signature, each of the at least t+1 participants updates the private key share of the participant, and generates and broadcasts a third random value of the participant and a corresponding third random value public key; and
in an online phase of the distributed signature, each of the at least t+1 participants receives the certificate application, calculates total coordinates of the corresponding third random value public key after collecting the corresponding third random value public key, calculates r in a signature share for a message based on the total coordinates, and further calculates a component sᵢ of the signature share for the application information in the certificate application based on r, the third random value of the participant, and an updated private key share of the participant, to obtain the certificate share.

17. A computer-implemented system for distributed digital certificate implementation, comprising:
one or more computers; and
one or more computer memory devices interoperably coupled with the one or more computers and having tangible, non-transitory, machine-readable media storing one or more instructions that, when executed by the one or more computers, perform one or more operations, comprising:
generating, by each of n participants, a respective threshold private key share based on a distributed key generation protocol;
generating, by each of at least t+1 of the n participants, a random value based on an offline-phase protocol;
receiving, by each of the at least t+1 participants, a certificate application;
generating, as a generated signature share, a certificate share by signing application information in the certificate application based on an online-phase protocol, the respective threshold private key share, and the random value generated based on the offline-phase protocol; and
aggregating, by any party, at least t+1 signature shares into a total certificate after obtaining the at least t+1 certificate shares.
